(19) United States
(12) Patent Application Publication
(10) Pub. No.: US 2007/0236631 A1
(43) Pub. Date: Oct. 11, 2007

(54) Antireflection Film, Polarizing Plate, and Image Display Device Using the Same

(75) Inventors: Shigeaki Ohtani, Minami-Ashigara-shi (JP); Eiichi Kato, Minami- Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Kanagawa (JP)

(21) Appl. No.: 11/632,370

(22) PCT Filed: Aug. 31, 2004
(86) PCT No.: PCT/JP04/12921

§ 371 Date: Jan. 12, 2007

(30) Foreign Application Priority Data
Jul. 12, 2004 (JP) 2004-204928

(51) Int. Cl. G02B 5/30; G02B 1/11; G02F 1/1335; G02B 5/02

(52) U.S. Cl. 349/96; 359/485; 359/599; 427/162

(57) ABSTRACT

An antireflection film is provided with a transparent support, which has a light-diffusing layer and a low refractive index layer on the transparent support, wherein the light-diffusing layer has an inner haze value of 30 to 60% and a surface haze value of 1% or less, and the antireflection film has an average reflectance of 2.5% or less at a wavelength of 450 to 650 nm.

### TECHNICAL FIELD

The present invention relates to a display for a highly fine image, such as CRT and liquid crystal panel used for displaying an image of a computer, a word processor, a television or the like. More specifically, the present invention relates to a liquid crystal display device capable of realizing an enhanced display quality, a highly fine drawn image and a large screen size, and also relates to a polarizing plate and an antireflection film for use in the display device.

### BACKGROUND ART

A liquid crystal device is generally constituted by a polarizing plate and a liquid crystal cell.

The liquid crystal cell in general comprises a rod-like liquid crystal molecule, two substrates for enclosing it, and an electrode for applying a voltage to the rod-like liquid crystal molecule. Heretofore, liquid crystal cells of various display modes differing in the alignment state of rod-like liquid crystal molecules have been proposed. For example, as for the transmission type, TN (twisted nematic), IPS (in-plane switching), FLC (ferroelectric liquid crystal), OCB (optically compensatory bend), STN (super twisted nematic), VA (vertically aligned), ECB (electrically controlled birefringence) cells, and as for the reflection type, HAN (hybrid aligned nematic) cell have been proposed.

From the standpoint of display quality, the liquid crystal display has a problem in the view angle and reflection of external light.

Regarding the view angle, as for the TN-mode TFT liquid crystal display device predominating at present, a liquid crystal display device having a very wide view angle has been realized by inserting an optically compensatory film between the polarizing plate and the liquid crystal cell (see, for example, JP-A-8-50206, JP-A-7-191217, and EP-A-0911656 (the term “JP-A” as used herein means an “unexamined published Japanese patent application”)). However, this liquid crystal display device still has a problem that gradation reversal occurs in the lower direction of the panel.

In the liquid crystal display device, when light mainly ejected from the inside proceeds straight without diffusing on the display device surface, the image surface of the liquid crystal display glares on viewing. Therefore, in order to diffuse the light ejected from the inside to a certain extent or also for preventing the external light reflection which causes reduction in contrast or reflection of an image, an optical functional film having light diffusibility of reducing the reflectance based on the principle of optical interference is disposed as an antireflection film on the outermost surface of a display device. The antireflection film is disposed on the outermost surface and therefore, various antireflection films having a function also as the protective film of a polarizing film have been proposed.

For example, as an inexpensive film having light diffusibility and capable of weight production, there have been disclosed films where a resin containing a filler such as silicon dioxide (silica) is coated on the surface of a transparent support film (hereinafter sometimes also referred to as a “transparent support”) (see, for example, JP-A-6-18706 and JP-A-10-20103), where the light-transmitting resin of the antiglare layer contains light-transmitting particles having a refractive index differing from that of the light-transmitting resin within a predetermined range and the light-transmitting particles are two kinds of light-transmitting particles differing in the refractive index (see, JP-A-2000-180611), where the light-transmitting resin of the antiglare layer contains a particle having a refractive index differing from that of the light-transmitting resin within a predetermined range and a mat particle (see, JP-A-2003-43218), or where the antiglare layer contains particles having a refractive index differing from that of the resin and the concave-convex shape on the surface has specified Ra and Rz (see, JP-A-2000-338310).

When the antireflection film described in these patent publications is provided in a display device of various liquid crystal display modes described above, an antiglare or antireflection effect may be obtained, but the problem that the change in view angle is accompanied with, for example, reduction of contrast or change in color tint of image cannot be overcome.

In this way, conventional antireflection films cannot completely solve the above-described problems regarding view angle and an antireflection film having an excellent effect on the reflection of external light, being free from the problems regarding view angle, and exhibiting excellent scratch resistance even when disposed on the outermost surface is being demanded.

Also, in recent years, as for the liquid crystal display mode of a liquid crystal display device, not only TN mode but also IPS mode, OCB mode, VA mode and the like are demanded to have an enhanced quality of image drawn, Particularly, in display devices having a large-size display image, realization of a high-quality image with a large contrast and no change in color tint is being demanded.

As for the coating system at the production of an antireflection film, a dip coating method, a microgravure method, a reverse roll coating method and the like have been mainly used. In the dip coating method, vibration of the coating solution in the liquid-receiving tank is inevitable and stepwise unevenness is readily generated. In the reverse roll coating method and microgravure method, stepwise unevenness is readily generated due to eccentricity or sagging of the roll related to coating. Furthermore, in the microgravure method, the coated amount is liable to fluctuate according to the production precision of gravure roll or change in aging of the roll or blade resulting from abutting between the blade and the gravure roll. In addition, these coating methods are employing a post-measuring system and therefore, it is relatively difficult to ensure a stable film thickness. Also, a method of coating an antireflection film by a die coating method has been proposed as the pre-measuring type coating system, but in the coating of a thin layer such as antireflection layer, film thickness unevenness is noticeably generated in the directions perpendicular and parallel to the conveyance direction of a transparent support and the film thickness is difficult to stably maintain.

Such film thickness unevenness of the antireflection layer is detected with an eye as color unevenness and this is a serious problem of impairing the quality. The stabilization of film thickness is being demanded.

### DISCLOSURE OF THE INVENTION

An object of the present invention is to provide an antireflection film, an antireflection film producing method, and a polarizing plate using the antireflection film, where the view angle (particularly, view angle in lower direction) is enlarged without increasing the thickness of liquid crystal panel, the reduction in contrast, gradation or black-and-white reversal, color tint change and the like are scarcely generated even when the view angle is changed, the color unevenness is improved, and the scratch resistance is enhanced.

Another object of the present invention is to provide a liquid crystal display device having a good contrast and a wide view angle, where gradation reversal in the lower direction of panel, color hue change and reflection of external light can be prevented in a high level.

The objects of the present invention can be attained by the following contents.

(1) An antireflection film comprising a transparent film having thereon a light-diffusing layer and a low refractive index layer, wherein the light-diffusing layer has an inner haze value of 30 to 60% and a surface haze value of 1% or less and the antireflection film has an average reflectance of 2.5% or less at a wavelength of 450 to 650 nm.

(2) The antireflection film as described in (1) above, wherein a color tint change ΔE of a reflected light before and after a weather resistance test according to JIS K5600-7-7:1999 is 15 or less on the L*a*b* chromaticity diagram.

(3) The antireflection film as described in (1) or (2) above, wherein the low refractive index layer has a surface energy of 26 mN/m or less and a dynamic friction coefficient of 0.25 or less.

(4) The antireflection film as described in any one of (1) to (3) above, wherein the light-diffusing layer comprises a light-transmitting resin and at least two or more kinds of light-transmitting particles, a difference between a refractive index of the light-transmitting resin and a refractive index of the light-transmitting fine particle is from 0.02 to 0.20, and the two or more kinds of light-transmitting fine particles are differing in the refractive index.

(5) The antireflection film as described in any one of (1) to (4) above, wherein the low refractive index layer is a low refractive index layer containing a fluorine-containing compound and having a refractive index of 1.31 to 1.48.

(6) The antireflection film as described in any one of (1) to (5) above, wherein the low refractive index layer is a cured film comprising a copolymer containing a repeating unit derived from a fluorine-containing vinyl monomer and a repeating unit having a radical polymerizable group on a side chain.

(7) The antireflection film as described in any one of (1) to (6) above, which further comprises an electrically conductive layer.

(8) A method for producing the antireflection film as described in any one of (1) to (7), comprising a coating step of bringing a land of a leading lip of a slot die closer to a surface of a continuously traveling web supported by a backup roll, and coating a coating solution from a slot of the leading lip, wherein in the coating step, a coating solution is coated by using a coating apparatus to coat at least either coating solution for the light-diffusing layer or the low refractive index layer, the apparatus comprising the slot die in which the leading lip of the slot die on a web traveling direction side has a land length of 30 to 100 μm in the web traveling direction and the leading lip on a side opposite to the web traveling direction and the web are disposed to give a gap larger by 30 to 120 μm than a gap between the leading lip in the web traveling direction and the web when the slot die is set to a coating position.

(9) The method for producing an antireflection film as described in (8), wherein a viscosity of the coating solution is 2.0 [mPa·sec] or less at the coating and an amount of the coating solution coated on a web surface is from 2.0 to 5.0 [ml/m²].

(10) The method for producing an antireflection film as described in (8) or (9), wherein the coating solution is coated on the surface of the continuously traveling web at a rate of 25 [m/min] or more.

(11) A polarizing plate comprising the antireflection film as described in any one of (1) to (7) above or an antireflection film produced by the method as described in any one of (8) to (10) above for at least one protective film of a polarizing film.

(12) A polarizing plate comprising the antireflection film as described in any one of (1) to (7) above or an antireflection film produced by the method as described in any one of (8) to (10) above for one protective film of a polarizing film and an optically compensatory film having optical anisotropy for another protective film of the polarizing film.

(13) A liquid crystal display device comprising a pair of opposedly disposed substrates with at least one substrate having an electrode, a liquid crystal layer interposed between the substrates, and a polarizing plate disposed on the outermost surface in the viewing side outside the liquid crystal layer, wherein the polarizing plate is the polarizing plate described in (11) or (12) above.

(14) The liquid crystal display device as described in (13) above, which is an IPS (in-plane switching) liquid crystal display device, an OCB (optically compensatory bend) liquid crystal display device or a VA (vertically aligned) liquid crystal display device.

(15) The liquid crystal display device as described in (13) or (14) above, wherein a size of a display image is 20 inches or more.

The light-diffusing layer has an inner haze value of 30 to 60% and a surface haze value of 1% or less and the antireflection film has an average reflectance of 2.5% or less at a wavelength of 450 to 650 nm, whereby a high image display quality with excellent antireflection property can be achieved, that is, image clearness free from whitish screen or blurred image display is realized, the reduction in contrast, color hue change and the like are satisfactorily prevented even when the view angle is changed, and the reflection of external light or glaring of screen does not occur. The methods for adjusting the haze value and the reflectance to the above-described ranges are described later in <Light-Transmitting Fine Particle> and <Light-Transmitting Resin>.

Also, the color tint change ΔE of reflected light before and after a weather resistance test according to JIS K5600-7-7:1999 is 15 or less on the L*a*b* chromaticity diagram, whereby both low reflection and reduction in color tint of reflected light can be achieved and therefore, even when external light having high brightness, such as fluorescent lamp in a room, is slightly reflected, the color tint can be neutral and good quality of the display image can maintained.

This antireflection film having reflected light with neutral color tint and having a low reflectance can be achieved, for example, by optimizing the balance between the refractive index of the low refractive index layer and the refractive index of the light-transmitting resin in the light-diffusing layer and by causing high refractive index metal oxide ultrafine particles in the light-diffusing layer to uniformly disperse with good monodispersitiy.

The outermost surface of the protective film preferably has a surface energy of 26 mN/m or less and a dynamic friction coefficient of 0.25 or less, more preferably a surface energy of 15 to 25.8 mN/m and a dynamic friction coefficient of 0.05 to 0.15. Within this range, good antifouling property as the protective film can be obtained. The method for adjusting the surface energy is described in detail in <Low Refractive Index Layer>.

### BRIEF DESCRIPTION OF THE DRAWINGS

FIG. 1 is a cross-sectional view showing one embodiment of the antireflection film.

FIG. 2 is a schematic view showing one embodiment of the TN-mode liquid crystal display device.

FIG. 3 is a schematic view showing one embodiment of the VA-mode liquid crystal display device.

FIG. 4 is a schematic view showing one embodiment of the OCB-mode liquid crystal display device.

FIG. 5 is a schematic view showing one embodiment of the semitransmitting ECB-mode liquid crystal display device.

FIG. 6 is a schematic view showing one embodiment of the IPS-mode liquid crystal display device.

FIG. 7 is a schematic view showing one example of the coating apparatus for use in the present invention.

FIG. 8 is a schematic cross-sectional view showing one example of the die coater which is preferably used in the present invention.

FIG. 9(A) is an enlarged view of the die coater shown in FIG. 2, and FIG. 9(B) is a schematic cross-sectional view showing a conventional slot die.

FIG. 10 is a perspective view showing the slot die and its periphery in the coating step for practicing the production method of the present invention.

FIG. 11 is a cross-sectional view schematically showing the relationship between depression chamber and web of FIG. 4.

FIG. 12 is a cross-sectional view schematically showing the relationship between depression chamber and web of FIG. 4.

### BEST MODE FOR CARRYING OUT THE INVENTION

The present invention is described in detail below. The term “from (numerical value 1) to (numerical value 2)” as used in the present invention means that “(numerical value 1) or more and (numerical value 2) or less”.

<Antireflection Film>

The antireflection film of the present invention is an antireflection film having a light-diffusing layer and a low refractive index layer, characterized in that the light-diffusing layer has an inner haze value of 30 to 60%, preferably from 40 to 50%, and a surface haze value of 1% or less.

The haze value can be measured according to JIS-K-7105 by using a haze meter (for example, Model 1001DP manufactured by Nippon Denshoku Industries Co., Ltd. or HR-100 manufactured by Murakami Color Research Laboratory).

The antireflection film of the present invention has an average reflectance of 2.5% or less at a wavelength of 450 to 650 nm.

The average reflectance is determined by measuring a mirror reflectance at an exit angle of −5° with an incident angle of 5° in the wavelength region of 380 to 780 nm by a spectrophotometer and calculating the average reflectance at 450 to 650 nm.

The mirror reflectance with an incident angle of 5° is a ratio of the intensity of light reflected at an angle of −5° with respect to the normal of a sample to the intensity of light entering from an angle of +5° with respect to the normal and this is an index for the reflection of surrounding scenes due to mirror reflection.

By specifying optical properties of the antireflection film to these ranges, a high image display quality with excellent antireflection property can be achieved, that is, image clearness free from whitish screen or blurred image display is realized, the reduction in contrast, color hue change and the like are satisfactorily prevented even when the view angle is changed, and the reflection of external light or glaring of screen does not occur.

The outermost surface of the antireflection film preferably has a surface energy of 26 mN/m or less and a dynamic friction coefficient of 0.25 or less, more preferably a surface energy of 15 to 25.8 mN/m and a dynamic friction coefficient of 0.05 to 0.15. Within this range, good antifouling property as the protective film can be obtained.

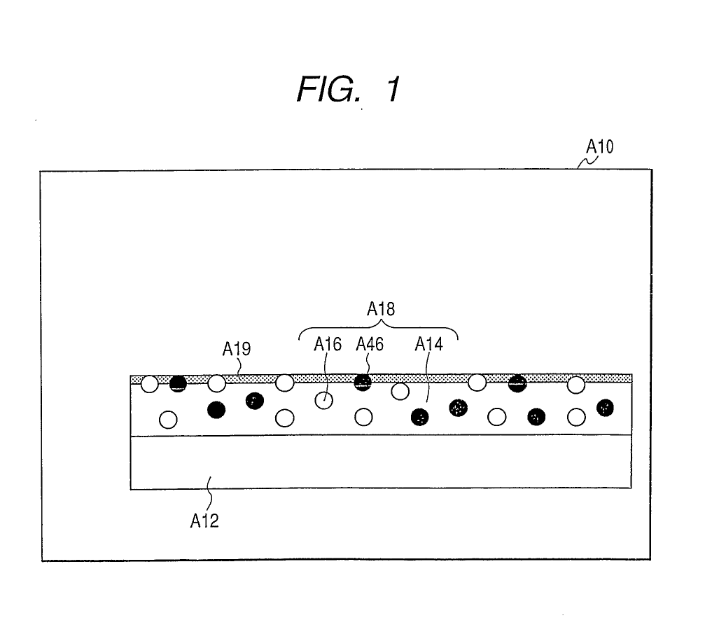

In an example of the embodiment of the present invention, as shown FIG. 1, the antireflection film A10 preferably obtained by stacking a transparent support film A12, a light-diffusing layer A18 comprising a light-transmitting resin A14 containing, for example, a first light-transmitting fine particle A16 and a second light-transmitting fine particle A46, and as the outermost layer, a low refractive index layer A19 containing a fluorine-containing material.

The transparent support A12 is a resin film such as triacetyl cellulose film (hereinafter sometimes also called “TAC”) and the transparent resin A14 is formed by coating and then curing it on the transparent film A12.

<Light-Diffusing Layer>

The light-diffusing layer may be composed of multiple layers. In the following, two kinds of light-transmitting fine particles differing in the refractive index are described, but two or more kinds of light-transmitting fine particles may be used.

<Light-Transmitting Fine Particle>

The two kinds of light-transmitting fine particles differing in the refractive index each may be monodisperse organic or inorganic fine particles. As the particle size has less fluctuation, the scattering property less fluctuates and the design of haze value is more facilitated.

The light-transmitting fine particle is preferably a plastic bead, more preferably a plastic bead having high transparency and a refractive index difference in the above-described range from the light-transmitting resin.

Examples of the organic fine particle include polymethyl methacrylate bead (refractive index: 1.49), acyl-styrene copolymer bead (refractive index: 1.54), melamine bead (refractive index: 1.57), polycarbonate bead (refractive index: 1.57), styrene bead (refractive index: 1.60) crosslinked polystyrene bead (refractive index: 1.61), polyvinyl chloride bead (refractive index: 1.60) and benzoguanamine-melamine formaldehyde bead (refractive index: 1.68).

Examples of the inorganic fine particle include silica bead (refractive index: 1.44) and alumina bead (refractive index: 1.63).

The difference between the refractive index of two kinds of light-transmitting fine particles differing in the refractive index and the refractive index of the light-transmitting resin is preferably from 0.02 to 0.20. In view of antiglare property, if the refractive index difference is less than 0.02, the light-scattering effect cannot be obtained due to excessively small difference between the refractive index of light-transmitting fine particle and the refractive index of light-transmitting resin, whereas if the refractive index difference exceeds 0.2, the light diffusibility is too high and the entire film is whitened. The refractive index difference is preferably from 0.02 to 0.11, and most preferably from 0.03 to 0.09.

As for the light-transmitting fine particle, when two or more kinds of light-transmitting fine particles differing in the refractive index are used and these light-transmitting fine particles are mixed, an average according to refractive indexes and ratio of respective light-transmitting fine particles can be regarded as the refractive index of light-transmitting fine particles and the refractive index can be subtly set by selecting the mixing ratio of light-transmitting fine particles and can be satisfactorily controlled than in the case of using one kind of light-transmitting particle, as a result, various designs are facilitated.

The particle size of two kinds of light-transmitting fine particle differing in the refractive index is preferably from 1.0 to 5.0 μm. If the particle size is less than 1.0 μm, unless a very large amount of light-transmitting fine particles are added to the light-transmitting resin, the light-scattering effect cannot be obtained, whereas if the particle size exceeds 5.0 μm, the surface shape of the light-diffusing layer becomes rough and a high haze value results. More preferably, the diameter of the light-transmitting fine particles is from 2.0 to 4.0 μm.

The two kinds of light-transmitting fine particles differing in the refractive index are preferably used by appropriately selected, as described above, those having a particle size of 1 to 5 μm and preferably contained in an mount of 5 to 30 parts by weight per 100 parts by weight of the light-transmitting resin. In this case, when the first light-transmitting fine particle and the second light-transmitting fine particle have the same particle size, the ratio between the first light-transmitting fine particle and the second light-transmitting fine particle can be freely selected. For using a first light-transmitting fine particle and second light-transmitting fine particle having the same particle size, monodisperse organic fine particles are preferably used.

In the case of adding these light-transmitting fine particles, the light-transmitting fine particles readily precipitate in the light-transmitting resin and for the purpose of preventing the precipitation, an inorganic filler such as silica may be added. Incidentally, as the amount of the inorganic filler added is larger, the precipitation of light-transmitting fine particles can be more effectively prevented, but this adversely affects the transparency of the light-diffusing layer. Therefore, an inorganic filler having a particle size of 0.5 μm or less is preferably added to the light-transmitting resin to a content of less than about 0.1 weight % within the range of not impairing the transparency of the light-diffusing layer.

<Light-Transmitting Resin>

As for the light-transmitting resin constituting the light-diffusing layer, a resin curable by ultraviolet light-electron beam is mainly used and this includes three kinds of resins, that is, an ionizing radiation-curable resin, a resin obtained by mixing a thermoplastic resin and a solvent with an ionizing radiation-curable resin, and a heat-curable resin. The thickness is usually on the order of 0.5 to 50 μm, preferably from 1 to 20 μm, more preferably from 2 to 10 μm.

The refractive index of the light-transmitting resin is preferably from 1.51 to 2.00, more preferably 1.51 to 1.90, still more preferably from 1.51 to 1.85, particularly preferably from 1.51 to 1.80. The refractive index of the light-transmitting resin is a value measured in the state of not containing the light-transmitting fine particles.

The ionizing radiation-curable resin composition preferably comprises an ionizing radiation-curable resin having an acrylate-base functional group, such as polyester, polyether, acrylic, epoxy, urethane, alkyd, spiroacetal, polybutadiene or polythiol polyene resin having a relatively low molecular weight; a (meth)acrylate (hereinafter, acrylate and methacrylate are collectively referred to as “(meth)acrylate”) oligomer or prepolymer of a polyfunctional compound such as polyhydric alcohol; or an ionizing radiation-curable resin containing a relatively large amount of a reactive diluent.

Examples of the reactive diluent include a monofunctional monomer such as ethyl(meth)acrylate, ethylhexyl(meth)acrylate, styrene, vinyltoluene and N-vinylpyrrolidone, and a polyfunctional monomer such as trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate and neopentyl glycol di(meth)acrylate.

In the case of using these ionizing radiation-curable resins as an ultraviolet light-curable resin, a photopolymerization initiator such as acetophenones, benzophenones, Michler's benzoylbenzoate, α-amyloxime esters and thioxanthones, and a photosensitizer such as n-butylamine, triethylamine and tri-n-butylphosphine, may be mixed and used in the ionizing radiation-curable resin. In the present invention, an oligomer such as urethane acrylate, or a monomer such as dipentaerythritol hexa(meth)acrylate is preferably mixed.

Furthermore, as the light-transmitting resin for forming the light-diffusing layer, a thermoplastic resin may be incorporated into the ionizing radiation-curable resin described above. As for the thermoplastic resin, main examples thereof include thermoplastic resins such as Cenol resin, urea resin, diallyl phthalate resin, melamine resin, guanamine resin, unsaturated polyester resin, polyurethane resin, epoxy resin, aminoalkyd resin, melamine-urea co-condensate resin, silicon resin and polysiloxane resin.

As for the kind of the thermoplastic resin added to the ionizing radiation-curable resin, those commonly used may all be used, but particularly when a cellulose-base resin such as TAC is used as the transparent support film, in view of adhesion and transparency of the coating film, the thermoplastic resin incorporated into the ionizing radiation-curable resin is preferably a cellulose-base resin such as nitrocellulose, acetylcellulose, cellulose acetate propionate and ethylhydroxyethyl cellulose.

Examples of the heat-curable resin include a phenolic resin, a urea resin, a diallyl phthalate resin, a melamine resin, a guanamine resin, an unsaturated polyester resin, a polyurethane resin, an epoxy resin, an aminoalkyd resin, a melamine-urea co-condensate resin, silicon resin and polysiloxane resin.

If desired, conventionally known compounds (curing agent, curing accelerator) including a curing agent such as crosslinking agent (e.g., epoxy compound, polyisocyanate compound, polyol compound, polyamine compound, melamine compound) and polymerization initiator (e.g., azobis compound, organic peroxide compound, organic halogen compound, onium salt compound), and a polymerization accelerator (e.g., organic metal compound, acid compound, basic compound) may be added and used in the heat-curable resin. Specific examples thereof include the compounds described in Shinzo Yamashita and Tosuke Kaneko, Kakyo-zai Handbook (Crosslinking Agent Handbook), Taisei Sha (1981). This curing agent is preferably used in an amount of 0.01 to 30 weight % based on the heat-curable resin used.

In addition to the above-described composition, the light-transmitting resin preferably contains, for example, a monomer having a high refractive index and/or a metal oxide ultrafine particle having a high refractive index.

Examples of the high refractive index monomer include bis(4-methacryloylthiophenyl)sulfide, vinylnaphthalene, vinylphenylsulfide and 4-methacryloxyphenyl-4′-methoxy-phenyl thioether.

The metal oxide ultrafine particle having a high refractive index is preferably a particle having a refractive index of 1.70 to 2.80 and an average primary particle size of 3 to 150 nm. If the refractive index is less than 1.70, the effect of elevating the refractive index of the film is small, whereas if the refractive index exceeds 2.80, the particle is colored and this is not preferred. If the average primary particle size exceeds, the light-diffusing layer formed has a high haze value and the transparency of the light-diffusing layer is disadvantageously impaired, whereas if it is less than 3 nm, this not preferred from the standpoint of maintaining a high refractive index. The metal oxide ultrafine particle is more preferably a particle having a refractive index of 1.80 to 2.80 and an average primary particle size of 3 to 100 nm, still more preferably a particle having a refractive index of 1.80 to 2.80 and an average primary particle size of 5 to 80 nm.

Preferred examples of the high refractive index metal oxide ultrafine particle include particles comprising, as the main component, an oxide, composite oxide or sulfide of Ti, Zr, Ta, In, Nd, Sn, Sb, Zn, La, W, Ce, Nb, V, Sm. Y and the like. The “main component” as used herein means a component having largest content (weight %) among the components constituting the particle. In the present invention, this particle is preferably a particle comprising, as the main component, an oxide or composite oxide containing at least one metal element selected from Ti, Zr, Ta, In and Sn. In the metal oxide ultrafine particle for use in the present invention, various elements may be contained. Examples of the element which may be contained include Li, Si, Al, B, Ba, Co, Fe, Hg, Ag, Pt, Au, Cr, Bi, P and S.

Specific examples of the high refractive index metal oxide ultrafine particle include ZrO₂, TiO₂, Al₂O₃, In₂O₃, ZnO, SnO₂, Sb₂O₃ and ITO. Among these, ZrO₂ is preferred.

The metal oxide ultrafine particle for use in the present invention may be surface-treated. The surface treatment is performed to modify the particle surface by using an inorganic compound and/or an organic compound and adjust the wettability on the surface of the metal oxide ultrafine particle so as to realize the formation of fine particles in an organic solvent and enhance the dispersibility or dispersion stability in the composition for forming the light-diffusion layer. Examples of the inorganic compound which is physicochemically adsorbed to the particle surface include silicon-containing inorganic compounds (e.g., SiO₂), aluminum-containing inorganic compounds (e.g., Al₂O₃, Al(OH)₃), cobalt-containing inorganic compounds (e.g., CoO₂, CO₂O₃, CO₃O₄), zirconium-containing inorganic compounds (e.g., ZrO₂, Zr(OH)₄) and iron-containing inorganic compounds (e.g., Fe₂O₃).

Examples of the organic compound used for the surface treatment include a surface modifier including inorganic fillers such as conventionally known metal oxides and inorganic pigments. These are described, for example, in Ganryo Bunsan Anteika to Hyomen Shori Gijutsu-Hyoka (Technique-Evaluation for Dispersion Stabilization and Surface Treatment of Pigments), Chap. 1, Gijutsu Joho Kyokai (2001).

Specific examples of the organic compound include organic compounds containing a polar group having affinity for the surface of the metal oxide ultrafine particle, and coupling compounds. Examples of the polar group having affinity for the surface of the metal oxide ultrafine particle include a carboxy group, a phosphono group, a hydroxy group, a mercapto group, a cyclic aid anhydride group and an amino group. Organic compounds having at least one of these polar groups within the molecule are preferred.

Examples of the coupling compound include conventionally known organic metal compounds such as silane coupling agent, titanate coupling agent and aluminate coupling agent. Among these, a silane coupling agent is most preferred. Specific examples thereof include the compounds described in JP-A-2002-9908 and JP-A-2001-310423 (paragraphs [0011] to [0015]).

The amount added of the monomer and/or metal oxide ultrafine particle having a high refractive index is preferably from 10 to 90 weight %, more preferably from 20 to 80 weight %, based on the entire weight of the light-transmitting resin.

The light-diffusing layer preferably contains, as the interface binder, a (meth)acryloyl group-containing organosilane represented by the following formula [A]:
(R¹⁰)α-Si(X)₄-α [A]
wherein R¹⁰ represents an aliphatic group or aryl group containing a radical polymerizable group or a cationic polymerizable group, and R¹⁰ is preferably an aliphatic group or aryl group containing a (meth)acryloyl group,

X represents a hydroxyl group or a hydrolyzable group, and

α represents an integer of 1 to 3.

The aliphatic group is preferably a substituted or unsubstituted aliphatic group having from 1 to 30 carbon atoms and specific examples thereof include a linear or branched alkyl group having from 1 to 22 carbon atoms (e.g., methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nanodecyl, eicosanyl, heneicosanyl, docosanyl), a linear or branched alkenyl group having from 2 to 22 carbon atoms (e.g., vinyl, propenyl, butenyl, pentenyl, hexenyl, octenyl, dodecenyl, tridecenyl, tetradecenyl, hexadecenyl, octadecenyl, eicosenyl, docosenyl, butadienyl, pentadienyl, hexadienyl, octadienyl), a linear or branched alkynyl group having from 2 to 22 carbon atoms (e.g., ethynyl, propynyl, butynyl, hexynyl, octanyl, decanyl, dodecanyl), and an alicyclic hydrocarbon group having from 5 to 22 carbon atoms (examples of the alicyclic hydrocarbon group include monocyclic, polycyclic or crosslinked cyclic hydrocarbon groups and specific examples thereof include ring structure hydrocarbons such as cyclopentane, cyclopentene, cyclopentadiene, cyclohexane, cyclohexene, cyclohexadiene, cycloheptane, cycloheptene, cycloheptadiene, cyclooctane, cyclooctene, cyclooctadiene, cyclooctatriene, cyclothonane, cyclothonene, cyclodecane, cyclodecene, cyclodecadiene, cyclodecatriene, cycloundecane, cyclododecane, bicycloheptane, bicyclohexane, bicyclohexene, tricyclohexene, norcarane, norpinane, norbornane, norbornene, norbornadiene, tricycloheptane, tricycloheptene, decalin and adamantane).

Among these, more preferred are those having from 1 to 12 carbon atoms, still more preferred are those having from 1 to 8 carbon atoms.

The aryl group is preferably a substituted or unsubstituted aryl group having from 6 to 14 carbon atoms and specific examples thereof include a phenyl group, a naphthyl group and an anthryl group, with a phenyl group being preferred.

The aliphatic group or aryl group may have a substituent other than a (meth)acryloyl group. The substituent is not particularly limited but examples thereof include a halogen (e.g., fluorine, chlorine, bromine), a hydroxyl group, a mercapto group, a carboxyl group, a cyano group, an alkoxy group, an aryloxy group, an acyl group, an amino group, an amido group, an alkanesulfonyl group, an alkyl group having from 1 to 18 carbon atoms, an alkenyl group having from 2 to 18 carbon atoms, an alkynyl group having from 2 to 18 carbon atoms, an alicyclic hydrocarbon group having from 5 to 10 carbon atoms, an aryl group having from 6 to 14 carbon atoms (examples of the aryl group include benzene, naphthalene, dihydronaphthalene, indene, fluorene, acenaphthylene, acenaphthene and biphenylene) and a heterocyclic group having a monocyclic or polycyclic ring structure containing at least one of oxygen atom, sulfur atom and nitrogen atom (examples of the heterocyclic group include a furanyl group, a tetrafuranyl group, a pyranyl group, a pyroyl group, a chromenyl group, a phenoxathinyl group, an indazoyl group, a pyrazoyl group, a pyridyl group, a pyrazinyl group, a pyrimidinyl group, an indoyl group, an isoindoyl group, a quinonyl group, a pyrrolidinyl group, a pyrrolinyl group, an imidazolinyl group, a pyrazolidinyl group, a piperidinyl group, a piperadinyl group, a morpholinyl group, a thienyl group and a benzothienyl group).

These alkenyl group, alkynyl group, alicyclic hydrocarbon group, aryl group and heterocyclic group each may further have a substituent and examples of the substituent are the same as those described above for the group which can be introduced into the aliphatic group or aryl group.

The hydrolyzable group represented by X is a halogen atom, an OR² group or a OCOR² group (wherein R² represents a substituted or unsubstituted alkyl group (e.g., methyl, ethyl, propyl, butyl). X is preferably an alkoxy group, more preferably a methoxy group or an ethoxy group.

When the interface binder is added, the antireflection film of the present invention can be enhanced in the scratch resistance and this is preferred. Specific examples of the interface binder include the following compounds.

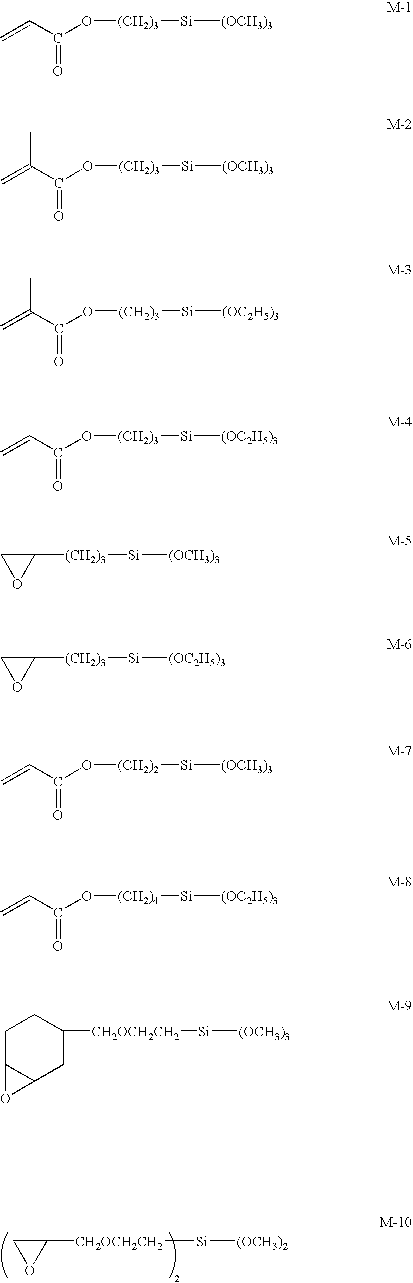

In particular, compounds such as KBM-5103 (M-1) and KBM-503 (both are produced by Shin-Etsu Chemical Co., Ltd.) are preferred.

Furthermore, a surfactant is preferably added to the light-diffusing layer, because the antireflection film of the present invention can be enhanced in the uniformity of plane state. Examples of the surfactant include a perfluoroalkyl group-substituted (meth)acrylate copolymer having from 6 to 12 carbon atoms, a fluoroalkyl group-substituted (meth)acrylate copolymer having an HCF₂— group at the terminal and having from 6 to 12 carbon atoms, a perfluorovinylether copolymer having from 6 to 12 carbon atoms, and a fluoroalkyl vinyl ether having an HCF₂— group at the terminal and having from 6 to 12 carbon atoms.

The process of forming the light-diffusing layer on a surface of the transparent support is described below.

In the present invention, the coating solvent of the light-diffusing layer may be appropriately selected from water and organic solvents and is preferably a liquid having a boiling point of 50° C. or more, more preferably an organic solvent having a boiling point of 60 to 180° C.

Examples of the dispersion medium include alcohols, ketones, esters, amides, ethers, ether esters, hydrocarbons and halogenated hydrocarbons. Specific examples thereof include alcohols (e.g., methanol, ethanol, propanol, butanol, benzyl alcohol, ethylene glycol, propylene glycol, ethylene glycol monoacetate), ketones (e.g., methyl ethyl ketone, methyl isobutyl ketone, cyclohexanone, methyl-cyclohexanone), esters (e.g., methyl acetate, ethyl acetate, propyl acetate, butyl acetate, ethyl formate, propyl formate, butyl formate, ethyl lactate), aliphatic hydrocarbons (e.g., hexane, cyclohexane), halogenated hydrocarbons (e.g., methylchloroform), aromatic hydrocarbons (e.g., benzene, toluene, xylene), amides (e.g., dimethylformamide, dimethylacetamide, n-methylpyrrolidone), ethers (e.g., dioxane, tetrahydrofuran, ethylene glycol dimethyl ether, propylene glycol dimethyl ether), ether alcohols (e.g., 1-methoxy-2-propanol, ethyl cellosolve, methyl carbinol). These may be used individually or as a mixture of two or more thereof. Among these dispersion mediums, preferred are toluene, xylene, methyl ethyl ketone, methyl isobutyl ketone, cyclohexanone and butanol. Also, a coating solvent system mainly comprising a ketone solvent (e.g., methyl ethyl ketone, methyl isobutyl ketone, cyclohexanone) is preferably used.

The light-diffusing layer can be prepared by coating the composition for forming the light-diffusing layer of the present invention on a transparent support which is described later, according to a known thin-firm forming method such as dip coating, air knife coating, curtain coating, roller coating, wire bar coating, gravure coating, microgravure coating and extrusion coating, then allowing the coating to stand until the concave-convex shape on the light-transmitting resin surface due to the first light-transmitting fine particle and the second light-transmitting fine particle is satisfactorily formed, drying it and irradiating light and/or heat thereon. The curing is preferably performed by the irradiation of light, because rapid curing can be advantageously attained. It is also preferred to perform a heat treatment in the latter half of the light curing treatment. The drying may be performed by blowing air at a low temperature near room temperature or may be performed under heat. In the case of drying under heat, the temperature is from 40 to 180° C., preferably from 80 to 150° C. The drying time is preferably from 0.5 to 60 minutes.

The light source for the light irradiation may be any light source as long as it can irradiate an electron beam, an ultraviolet ray or a near infrared ray. Examples of the light include, in the case of electron beam curing, an electron beam having an energy of 50 to 1,000 KeV, preferably from 100 to 300 KeV, emitted from various electron beam accelerators such as Cockcroft-Walton type, Van de Graaff type, resonant transforming type, insulating core-transforming type, linear type, dinamitron type and radio-frequency type, and in the case of ultraviolet ray curing, an ultraviolet ray emitted from a light beam of an ultrahigh-pressure mercury lamp, a high-pressure mercury lamp, a low-pressure mercury lamp, a carbon arc lamp, a xenon arc lamp, a metal halide lamp or the like. Examples of the light source for the ultraviolet ray include ultrahigh-pressure, medium-pressure and low-pressure mercury lamps, a chemical lamp, a carbon arc lamp, a metal halide lamp, a xenon lamp and solar light, and a multibeam formed by using various available laser sources in a wavelength region from 350 to 420 nm may also be irradiated. Examples of the light source for near infrared ray include a halogen lamp, a xenon lamp and a high-pressure sodium lamp, and a multibeam formed by using various available laser sources in a wavelength region from 750 to 1,400 nm may also be irradiated.

The photo-radical polymerization by light irradiation may be performed in an air or in an inert gas, but in order to, for example, shorten the induction period for polymerization of the radical polymerizable monomer or sufficiently elevate the polymerization ratio, the oxygen concentration in the atmosphere is preferably made as low as possible. The irradiation intensity of ultraviolet ray irradiated is preferably on the order of 0.1 to 100 mW/cm² and the light dosage on the coating film surface is preferably from 100 to 1,000 mJ/cm². The temperature distribution of the coating film during the light irradiation is preferably as uniform as possible and the temperature is preferably controlled to +3° C., more preferably +1.5° C. Within this range, the polymerization reaction uniformly proceeds inside the plane of the coating film and in the thickness direction inside the layer and this is preferred.

By such a constitution, a light-diffusing layer having formed thereon irregularities due to the first light-transmitting fine particle and the second light-transmitting fine plate can be provided. In FIG. 1, a light-diffusing layer having formed thereon irregularities is shown, but a light-diffusing layer where irregularities are not formed may also be used.

The surface of the light-diffusing layer may be subjected to shaping or specular working.

<Low Refractive Index Layer>

The low refractive index layer is provided as an outermost layer on a transparent support in the side where the light-diffusing layer is provided, so as to impart an anti-reflection property.

The refractive index of the low refractive index layer is preferably from 1.35 to 1.45.

In the case where the low refractive index layer contains a fluorine-containing compound which is described later, the refractive index is preferably from 1.31 to 1.48.

The refractive index of the low refractive index layer preferably satisfies the following equation (I):
(mλ/4)×0.7<n1d1<(mλ/4)×1.3 Equation (I)
wherein m represents a positive odd number (generally 1), n1 represents the refractive index of the low refractive index layer, d1 represents the thickness (nm) of the low refractive index layer, and λ represents a wavelength of visible light and is a value in the range from 450 to 650 nm.

When the refractive index satisfies equation (I), this means that m (a positive odd number, usually 1) satisfying equation (I) is present in the above-described wavelength range.

The low refractive index layer may be provided by any conventionally known method but is preferably provided by vapor deposition, sputtering, CVD or coating. The coating method includes a sol-gel processing and the curing method described later.

The low refractive index layer of the present invention is preferably provided as an outermost layer having scratch resistance and antifouling property. In order to greatly enhance the scratch resistance, a method of imparting slipperiness to the surface is effective and for this purpose, a conventionally known thin-film layer obtained by introducing silicone, fluorine or the like can be appropriately employed. A fluorine-containing compound is preferably incorporated. Particularly, in the low refractive index layer of the present invention, a cured fluorine-containing resin mainly comprising a heat-curable or ionizing radiation-curable crosslinking fluorine-containing compound is preferably used.

The term “mainly comprising a fluorine-containing compound” as used in the present invention means that the content of the fluorine-containing compound contained in the outermost layer is 50 weight % or more, preferably 60 weight % or more, based on the entire weight of the outermost layer.

The refractive index of the fluorine-containing compound is preferably from 1.35 to 1.50, more preferably from 1.36 to 1.47. Also, the fluorine-containing compound preferably contains a fluorine atom in the range from 35 to 80 weight %.

Examples of the fluorine-containing compound, a fluorine-containing surfactant, a fluorine-containing ether and a fluorine-containing silane compound. Specific examples thereof include the compounds described in JP-A-9-222503 (paragraph Nos. [0018] to [0026]), JP-A-11-38202 (paragraph Nos. [0019] to [0030]) and JP-A-2001-40284 (paragraph Nos. [0027] to [0028]).

The fluorine-containing polymer is preferably a copolymer comprising a repeating structural unit containing a fluorine atom, a repeating structural unit containing a crosslinking or polymerizable functional group, and a repeating structural unit containing a substituent other than those. That is, a copolymer of a fluorine-containing monomer and a monomer for imparting a crosslinking group is preferred and a polymer where other monomer is further copolymerized may also be used.

The crosslinking or polymerizable functional group may be any conventionally known functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Furthermore, a vinylsulfonic acid, an acid anhydride, a cyanoacrylate derivative, melamine, an etherified methylol, an ester and a metal alkoxide such as urethane and tetramethoxysilane, can also be used as the monomer for introducing a crosslinked structure. In addition, a functional group showing a crosslinking property as a result of decomposition reaction, such as block isocyanate group, may also be used. That is, the crosslinking functional group for use in the present invention may be a functional group of not directly causing a reaction but exhibiting a reactivity as a result of decomposition. The compound having such a crosslinking functional group is coated and then heated, whereby a crosslinked structure can be formed.

The polymerizable functional group includes a radical polymerizable group and a cationic polymerizable group.

Examples of the radical polymerizable group include a (meth)acryloyl group, a styryl group and a vinyloxy group.

Examples of the cationic polymerizable group include an epoxy group, a thioepoxy group and an oxetanyl group.

As for the other repeating structural unit, a hydrocarbon-base copolymerization component is preferred for solubilizing the polymer in a solvent. A fluorine-base polymer having introduced thereinto 50 mol % or less of this copolymerization component is preferred. At his time, a silicone compound is preferably used in combination.

The silicone compound is preferably a compound having a polysiloxane structure, which contains a curable functional group or a polymerizable functional group in the polymer chain and provides a crosslinked structure in the film. Examples thereof include commercially available reactive silicones such as SILAPLANE (produced by Chisso Corporation), and compounds containing a silanol group at both terminals of a polysiloxane structure, described in JP-A-11-258403.

The crosslinking or polymerization reaction of the fluorine-containing polymer having a crosslinking or polymerizable group is preferably performed under light irradiation or heat simultaneously with or after the coating of the low refractive index composition for forming an outermost layer.

The polymerization initiator, sensitizer and the like are the same as those described above for the light-diffusing layer.

The other monomer which may be copolymerized is not particularly limited and examples thereof include olefins (e.g., ethylene, propylene, isoprene, vinyl chloride, vinylidene chloride), acrylic acid esters (e.g., methyl acrylate, methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinylbenzene, vinyltoluene, α-methylstyrene), vinyl ethers (e.g., methyl vinyl ether), vinyl esters (e.g., vinyl acetate, vinyl propionate, vinyl cinnamate), acrylamides (e.g., N-tert-butylacrylamide, N-cyclohexyl-acrylamide), methacrylamides and acrylonitrile derivatives.

In combination with the above-described polymer, a curing agent may be appropriately used as described in JP-A-10-25388 and JP-A-10-147739.

The fluorine-containing polymer particularly useful in the present invention is a random copolymer of perfluoroolefin with a vinyl ether or a vinyl ester. In particular, the copolymer preferably has a group capable of undergoing a crosslinking reaction by itself (for example, a radical reactive group such as (meth)acryloyl group, and a ring-opening polymerizable group such as epoxy group and oxetanyl group). This polymerization unit containing a crosslinking reactive group is preferably occupying from 5 to 70 mol %, more preferably from 30 to 60 mol %, of all polymerization units in the polymer.

A preferred embodiment of the copolymer for use in the present invention includes a compound represented by formula 1:

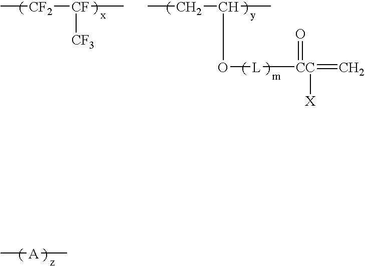

In formula 1, L represents a linking group having from 1 to 10 carbon atoms, preferably a linking group having from 1 to 6 carbon atoms, more preferably a linking group having from 2 to 4 carbon atoms, which may be linear, branched or cyclic and which may have a heteroatom selected from O, N and S.

Preferred examples thereof include *-(CH₂)₂—O-**, *-(CH₂)₂—NH-**, *-(CH₂)₄—O-**, *-(CH₂)₆—O-**, *-(CH₂)₂—O—(CH₂)₂—O-**, *-CONH— (CH₂)₃—O-**, *-CH₂CH(OH)CH₂—O-**, *-CH₂CH₂OCONH(CH₂)₃—O-** (wherein * represents a linking site in the polymer main chain side and ** represents a linking site in the (meth)acryloyl group side). m represents 0 or 1.

In formula 1, X represents a hydrogen atom or a methyl group and in view of curing reactivity, preferably a hydrogen atom.

In formula 1, A represents a repeating unit derived from an arbitrary vinyl monomer and this is not particularly limited as long as it is a constituent component of a monomer copolymerizable with hexafluoropropylene. This repeating unit may be appropriately selected in view of various points such as adhesion to support, Tg of polymer (contributing the film hardness), solubility in solvent, transparency, slipperiness and dust-protecting-antifouling property and according to the purpose, may be constituted by a single vinyl monomer or multiple vinyl monomers.

Preferred examples thereof include vinyl ethers such as methyl vinyl ether, ethyl vinyl ether, tert-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl(meth)acrylate, ethyl (meth)acrylate, hydroxyethyl(meth)acrylate, glycidyl methacrylate, allyl(meth)acrylate and (meth)acryloyloxypropyltrimethoxysilane, styrene derivatives such as styrene and p-hydroxymethylstyrene, unsaturated carboxylic acids such as crotonic acid, maleic acid and itaconic acid, and derivatives thereof. Among these, preferred are vinyl ether derivatives and vinyl ester derivatives, more preferred are vinyl ether derivatives.

x, y and z represent mol % of respective constituent components and each represents a value satisfying 30≦x≦60, 5≦y≦70 and 0≦z≦65, preferably 35≦x≦55, 30≦y≦60 and 0≦z≦20, more preferably 40≦x≦55, 40≦y≦55 and 0≦z≦10, provided that x+y+z=100.

A more preferred embodiment of the copolymer for use in the present invention includes a compound represented by the following formula 2:

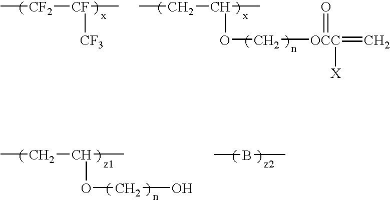

In formula 2, X, x and y have the same meanings as in formula 1 and preferred ranges are the same.

n represents an integer of 2≦n≦10, preferably 2≦n≦6, more preferably 2≦n≦44.

B represents a repeating unit derived from an arbitrary vinyl monomer and may be composed of a single composition or multiple compositions. Examples thereof include those described above as examples of A.

z1 and z2 represent mol % of respective units and each represents a value satisfying 0≦z1≦65 and 0≦z2≦65, preferably 0≦z1≦30 and 0≦z2≦10, more preferably 0≦z1≦10 and 0≦z2≦5, provided that x+y+z1+z2=100.

The copolymer represented by formula 1 or 2 can be synthesized, for example, by introducing according to any method a (meth)acryloyl group into a copolymer comprising a hexafluoropropylene component and a hydroxyalkyl vinyl ether component.

Specific preferred examples of the copolymer useful in the present invention are set forth below, but the present invention is not limited thereto.

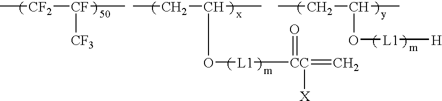

| | | | | | | Number Average |
|---|---|---|---|---|---|---|
| | | | | | | Molecular Weight |
| | x | y | m | L1 | X | Mn (× 10⁴) |
| P-1 | 50 | 0 | 1 | *—CH₂CH₂O— | H | 3.1 |
| P-2 | 50 | 0 | 1 | *—CH₂CH₂O— | CH₃ | 4.0 |
| P-3 | 45 | 5 | 1 | *—CH₂CH₂O— | H | 2.8 |
| P-4 | 40 | 10 | 1 | *—CH₂CH₂O— | H | 3.8 |
| P-5 | 30 | 20 | 1 | *—CH₂CH₂O— | H | 5.0 |
| P-6 | 20 | 30 | 1 | *—CH₂CH₂O— | H | 4.0 |
| P-7 | 50 | 0 | 0 | — | H | 11.0 |
| P-8 | 50 | 0 | 1 | *—C₄H₈O— | H | 0.8 |
| P-9 | 50 | 0 | 1 | 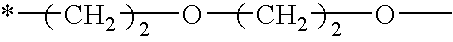 | H | 1.0 |
| P-10 | 50 | 0 | 1 | 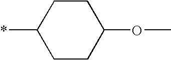 | H | 7.0 |
| P-11 | 50 | 0 | 1 | *—CH₂CH₂NH— | H | 4.0 |
| P-12 | 50 | 0 | 1 | 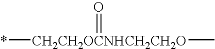 | H | 4.5 |
| P-13 | 50 | 0 | 1 | 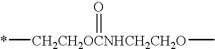 | CH₃ | 4.5 |
| P-14 | 50 | 0 | 1 | 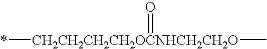 | CH₃ | 5.0 |
| P-15 | 50 | 0 | 1 | 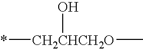 | H | 3.5 |
| P-16 | 50 | 0 | 1 | 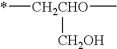 | H | 3.0 |
| P-17 | 50 | 0 | 1 | 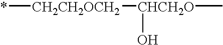 | H | 3.0 |
| P-18 | 50 | 0 | 1 | 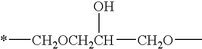 | CH₃ | 3.0 |
| P-19 | 50 | 0 | 1 | 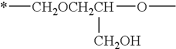 | CH₃ | 3.0 |
| P-20 | 40 | 10 | 1 | *—CH₂CH₂O— | CH₃ | 0.6 |

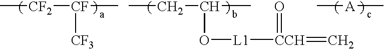

| | | | | | | Number Average |
|---|---|---|---|---|---|---|
| | | | | | | Molecular Weight |
| | a | b | C | L1 | A | Mn (× 10⁴) |
| P-21 | 55 | 45 | 0 | *—CH₂CH₂O—** | — | 1.8 |
| P-22 | 45 | 55 | 0 | *—CH₂CH₂O—** | — | 0.8 |
| P-23 | 50 | 45 | 5 | 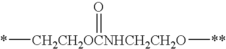 | 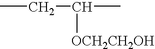 | 0.7 |
| P-24 | 50 | 45 | 5 | 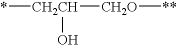 | 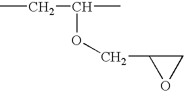 | 4.0 |
| P-25 | 50 | 45 | 5 | 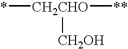 | 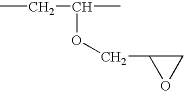 | 4.0 |
| P-26 | 50 | 40 | 10 | *—CH₂CH₂O—** | 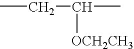 | 4.0 |
| P-27 | 50 | 40 | 10 | *—CH₂CH₂O—** | 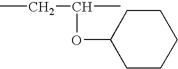 | 4.0 |
| P-28 | 50 | 40 | 10 | *—CH₂CH₂O—** | 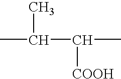 | 5.0 |

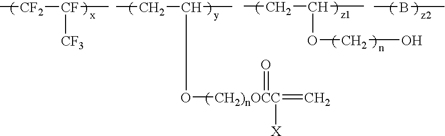

| | | | | | | | | Number Average |
|---|---|---|---|---|---|---|---|---|
| | | | | | | | | Molecular Weight |
| | x | y | z1 | z2 | n | X | B | Mn (× 10⁴) |
| P-29 | 50 | 40 | 5 | 5 | 2 | H | 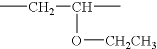 | 5.0 |
| P-30 | 50 | 35 | 5 | 10 | 2 | H | 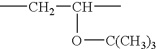 | 5.0 |
| P-31 | 40 | 40 | 10 | 10 | 4 | CH₃ | 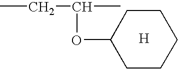 | 4.0 |

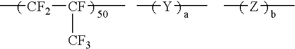

| | | | | | Number Average |
|---|---|---|---|---|---|
| | | | | | Molecular Weight |
| | a | b | Y | Z | Mn (× 10⁴) |
| P-32 | 45 | 5 | 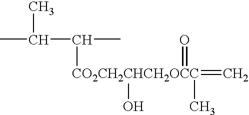 | 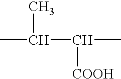 | 4.0 |
| P-33 | 40 | 10 | 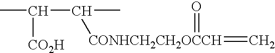 | 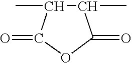 | 4.0 |

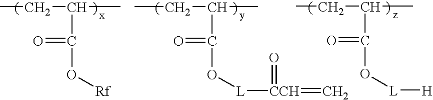

| | | | | | | Number Average |
|---|---|---|---|---|---|---|
| | | | | | | Molecular Weight |
| | x | y | z | Rf | L | Mn (× 10⁴) |
| P-34 | 60 | 40 | 0 | —CH₂CH₂C₈F₁₇-n | *—CH₂CH₂O— | 11 |
| P-35 | 60 | 30 | 10 | —CH₂CH₂C₄F₈H-n | *—CH₂CH₂O— | 30 |
| P-36 | 40 | 60 | 0 | —CH₂CH₂C₆F₁₂H | *—CH₂CH₂CH₂CH₂O— | 4.0 |

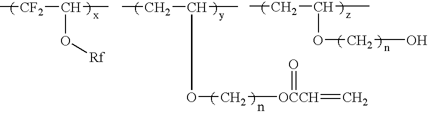

| | | | | | | Number Average |
|---|---|---|---|---|---|---|
| | | | | | | Molecular Weight |
| | x | y | z | n | Rf | Mn (× 10⁴) |
| P-37 | 50 | 50 | 0 | 2 | —CH₂C₄F₈H-n | 5.0 |
| P-38 | 40 | 55 | 5 | 2 | —CH₂C₄F₈H-n | 4.0 |
| P-39 | 30 | 70 | 0 | 4 | —CH₂C₈F₁₇-n | 10 |
| P-40 | 60 | 40 | 0 | 2 | —CH₂CH₂C₈F₁₆H-n | 5.0 |

The synthesis of the copolymer preferably used in the present invention can be performed by synthesizing a precursor such as hydroxyl group-containing polymer according to various polymerization methods such as solution polymerization, precipitation polymerization, suspension polymerization, precipitation polymerization, block polymerization and emulsion polymerization, then introducing a (meth)acryloyl group through the above-described polymer reaction. The polymerization reaction can be performed by a known operation such as batch system, semi-continuous system or continuous system.

The polymerization initiating method includes a method of using a radical initiator, a method of irradiating light or radiation, and the like. Examples of these polymerization methods and polymerization initiating methods include the methods described in Teiji Tsuruta, Kobunshi Gosei Hoho (Polymer Synthesis Method), revised edition, Nikkan Kogyo Shinbun Sha (1971), and Takayuki Ohtsu and Masaetsu Kinoshita, Kobunshi Gosei no Jikken Ho (Test Method of Polymer Synthesis), pp. 124-154, Kagaku Dojin (1972).

Among those polymerization methods, a solution polymerization method using a radical initiator is preferred. Examples of the solvent for use in the solution polymerization include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol. These solvents may be used individually or as a mixture of two or more thereof or may be used as a mixed solvent with water.

The polymerization temperature should be set according to the molecular weight of polymer, the kind of initiator, and the like and a polymerization temperature from 0° C. or less to 100° C. or more can be used, but the polymerization is preferably performed in the range from 50 to 100° C.

The reaction pressure can be appropriately selected but is usually from 1 to 100 kg/cm², preferably from 1 to 30 kg/cm². The reaction time is approximately from 5 to 30 hours.

The reprecipitation solvent for the polymer obtained is preferably isopropanol, hexane, methanol or the like.

As the low refractive index layer, a sol-gel cured film obtained by curing an organic metal compound such as silane coupling agent and a silane coupling agent containing a specific fluorine-containing hydrocarbon group through a condensation reaction in the presence of a catalyst is also preferred.

Examples thereof include polyfluoroalkyl group-containing silane compounds or a partial hydrolysis condensate thereof (compounds described in JP-A-58-142958, JP-A-58-147483, JP-A-58-147484, etc.), perfluoroalkyl group-containing silane coupling agents described in JP-A-9-157582, and silyl compounds containing a poly(perfluoroalkylether) group which is a fluorine-containing long chain group (for example, compounds described in JP-A-2000-117902, JP-A-2001-48590 and JP-A-2002-53804).

Examples of the catalyst used in combination include conventionally known compounds, and preferred examples thereof include those described in the above-described patent publications.

As the additives other than those described above, the low refractive index layer may contain, for example, a filler (for example, an inorganic fine particle or an organic fine particle), a silane coupling gent, a slipping agent (for example, a silicon compound such as dimethylsilicon) and a surfactant. In particular, the low refractive index layer preferably contains an inorganic fine particle, a silane coupling agent and a slipping agent. As the silane coupling agent, those described above regarding the light-diffusing layer are preferred.

The inorganic fine particle is preferably a low refractive index compound such as silicon dioxide (silica and fluorine-containing particle (e.g., magnesium fluoride, calcium fluoride, barium fluoride), more preferably silicon dioxide (silica). The weight average primary particle size of the inorganic fine particle is preferably from 1 to 150 nm, more preferably from 3 to 100 nm. The inorganic fine particles are preferably dispersed as finely as possible.

Examples of the organic fine particle include the compounds described in JP-A-11-3820 (paragraph Nos. [0020] to [0038]).

The inorganic or organic fine particle preferably has a pebble-like, spherical, cubic, spindle-like, staple-like, ring-like or amorphous shape.

Particularly, in order to more reduce the increase in refractive index of the low refractive index layer, a hollow silica fine particle is preferably used. The refractive index of the hollow silica fine particle is from 1.17 to 1.40, preferably from 1.17 to 1.35, more preferably from 1.17 to 1.30. The refractive index used here indicates a refractive index of the particle as a whole but not a refractive index of only the outer-shell silica forming the hollow silica particle. At this time, assuming the radius of cavity in the particle is a and the radius of outer shell of the particle is b, the porosity w (%) represented by the following formula (II) can be calculated according to formula (II):
w={(4πa³/3)/(4πb³/3)}×100 (II)

The porosity is preferably from 10 to 60%, more preferably from 20 to 60%, and most preferably from 30 to 60%.

When the hollow silica particle is made to have a lower refractive index and a larger porosity, the thickness of outer shell becomes small and the strength of particle decreases. Therefore, in view of scratch resistance, a particle having a low refractive index of less than 1.17 is not preferred.

The average particle size of hollow silica particles in the low refractive index layer is preferably from 30 to 100%, more preferably from 35 to 80%, still more preferably from 40 to 60%, of the thickness of the low refractive index layer. In other words, when the thickness of the low refractive index layer is 100 nm, the particle size of the silica fine particle is preferably from 30 to 100 nm, more preferably from 35 to 80 nm, still more preferably from 40 to 60 nm.

The refractive index of the hollow silica particle is measured by an Abbe refractometer (manufactured by Atago Co., Ltd.) or the like.

Also, at least one kind of silica fine particle having an average particle size of less than 25% of the thickness of the low refractive index layer (this fine particle is referred to as a “small particle-size silica fine particle”) is preferably used in combination with the silica fine particle having the above-described particle size (this fine particle is referred to as a “large particle-size silica fine particle”).

The small particle-size silica fine particle can be present in a space between large particle-size silica fine particles and therefore, can contribute as a holding agent of the large particle-size silica fine particle.

When the thickness of the low refractive index layer is 100 nm, the average particle size of the small particle-size silica fine particle is preferably from 1 to 20 nm, more preferably from 5 to 15 nm, still more preferably from 10 to 15 nm. Use of such a silica fine particle is preferred in view of the raw material cost and the holding agent effect.

The silica fine particle may be subjected to a physical surface treatment such as plasma discharge treatment and corona discharge treatment, or a chemical surface treatment with a surfactant, a coupling agent or the like, so as to stabilize the dispersion in a dispersion or a composition solution for the low refractive index layer or to enhance the affinity for or binding property with a binder component. A surface treatment using a coupling agent is particularly preferred. The coupling agent is preferably an alkoxy metal compound (e.g., titanium coupling agent, silane coupling agent). In particular, a treatment with a silane coupling agent is more preferred.

This coupling agent is used as a surface treating agent for previously applying a surface treatment to an inorganic filler of the low refractive index layer before a composition solution for the low refractive index layer is prepared, but the coupling agent is preferably incorporated into the low refractive index layer by further adding it as an additive at the preparation of a coating solution for the layer.

The silica fine particle is preferably dispersed in a medium in advance of the surface treatment so as to reduce the load of the surface treatment.

Those described regarding the silica fine particle may be applied to other inorganic particles.

For the purpose of imparting characteristics such as antifouling property, water resistance, chemical resistance and slipperiness, it is preferred to appropriately add, for example, known silicone- or fluorine-base antifouling agent and slipping agent to the low refractive index layer of the present invention. In the case of adding these additives, the additive is preferably added in an amount of 0.01 to 20 weight %, more preferably from 0.05 to 10 weight %, still more preferably from 0.1 to 5 weight %, based on the entire solid content of the low refractive index layer.

Preferred examples of the silicone-base compound include those having a substituent at the terminal and/or on the side chain of a compound chain containing multiple dimethylsilyloxy units as the repeating unit. In the compound chain containing multiple dimethylsilyloxy units as the repeating unit, a structural unit other than dimethylsilyloxy may be contained. Multiple substituents, which may be the same or different, are preferably present. Preferred examples of the substituent include groups containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, an amino group or the like. The molecular weight is not particularly limited but is preferably 100,000 or less, more preferably 50,000 or less, and most preferably from 3,000 to 30,000. The silicone atom content of the silicone-base compound is not particularly limited but is preferably 18.0 weight % or more, more preferably from 25.0 to 37.8 weight %, and most preferably from 30.0 to 37.0 weight %. Specific preferred examples of the silicone-base compound include, but are not limited to, X-22-174DX, X-22-2426, X-22-164B, X22-164C, X-22-170DX, X-22-176D and X-22-1821 (all are a trade name) produced by Shin-Etsu Chemical Co., Ltd., and FM-0725, FM-7725, DMS-U22, RMS-033, RMS-083 and UMS-182 (all are a trade name) produced by Chisso Corporation.

The fluorine-base compound is preferably a compound having a fluoroalkyl group. The fluoroalkyl group is preferably a fluoroalkyl group having from 1 to 20, more preferably from 1 to 10, carbon atoms, and may be linear (e.g., —CF₂CF₃, —CH₂(CF₂)₄H, —CH₂(CF₂)₈CF₃, —CH₂CH₂(CF₂)₄H), may have a branched structure (e.g., —CH(CF₃)₂, —CH₂CF(CF₃)₂, —CH(CH₃)CF₂CF₃, —CH(CH₃)(CF₂)₅CF₂H) or an alicyclic structure (preferably a 5- or 6-membered ring, for example, a perfluorocyclohexyl group, a perfluorocyclopentyl group or an alkyl group substituted by such a group), or may have an ether bond (e.g., —CH₂OCH₂CF₂CF₃, CH₂CH₂OCH₂C₄F₈H, —CH₂CH₂OCH₂CH₂C₈F₁₇, —CH₂CH₂OCF₂CF₂OCF₂CF₂H). A plurality of these fluoroalkyl groups may be contained within the same molecule.

The fluorine-base compound preferably further contains a substituent capable of contributing to the bond formation or compatibility with the low refractive index layer film. A plurality of such substituents, which may be the same or different, are preferably contained. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine-base compound may be a polymer or oligomer with a compound not containing a fluorine atom, and the polymer or oligomer is used without any particular limitation in the molecular weight. The fluorine atom content of the fluorine-base compound is not particularly limited but is preferably 20 weight % or more, more preferably from 30 to 70 weight %, and most preferably from 40 to 70 weight %. Preferred examples of the fluorine-base compound include, but are not limited to, R-2020, M-2020, R-3833 and M-3833 (all are a trade name) produced by Daikin Kagaku Kogyo K.K., and Megafac F-171, F-172, F-179A and DIFENSA MSF-300 (all are a trade name) produced by Dai-Nippon Ink & Chemicals, Inc.

For the purpose of imparting properties such as dust protection and antistaticity, a dust-protecting agent, an antistatic agent and the like such as known cationic surfactants and polyoxyalkylene-base compound can be appropriately added. These dust-protecting agent and antistatic agent may be contained in the above-described silicone-base compound or fluorine-base compound such that the structural unit thereof forms a part of the function. In the case of adding these additives, the additive is preferably added in the range from 0.01 to 20 weight %, more preferably from 0.05 to 10 weight %, still more preferably from 0.1 to 5 weight %, based on the entire solid content of the low refractive index layer. Preferred examples of the compound include, but are not limited to, Megafac F-150 (trade name) produced by Dai-Nippon Ink & Chemicals, Inc. and SH-3748 (trade name) produced by Toray Dow Corning K.K.

The low refractive index layer may have microvoids in the inside thereof. This is specifically described, for example, in JP-A-9-222502, JP-A-9-288201 and JP-A-11-6902.

The low refractive index layer preferably has a surface energy of 26 mN/m or less, more preferably from 18 to 25.8 mN/m. The surface energy in this range is preferred in view of antifouling property.

The surface energy in this range can be expressed when the low refractive index layer of the present invention is formed as a fluorine-containing cured resin film containing a fluorine-containing compound or mainly comprising a heat-curable or ionizing radiation-curable crosslinking fluorine-containing compound.

In particular, when the fluorine-containing compound contained in the low refractive index layer working out to the outermost layer occupies 50 weight % or more of the entire weight of the outermost layer, an even and stable surface energy is obtained throughout the film surface.

The surface energy of a solid can be determined by a contact angle method, a wet heat method or an adsorption method as described in Nure no Kiso to Oyo (Basis and Application of Wetting), Realize Sha (Dec. 1, 1989). In the case of the film of the present invention, a contact angle method is preferably used.

More specifically, two kinds of solutions each having a known surface energy are dropped on the surface of the polarizing plate protective film and by defining that out of angles made by the tangent of liquid droplet and the film surface at the intersection of the liquid droplet surface and the film surface, the angle including the liquid droplet is the contact angle, the surface energy of the film can be calculated by computation.

The contact angle to water of the outermost surface is preferably 90° or more, more preferably 95° or more, still more preferably 100° or more.

In the present invention, the dynamic friction coefficient on the low refractive index layer surface is preferably 0.25 or less, more preferably from 0.03 to 0.15. The dynamic friction coefficient as used herein means a dynamic friction coefficient between the surface and a stainless steel ball having a diameter of 5 mm when a stainless steel ball is moved on the surface under a load of 0.98 N at a speed of 60 cm/min. The dynamic friction coefficient is more preferably 0.17 or less, still more preferably 0.15 or less.

The strength of the low refractive index layer preferably H or more in a pensile hardness test according to JIS K5400, more preferably 2H or more, and most preferably 3H or more.

Also, the abrasion loss as measured by a Taber test according to JIS K6902 is preferably smaller.

<Other Layers of Antireflection Film>

In the antireflection film of the present invention, an electrically conductive layer (antistatic layer), a hard coat layer, a primer layer, an undercoat layer, a protective layer and the like may be further provided.

[Electrically Conductive Layer]

In the case where the liquid crystal mode of a display device is IPS mode or VA mode, an electrically conductive layer is preferably provided for protecting the surface energy outside the polarizing plate disposed in the viewing side.

The electrically conductive layer may be formed by a conventionally known method, for example, a method of coating an electrically conductive coating solution containing an electrically conductive fine particle and a reactive curable resin, a method of forming a cured film of an electrically conductive polymer, or a method of forming an electrically conductive thin film by vapor-depositing or sputtering a metal, a metal oxide or the like of providing a transparent film. The electrically conductive layer can be formed directly on the support film or through a primer layer of strengthening the adhesion to the support film. The electrically conductive layer may be also used as a part of the antireflection film. In this case, when the electrically conductive layer is close to the outermost layer, a sufficiently high antistatic property can be obtained even when the film thickness is small. The coating method is not particularly limited and according to the properties or coated amount of the coating solution, an optimal method may be selected from known methods such as roll coating, gravure coating, bar coating and extrusion coating.

As for the transparent electrically conductive layer, a conventionally known electrically conductive layer may be used by appropriately adjusting the layer. The electrically conductive layer is described, for example, in Tomei Doden Maku no Genjo to Tenbo (Status Quo and Prospect of Transparent Electrically Conductive Film), edited by the Research Division of Toray Research Center, Toray Research Center (1997), Yutaka Toyoda (supervisor), Tomei Doden Maku no Shin Tenbo (New Prospect of Transparent Electrically Conductive Film), CMC (1999).

The thickness of the electrically conductive layer is preferably from 0.01 to 10 μm, more preferably from 0.03 to 7 μm, still more preferably from 0.05 to 5 μm. The surface resistance of the electrically conductive layer is preferably from 105 to 1,012Ω/□, more preferably from 105 to 109Ω/□, and most preferably from 105 to 108Ω/□. The surface resistance can be measured by a four-point probe method.

It is preferred that the electrically conductive layer is substantially transparent. More specifically, the haze value of the electrically conductive layer is preferably 10% or less, more preferably 5% or less, still more preferably 3% or less, and most preferably 1% or less. The transmission factor for light at a wavelength of 550 nm is preferably 50% or more, more preferably 60% or more, still more preferably 65% or more, and most preferably 70% or more.

The electrically conductive layer of the present invention has excellent strength. More specifically, the strength in terms of a pensile hardness (according to JIS-K-5400) under a load of 1 kg is preferably H or more, more preferably 2H or more, still more preferably 3H or more, and most preferably 4H or more.

(Electrically Conductive Inorganic Fine Particle of Electrically Conductive Layer)

The specific surface area of the electrically conductive inorganic fine particle is preferably from 10 to 400 m²/g, more preferably from 20 to 200 m²/g, still more preferably from 30 to 150 m²/g.

Examples of the electrically conductive fine particle include the inorganic compounds described, for example, in Tomei Doden Maku no Genjo to Tenbo (Status Quo and Prospect of Transparent Electrically Conductive Film), supra, Chap. 3 to 4, and Dodensei Filler no Kaihatsu to Oyo (Development and Application of Electrically Conductive Filler), edited and published by Gijutsu Joho Kyokai (1997).

The electrically conductive fine particle is preferably formed, for example, from an oxide or nitride of metal. Examples of the oxide or nitride of metal include tin oxide, indium oxide, zinc oxide and titanium nitride. Among these, tin oxide and indium oxide are preferred. The electrically conductive inorganic fine particle may contain such a metal oxide or nitride as the main component and further contain other element. The main component means a component of which content (weight %) is largest in components constituting the particle. Examples of other elements include Ti, Zr, Sn, Sb, Cu, Fe, Mn, Pb, Cd, As, Cr, hg, Zn, Al, Mg, Si, P, S, B, Nb, In, V and halogen atoms. In order to enhance the electrical conductivity of tin oxide or indium oxide, Sb, P, B, Nb, In V or a halogen atom is preferably added. In particular, Sb-containing tin oxide (ATO) and Sn-containing indium oxide (ITO) are preferred. The ratio of Sb in ATO is preferably from 3 to 20 weight % and the ratio of Sn in ITO is preferably from 5 to 20 weight %.

The average primary particle size of electrically conductive inorganic fine particles used in the electrically conductive layer is preferably from 1 to 150 nm, more preferably from 5 to 100 nm, and most preferably from 5 to 70 nm. The average particle size of electrically conductive inorganic fine particles in the electrically conductive layer formed is from 1 to 200 nm, preferably from 5 to 150 nm, more preferably from 10 to 100 nm, and most preferably from 10 to 80 nm. The average particle size of electrically conductive inorganic fine particles is an average size weighed with the weight of particle and can be measured by a light-scattering method or an electron microphotograph.

The electrically conductive inorganic fine particle may be subjected to a surface treatment. The surface treatment is performed by using an inorganic compound or an organic compound. Examples of the inorganic compound for use in the surface treatment include alumina and silica. In particular, a silica treatment is preferred. Examples of the organic compound for use in the surface treatment include a polyol, an alkanolamine, a stearic acid, a silane coupling agent and a titanate coupling agent. Among these, a silane coupling agent is most preferred. Two or more surface treatments may be performed in combination.

The electrically conductive inorganic fine particle preferably has a pebble-like, spherical, cubic, spindle-like or amorphous shape. Two or more kinds of electrically conductive inorganic fine particles may be used in combination in the antistatic layer.

The ratio of the electrically conductive inorganic fine particle in the electrically conductive layer is preferably from 20 to 90 weight %, more preferably from 25 to 85 weight %, still more preferably from 30 to 80 weight %.

(Binder of Electrically Conductive Layer)

In the electrically conductive layer, a crosslinked polymer can be used as the binder. The crosslinked polymer preferably has an anionic group. The crosslinked polymer having an anionic group preferably has a structure where the main chain of the polymer having an anionic group is crosslinked. The anionic group has a function of maintaining the dispersion state of electrically conductive inorganic fine particles. The crosslinked structure has a function of imparting a film-forming ability to the polymer and strengthening the electrically conductive layer.

Examples of the polymer main chain include polyolefin (saturated hydrocarbon), polyether, polyurea, polyurethane, polyester, polyamine, polyamide and melamine resin. Among these, a polyolefin main chain, a polyether main chain and a polyurea main chain are preferred, a polyolefin main chain and a polyether main chain are more preferred, and a polyolefin main chain is most preferred.

These polymer main chains can be obtained by any conventionally known method.

The polyolefin main chain comprises a saturated hydrocarbon and can be obtained, for example, by an addition polymerization reaction of an unsaturated polymerizable group. The polyether main chain comprises repeating units bonded through an ether bond (—O—) and can be obtained, for example, by a ring-opening polymerization reaction of an epoxy group. The polyurea main chain comprises repeating units bonded through a urea bond (—NH—CO—NH—) and can be obtained, for example, by a condensation polymerization reaction of an isocyanate group and an amino group. The polyurethane main chain comprises repeating units bonded through a urethane bond (—NH—CO—O—) and can be obtained, for example, by a condensation polymerization reaction of an isocyanate group and a hydroxyl group (including N-methylol group). The polyester main chain comprises repeating units bonded through an ester bond (—CO—O—) and can be obtained, for example, by a condensation polymerization reaction of a carboxyl group (including acid halide group) and a hydroxyl group (including N-methylol group). The polyamine main chain comprises repeating units bonded through an imino bond (—NH—) and can be obtained, for example, by a ring-opening polymerization reaction of an ethyleneimine group. The polyamide main chain comprises repeating units bonded through an amido bond (—NH—CO—) and can be obtained, for example, by a reaction of an isocyanate group and a carboxyl group (including acid halide group). The melamine resin has a crosslinked structure in the main chain itself and can be obtained, for example, by a condensation polymerization reaction of a triazine group (e.g., melamine) and an aldehyde (e.g., formaldehyde).

The anionic group may be directly bonded to the polymer main chain or may be bonded to the main chain through a linking group. The anionic group is preferably bonded to the main chain as a side chain through a linking group.

Examples of the anionic group include a carboxylic acid group (carboxyl), a sulfonic acid group (sulfo) and a phosphoric acid group (phosphono). Among these, a sulfonic acid group and a phosphoric acid group are preferred. The anionic group may take a salt form. The cation of forming a salt with the anionic group is preferably an alkali metal ion. The proton of the anionic group may be in the dissociated state.

The linking group for connecting the anionic group and the polymer main chain is preferably a divalent group selected from —CO—, —O—, an alkylene group, an arylene group and a combination thereof.

The crosslinked structure is formed by chemically bonding (preferably covalently bonding) two or more main chains, preferably by covalently bonding three or more main chains. The crosslinked structure preferably comprises a divalent or greater group selected from —CO—, —O—, —S—, a nitrogen atom, a phosphorus atom, an aliphatic residue, an aromatic residue and a combination thereof.

The polymer having a crosslinked anionic group is preferably a copolymer comprising a repeating unit having an anionic group and a repeating unit having a crosslinked structure. In the copolymer, the ratio of the repeating unit having an anionic group is preferably from 2 to 96 weight %, more preferably from 4 to 94 weight %, and most preferably from 6 to 92 weight %. The repeating unit may have two or more anionic groups. In the copolymer, the ratio of the repeating unit having a crosslinked structure is preferably from 4 to 98 weight %, more preferably from 6 to 96 weight %, and most preferably from 8 to 94 weight %.

The repeating unit in the crosslinked polymer having an anionic group may have both an anionic group and a crosslinked structure. Also, other repeating unit (a repeating unit having neither an anionic group nor a crosslinked structure) may be contained.

The other repeating unit is preferably a repeating unit having an amino group or a quaternary ammonium group, or a repeating unit having a benzene ring. The amino group or quaternary ammonium group has a function of, similarly to the anionic group, maintaining the dispersion state of inorganic fine particles and such a group is preferred. Incidentally, even when the amino group, quaternary ammonium group or benzene ring is contained in the repeating unit having an anionic group or in the repeating unit having a crosslinked structure, the same effect can be obtained.

The repeating unit having an amino group or a quaternary ammonium group can be obtained by bonding an amino group or a quaternary ammonium group to the polymer main chain directly or through a linking group. The amino group or quaternary ammonium group is preferably bonded to the polymer main chain as a side chain through a linking group. The amino group or quaternary ammonium group is preferably a secondary amino group, a tertiary amino group or a quaternary ammonium group, more preferably a tertiary amino group or a quaternary ammonium group. The group bonded to the nitrogen atom of the tertiary amino group or quaternary ammonium group is preferably an alkyl group and the alkyl group is preferably an alkyl group having from 1 to 12 carbon atoms, more preferably an alkyl group having from 1 to 6 carbon atoms. The counter ion of the quaternary ammonium group is preferably a halide ion. The linking group of connecting an amino group or a quaternary ammonium group to the polymer main chain is preferably a divalent group selected from —CO—, —NH—, —O—, an alkylene group, an arylene group and a combination thereof. In the case where the crosslinked polymer having an anionic group contains a repeating unit having an amino group or a quaternary ammonium group, the ratio thereof is preferably from 0.06 to 32 weight %, more preferably from 0.08 to 30 weight %, and most preferably from 0.1 to 28 weight %.

In combination with the binder, a reactive organic silicon compound in the following (1) to (3) described, for example, in JP-A-2003-39586 may be used. The reactive organic silicon compound is used in the range from 10 to 100 weight % based on the total of the ionizing radiation-curable resin and the reactive organic silicon compound. In particular, when an ionizing radiation-curable organic silicon compound of (3) is used, the electrically conductive layer can be formed by using only this compound as the resin component.

(1) Silicon Alkoxide

This is a compound represented by R¹¹ₚSi(OR¹²)_{q}, wherein R¹¹ and R¹² each represents an alkyl group having from 1 to 10 carbon atoms and p and q each is an integer satisfying p+q=4. Examples thereof include tetramethoxysilane, tetraethoxysilane, tetra-iso-propoxysilane, tetra-n-propoxysilane, tetra-n-butoxysilane, tetra-sec-butoxysilane, tetra-tert-butoxysilane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltrimethoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane and hexyltrimethoxysilane.

(2) Silane Coupling Agent

Examples of this compound include γ-(2-aminoethyl)-aminopropyltrimethoxysilane, γ-(2-aminoethyl)aminopropylmethyldimethoxysilane, β-(3,4-epoxycyclohexyl)ethyltrimethoxysilane, γ-aminopropyltriethoxysilane, γ-methacryloxypropyltrimethoxysilane, N-β-(N-vinylbenzyl-aminoethyl)-γ-aminopropylmethoxysilane hydrochloride, γ-glycidoxypropyltrimethoxysilane, aminosilane, methyltrimethoxysilane, vinyltriacetoxysilane, γ-mercaptopropyltrimethoxysilane, γ-chloropropyltrimethoxysilane, hexamethyldisilazane, vinyltris(β-methoxyethoxy)silane, octadecyldimethyl[3-(trimethoxysilyl)propyl]ammonium chloride, methyltrichlorosilane and dimethyldichlorosilane.

(3) Ionizing Radiation-Curable Silicon Compound

Examples of this compound include organic silicon compounds having a molecular weight of 5,000 or less and containing multiple groups of undergoing reaction and crosslinking when irradiated with ionizing radiation, for example, polymerizable double bond groups. Specific examples of this reactive organic silicon compound include a functional polysilane terminated by vinyl at one end, a functional polysilane terminated by vinyl at both ends, a functional polysiloxane terminated by vinyl at one end, a functional polysiloxane terminated by vinyl at both ends, and vinyl functional polysilane and vinyl functional polysiloxane obtained by reacting such a vinyl-terminated compound.

Examples of other compounds include (meth)acryloxy-silane compounds such as 3-(meth)acryloxypropyltrimethoxysilane and 3-(meth)acryloxypropylmethyldimethoxysilane.

[Hard Coat Layer]

For imparting physical strength to the antireflection film, the hard coat layer is preferably provided on the surface of a transparent support, preferably between the transparent support and the light-diffusing layer.

The hard coat layer is preferably formed by a crosslinking or polymerization reaction of a light- and/or heat-curable compound.

The curable functional group is preferably a photopolymerizable functional group, and the hydrolyzable functional group-containing organic metal compound is preferably an organic alkoxysilyl compound.

Specific examples of these compounds include those described above in regard of the light-diffusing layer.

Specific examples of the composition for constituting the hard coat layer include those described in JP-A-2002-144913, JP-A-2000-9908 and International Publication 00/46617 (pamphlet).

In an embodiment of the hard coat layer, an electrically containing hard coat layer containing the above-described electrically conductive fine particle is also preferred.

[Transparent Support]

Examples of the material for the transparent support include a transparent resin film, a transparent resin plate, a transparent resin sheet and a transparent glass. Examples of the transparent resin film which can be used include a triacetylcellulose (TAC) film, a polyethylene terephthalate (PET) film, a diacetylene cellulose film, an acetate butyrate cellulose film, a polyether sulfone film, a polyacrylic resin film, a polyurethane resin film, a polyester film, a polycarbonate film, a polysulfone film, a polyether film, a trimethylpentene film, a polyether ketone film and a (meth)acrylonitrile film. The thickness is usually on the order of 25 to 1,000 μm and from the standpoint of lightweighting the protective film, preferably from 30 to 200 μm, more preferably from 30 to 100 μm.

The transparent support of the present invention is used as the outermost surface of a polarizing plate and therefore, a cellulose acylate film commonly used as the protective film of a polarizing film is preferably used.

The cellulose acylate film having high transparency and smooth surface, which can be particularly preferably used as the transparent support film of the antireflection film of the present invention, is described below.

(Cellulose Acylate Film Having High Transparency and High Smoothness)

In the present invention, the cellulose acylate means a fatty acid ester of cellulose. A lower fatty acid ester of cellulose is more preferred.

The lower fatty acid means a fatty acid having 6 or less carbon atoms and the number of carbon atoms is preferably 2 (cellulose acetate), 3 (cellulose propionate) or 4 (cellulose butyrate). The cellulose ester is preferably cellulose acetate and examples thereof include diacetyl cellulose and triacetyl cellulose. A mixed fatty acid ester such as cellulose acetate propionate and cellulose acetate butyrate is also preferably used.

In the present invention, a cellulose acylate having an acetylation degree of 59.0 to 61.5% is preferably used.

The acetylation degree means an amount of acetic acid bonded per unit weight of cellulose. The acetylation degree is determined in accordance with the measurement and calculation of acylation degree in ASTM D-817-91 (test method of cellulose acetate, etc.).

The viscosity average polymerization degree (DP) of cellulose ester is preferably 250 or more, more preferably 290 or more.

The cellulose ester for use in the present invention preferably has a narrow molecular weight distribution Mw/Mn (Mw is a weight average molecular weight and Mn is a number average molecular weight) as measured by gel permeation chromatography. Specifically, the Mw/Mn value is preferably from 1.0 to 1.7.

In the cellulose acylate, the hydroxyl groups at the 2-position, 3-position and 6-position are not evenly distributed in ⅓ portions of the entire substitution degree, but the substitution degree of hydroxyl group at the 6-position is liable to become small. The substitution degree of hydroxyl group at the 6-position of cellulose acylate is preferably larger than those at the 2-position and 3-position.

The hydroxyl group at the 6-position is preferably substituted by an acyl group to account for 32% or more, preferably 33% or more, more preferably 34% or more, of the entire substitution degree. Furthermore, the substitution degree of acyl group at the 6-position of cellulose acylate is preferably 0.88 or more.

The hydroxyl group at the 6-position may be substituted by an acyl group having 3 or more carbon atoms (e.g., propionyl, butyroyl, valeroyl, benzoyl, acryloyl) other than an acetyl group. The substitution degree at each position can be determined by NMR.

The cellulose acylate film is specifically described in JIII Journal of Technical Disclosure, No. 2001-1745.

The transparent support film is more preferably a cellulose acylate film having no birefringence, because a polarizing plate can be produced by laminating a light-diffusing antireflection film and a polarizing element as described later and furthermore, a liquid crystal display device with excellent display quality can be obtained by using the polarizing plate.

Also, in view of processability such as heat resistance, solvent resistance and mechanical strength when coating the light-diffusing layer by various coating methods, the transparent support film is particularly preferably PET.

[Production of Antireflection Film]

Each layer of the antireflection film of the present invention can be formed by dissolving the composition for forming each layer in a dispersion medium for coating, which is described later, and applying the obtained coating solution by a coating method such as dip coating, air knife coating, curtain coating, roller coating, die coating, wire bar coating, gravure coating or extrusion coating (described in U.S. Pat. No. 2,681,294). Each layer is preferably coated by a die coating method. More preferably, the coating step is preferably performed by using a die coater which is described later. Two or more layers may be coated simultaneously. As for the simultaneous coating method, the methods described in U.S. Pat. Nos. 2,761,791, 2,941,898, 3,508,947 and 3,526,528 and Yuji Harasaki, Coating Kogaku (Coating Engineering), page 253, Asakura Shoten (1973) can be used without limitation.

In the antireflection film of the present invention, at least a light-diffusing layer and a low refractive index layer are stacked and therefore, when foreign matters such as dirt or dust are present, luminescent spot defects tend to become conspicuous. The luminescent spot defect as used in the present invention means a defect viewed with an eye due to reflection on the coating film, and this defect can be detected with an eye by applying an operation such as black painting to the back surface of the coated antireflection film. The size of the luminescent spot defect viewable with an eye is generally 50 μm or more.

In the antireflection film of the present invention, the number of luminescent spot defects is preferably 20 or less, more preferably 10 or less, still more preferably 5 or less, yet still more preferably 1 or less, per square meter. This range is preferred in view of yield at the production and also preferred because there arises no problem at the production of a large-area antireflection film.

In order to continuously produce the antireflection film of the present invention, a step of continuously delivering a roll-form transparent support film, a step of coating a coating solution, a step of drying it, a step of curing the coating film, and a step of taking up the support film having a cured layer are performed.

A support film is continuously delivered from the roll-form support film to a clean room, the static electricity charged to the support film is removed by a static electricity-removing apparatus in the clean room, and the foreign matters adhering on the support film are then removed by a dust-removing apparatus. Subsequently, a coating solution is coated on the support film in the coating section provided in the clean room and the coated support film is transferred to a drying room and dried.

The support film having a dried coating layer is transferred from the drying room to a radiation curing room and irradiated with radiation to cure the coating layer by causing polymerization of the curable resin contained in the coating layer. The support having a layer cured with radiation is transferred to a heat curing section and cured, thereby completing the curing. The support film having a completely cured layer is taken up into a roll form.

These steps may be performed every formation of each layer or by providing multiple coating sections-multiple drying rooms-multiple radiation curing sections-multiple heat curing rooms, respective layers may be continuously formed. In view of productivity, respective layers are preferably continuously formed.

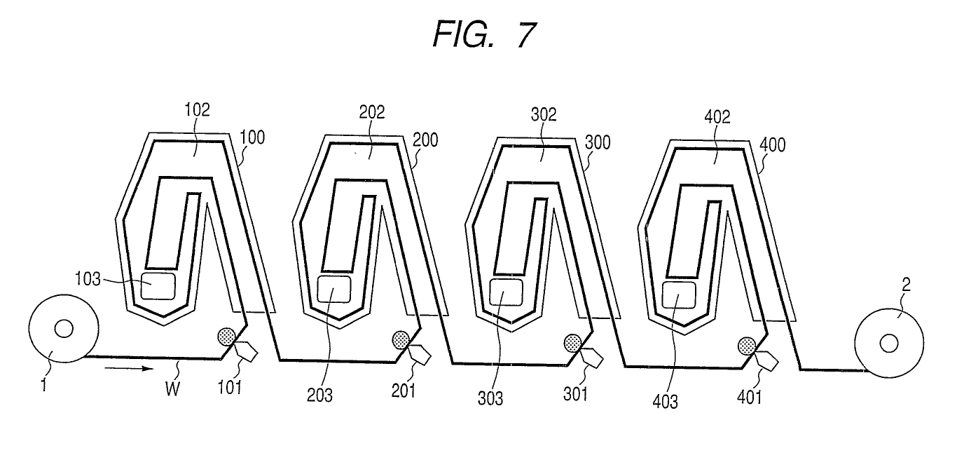

This is specifically described below by referring to FIG. 7 showing one embodiment of the production apparatus which is preferably used in the present invention.

FIG. 7 is a schematic view showing one embodiment of the production apparatus which is preferably used in the present invention.

In the production apparatus shown in FIG. 7, a web W, a roll 1 and multiple guide rollers (not shown) are disposed for performing the step of continuously delivering a support film, a take-up roll 2 is disposed for performing the step of taking up the support film, and a necessary number of film formation units 100, 200, 300 and 400 are appropriately disposed for performing the steps of coating, drying and curing the coating film. In this embodiment, the film formation unit 100 is disposed for the formation of a hard coat layer, the film formation unit 200 is for the formation of an electrically conductive layer, the film formation unit 300 is for the formation of a light-diffusing layer, and the film formation unit 400 is for the formation of a low refractive index layer.

These film formation units have the same structure and therefore, the film formation is described below by referring to the film formation unit 100. The film formation unit 100 comprises a coating section 101 for performing the step of coating a coating solution, a drying section 102 for performing the step of drying the solution coated, and a curing device 103 for performing the step of curing the dried coating solution.

The apparatus shown in FIG. 7 is one example of the constitution where four layers are continuously coated without taking up the film, but the number of film formation units can be of course changed according to the layer structure.

It is preferred to use an apparatus having three film formation units, where a roll-form support film having coated thereon the above-described hard coat layer is continuously delivered, a hard coat layer, a light-diffusing layer and a low refractive index layer are sequentially coated by respective film formation units, and then the support film is taken up, more preferably an apparatus having four film formation units shown in FIG. 7, where a roll-form support film is continuously delivered, a hard coat layer, a hard coat layer, a light-diffusing layer and a low refractive index layer are sequentially coated by respective film formation units, and then the support film is taken up.

Among those coating methods, a microgravure method is generally preferred. The light-diffusing layer and low refractive index layer of the present invention can also be produced by a microgravure method. This method can give a good surface state regarding the coated amount distribution in the cross direction and various surface state failures and can also give satisfactory performance regarding the coated amount distribution in the longitudinal direction by optimizing the material, shape or the like of the metal blade used for scraping off.

On the other hand, in view of higher production rate, an extrusion method (die coating method) is preferred. The die coating method is preferably used because both the productivity and the surface state free from coating unevenness can be obtained in a high level.

The antireflection film of the present invention is preferably produced by the following production method of the present invention using such a die coating method.

That is, the preferred production method is a method for producing an antireflection film, comprising a coating step of bringing the land of a leading lip of a slot die closer to the surface of a continuously travelling web supported by a backup roll, and coating a coating solution from the slot of the leading lip, wherein in the coating step, at least either one or both of a light-diffusing layer and a low refractive index layer is coated by using a coating apparatus comprising a slot die in which the leading lip of the slot die on the web progressing direction side has a land length of 30 to 100 μm in the web travelling direction and the leading lip on the side opposite the web progressing direction and the web are disposed to give a gap larger by 30 to 120 μm (hereinafter, this numerical limitation is called an “overbite length”) than the gap between the leading lip in the web progressing direction and the web when the slot die is set to the coating position.

The die coater which can be preferably used particularly in the production method of the present invention is described below by referring to the drawing. This die coater is preferred because it can be used in the case where the wet coated amount is small (20 ml/m² or less).

<Constitution of Die Coater>

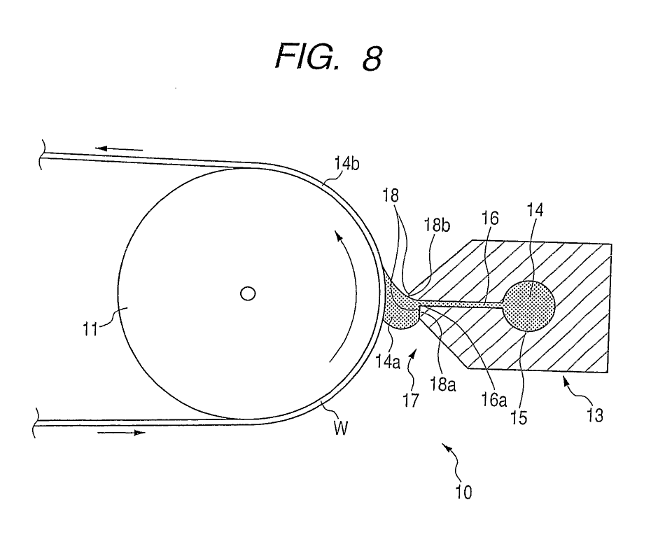

FIG. 8 is a cross-sectional view of a coater (coating apparatus) using a slot die with which the present invention can be suitably performed.

The coater 10 comprises a backup roll 11 and a slot die 13, and a coating solution 14 in the bead shape 14a is ejected from the slot die 13 to a continuously travelling web W supported by the backup roll 11 to form a coating film 14b on the web W.

In the inside of the slot die, a pocket 15 and a slot 16 are formed. The cross section of the pocket 15 is constituted by a curve and a straight line and may have a nearly circular or semicircular shape. The pocket 15 is a liquid reservoir space for the coating solution, extended with its cross-sectional shape to the cross direction of the slot die 13 (here, the cross direction of the slot die 13 means the front or rear direction on facing the drawing shown in FIG. 8), and the length of effective extension is generally set to be equal to or slightly longer than the coating width. The coating solution 14 is supplied to the pocket 15 from the side face of the slot die 13 or from the center of the face on the side opposite the slot opening 16a. In the pocket 15, a stopper (not shown) for preventing the coating solution 14 from leaking out is provided.

The slot 16 is a flow path of the coating solution 14 from the pocket 15 to the web W and similarly to the pocket 15, its cross-sectional shape is extending in the width direction of the slot die 13. The opening 16a positioned in the web side is generally adjusted to have nearly the same length as the coating width by using a width regulating plate (not shown) or the like. The angle between the slot end of the slot 16 and the tangent of the backup roll 11 in the web W travelling direction is preferably 30 to 90°.

The leading lip 17 of the slot die 13, where the opening 16a of the slot 16 is positioned, is tapered and the distal end is forming a flat part 18 called a land. In this land 18, the upstream side in the web W progressing direction with respect to the slot 16 (the side opposite the progressing direction, that is, opposite the arrow direction in the figure) is called an upstream lip land 18a and the downstream side (progressing direction side) is called a downstream lip land 18b.

The gap between the upstream lip land 18a and the web is larger in the above-described range than the gap between the downstream lip land 18b and the web 2. Also, the length of the downstream lip land 18b is in the above-described range.

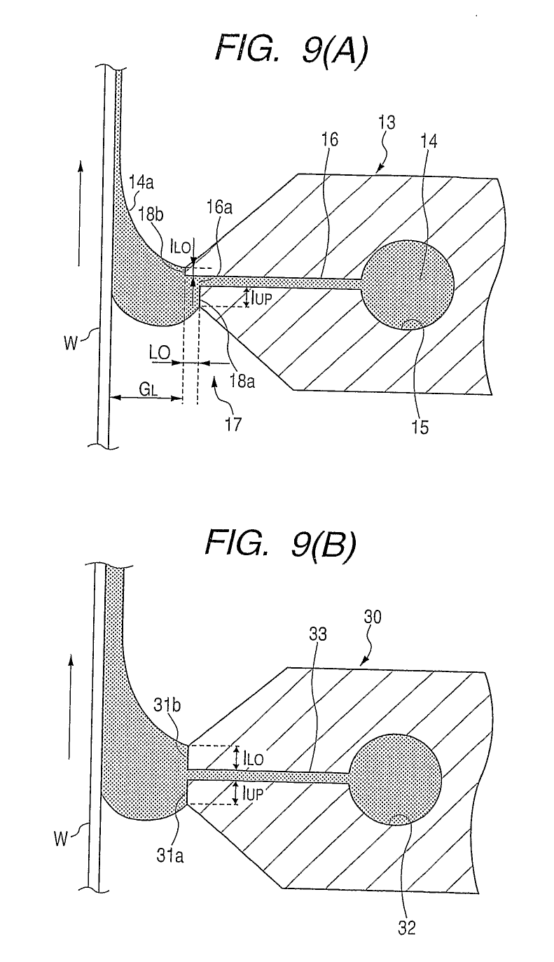

When the sites related to the above-described numerical limitation are described by referring to FIG. 9(A), the land length in the web progressing direction side is the portion shown by l_{LO} in FIG. 9(A) and the overbite length is the portion shown by LO in FIG. 9.

The coating apparatus used for practicing the production method of an antireflection film of the present invention and a conventional coating apparatus are compared below by referring to FIG. 9. Here, FIG. 9 shows the cross-sectional shape of the slot die 13 by comparing it with a conventional slot die, where FIG. 9(A) shows the slot die 13 of the present invention and FIG. 9(B) shows a conventional slot die 30.

In the conventional slot die 30, the distance between the upstream lip land 31a and the web and the distance between the downstream lip land 31b and the wet are equal. The numeral 32 denotes a pocket and 33 denotes a slot. On the other hand, in the slot die 13 of the present invention, the downstream lip land length l_{LO} is made shorter and by virtue of this constitution, coating of a film in a wet thickness of 20 μm or less can be performed with good precision.

The land length 1_{UP} of the upstream lip land 18a is not particularly limited but is preferably from 500 μm to 1 mm. The land length l_{LO} of the downstream lip land 18b is preferably from 30 to 100 μm as described above, more preferably from 30 to 80 μm, and most preferably from 30 to 60 μm. When the land length l_{LO} of the downstream lip land is 30 μm or more, the edge or land of the leading lip is less chipped and the generation of streaks on the coating film can be advantageously prevented. Also, the wetting line position in the downstream side can be set with ease and furthermore, the coating solution can be advantageously prevented from spreading in the downstream side. The spreading of the coating solution due to wetting in the downstream side means non-uniformity of the wetting line and leads to a problem of incurring a defective shape such as streak on the coated surface. On the other hand, when the land length l_{LO} of the downstream lip land is 100 μm or less, a bead 14a can be formed and by the bead 14a formation of the coating solution, thin-layer coating can be performed.

The downstream lip land 18b has an overbite shape of approaching closer to the web B than the upstream lip land 18a and therefore, the depression degree can be decreased, as a result, a bead 14a suitable for thin-film coating can be formed. The difference (hereinafter referred to as a “overbite length LO”) between the distance from the upstream lip land 18b to the web W and the distance from the upstream lip land 18a to the web B is preferably from 30 to 120 μm, more preferably from 30 to 100 μm, still more preferably from 30 to 80 μm. When the slot die 13 is in the overbite shape, the gap G_{L} between the leading lip 17 and the web W means the gap between the downstream lip land 18b and the web W.

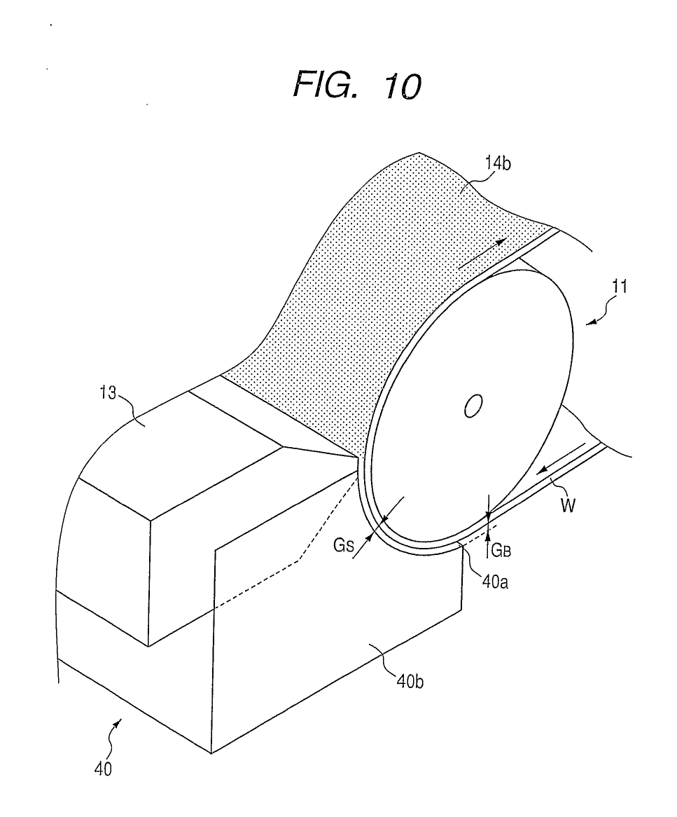

The coating step in general is described below by referring to FIG. 10.

FIG. 10 is a perspective view showing the slot die 13 and its periphery in the coating step for practicing the production method of the present invention. On the side opposite the web W progressing direction with respect to the slot die 13 (that is, on the upstream side than the bead 14a), a depression chamber 40 is disposed at the position not coming into contact with the bead 14a so as to satisfactorily adjusting the depression. The depression chamber 40 comprises a back plate 40a and a side plate 40b for maintaining its operation efficiency and a gap G_{B} and a gap Gs are present between the back plate 40a and the web W and between the side plate 40b and the web W, respectively.

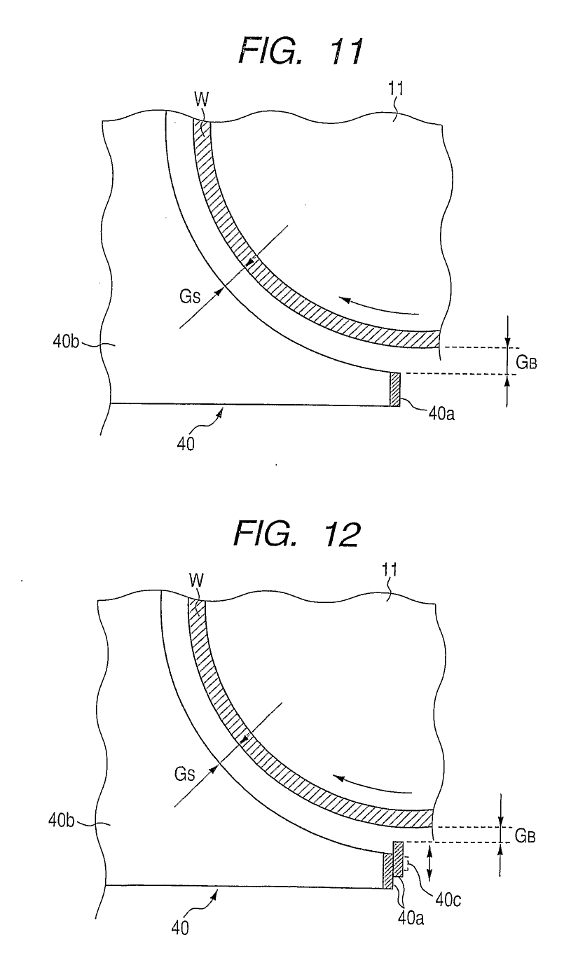

The relationship between the depression chamber 40 and the web B is described below by referring to FIGS. 11 and 12. FIGS. 11 and 12 each is a cross-sectional view showing the depression chamber 40 and the web W approaching closer.

The side plate 40b and the back plate 40a may be integrated with the main body of the chamber 40 as shown in FIG. 11 or, for example, as shown in FIG. 12, the back plate 40a may be secured to the chamber 40 by a screw 40c or the like so that the gap G_{B} can be appropriately changed. In any structure, the portions actually emptying between the back plate 40a and the web B and between the side plate 40b and the web W are defined as gaps G_{B} and G_{S}, respectively. The gap G_{B} between the back plate 40a of the depression chamber 40 and the web W indicates a gap from the uppermost end of the back plate 40a and the web W when the depression chamber 40 is disposed, as shown in FIG. 10, below the slot die 13.

The depression chamber is preferably disposed such that the gap G_{B} between the back plate 40a and the web W becomes larger than the gap G_{L} (see, FIG. 9) between the leading lip 17 of the slot die 13 and the web W, whereby the depression degree in the vicinity of the bead can be prevented from changing due to eccentricity of the backup roll 11. For example, when the gap G_{L} between the leading lip 17 of the slot die 13 and the web W is from 30 to 100 μm, the gap G_{B} between the back plate 40a and the web W is preferably from 100 to 500 μm.

<Construction Material and Precision>

The length in the web travelling direction of the leading lip on the web progressing direction side (the downstream lip land length l_{LO} shown in FIG. 9(A)) is preferably in the above-described range. Also, the fluctuation width of l_{LO} in the slot die cross direction is preferably within 20 μm. With the fluctuation width in this range, the bead can be stable even when slight disturbance may occur, and this is preferred.

As for the construction material for the leading lip of the slot die, stainless steel and the like are not preferred because such a construction material is worn at the die working stage. In the case of a stainless steel or the like, even when the downstream lip land length l_{LO} is set to the above-described range from 30 to 100 μm, it is difficult to satisfy the precision of the leading lip. For maintaining high working precision, a super-hard material described in Japanese Patent No. 2817053 is preferably used. More specifically, at least the leading lip of the slot die is preferably formed of a cemented carbide obtained by binding carbide crystals having an average particle size of 5 μm or less. Examples of the cemented carbide include those obtained by binding carbide crystal particles such as tungsten carbide (hereinafter referred to as WC) with a binding metal such as cobalt. As for the binding metal, titanium, tantalum, niobium and a mixed metal thereof may be also used other than cobalt. The average particle size of WC crystal is preferably 3 μm or less.

For realizing high-precision coating, the downstream lip land length l_{LO} is important and furthermore, the fluctuation width of the gap G_{L} in the slot die cross direction is preferably controlled. Between the backup roll 11 and the leading lip 17, a straightness is preferably established within the range of enabling the control of fluctuation width of the gap G_{L} in the slot die cross direction. The straightness between the leading lip 17 and the backup roll 11 is preferably established such that the fluctuation width of the gap G_{L} in the slot die cross direction becomes 5 μm or less.

In order to prepare an antireflection film having the above-described range reduced in the luminescent spot defect, this may be attained by precisely controlling the dispersion of high refractive index metal oxide ultrafine particles and light-transmitting fine particles in the coating material for the light-diffusing layer and by microfiltering the coating solution. In combination with these, the coating step in the coating section and the drying step in the drying room in the process of forming each layer constituting the antireflection film are preferably performed in an air atmosphere having a high cleanliness and at the same time, the dirt and dust on the film are preferably satisfactorily removed before the coating is performed. The air cleanliness in the coating and drying steps is, based on the air cleanliness prescribed in US Federal Standard 209E, preferably class 10 (the number of particles of 0.5 μm or more is 353/m³ or less) or more, more preferably class 1 (the number of particles of 0.5 μm or more is 35.5/m³ or less) or more.

Examples of the dust-removing method used in the dust-removing step as a pre-step before coating include dry dust-removing methods such as a method of pressing a non-woven fabric, a blade or the like to the film surface described in JP-A-59-150571, a method of blowing an air of high cleanliness at a high speed to separate the attached matters from the film surface and sucking them from the adjacent suction port described in JP-A-10-309553, and a method of blowing a compressed air under ultrasonic vibration to separate the attached matters and sucking them (e.g., New Ultra-Cleaner, manufactured by Shinko Sha) described in JP-A-7-333613. Also, a wet dust-removing method may be used, such as a method of introducing the film into a cleaning tank and separating the attached matters by an ultrasonic vibrator, a method of supplying a cleaning solution to the film and then performing high-speed blowing of air and sucking described in JP-B-49-13020, and a method of continuously rubbing the web with a liquid-wetted roll and cleaning the rubbed surface by jetting a liquid thereon. Among these dust-removing methods, a dust-removing method by ultrasonic wave and a wet dust-removing method are preferred in view of dust-removing effect.

Before performing such a dust-removing step, the static electricity on the support film is preferably removed in view of elevating the dust-removing efficiency and preventing the attachment of dusts. For such an electricity-removing method, a corona discharge-type ionizer, a light (e.g., UV, soft X ray) irradiation-type ionizer and the like can be used. The electric charge voltage of the support film before and after dust removal and coating is preferably 1,000 V or less, more preferably 300 V or less, still more preferably 100 V or less.

[Dispersion Medium for Coating]

The dispersion medium for coating used in the coating solution is not particularly limited and one dispersion medium or a mixture of two or more dispersion mediums may be used. Preferred examples of the dispersion medium include aromatic hydrocarbons such as toluene, xylene and styrene, chlorinated aromatic hydrocarbons such as chlorobenzene and ortho-dichlorobenzene, chlorinated aliphatic carbons such as methane derivatives (e.g., monochloromethane) and ethane derivatives (e.g., monochloroethane), alcohols such as methanol, isopropyl alcohol and isobutyl alcohol, esters such as methyl acetate and ethyl acetate, ethers such as ethyl ether and 1,4-dioxane, ketones such as acetone, methyl ethyl ketone, methyl isobutyl ketone and cyclohexanone, glycol ethers such as ethylene glycol monomethyl ether, alicyclic hydrocarbons such as cyclohexane, aliphatic carbons such as normal hexane, and a mixture of aliphatic or aromatic hydrocarbons. Among these solvents, a dispersion medium for coating prepared by using ketones individually or in combination of two or more thereof is preferred. In the case of coating the coating solution by a die coating method, the dispersion medium for coating is preferably used to give the following liquid properties based on the solid components in the composition for forming each layer.

[Properties of Coating Solution]

The production method of the present invention preferably employs a coating system where the liquid properties at the moment of coating, particularly, the viscosity and surface tension, are controlled. By controlling the liquid properties, the coatable upper limit rate can be elevated and this is preferred. The coatable upper limit rate can also be elevated by controlling the amount of the coating solution coated on the web surface and therefore, this is also preferred.

The viscosity of the coating solution at the coating is preferably 2.0 [mPa·sec] or less, more preferably 1.5 [mPa·sec] or less, and most preferably 1.0 [mPa·sec] or less. These values show a viscosity at a shear rate at the moment of coating because depending on the coating solution, the viscosity changes due to the shear rate. When a thixotropy agent is added to the coating solution, the viscosity is low at the coating of yielding high searing but becomes high at the drying almost free of shearing on the coating solution and unevenness at the drying is advantageously less generated.

The amount of the coating solution coated on the web surface is preferably from 2.0 to 5.0 [ml/m²]. Within this range, the coatable upper limit rate can be elevated and this is also preferred from the standpoint of decreasing the load of drying. The optimal amount of the coating solution coated on the web surface is preferably determined according to the formulation of solution and conditions in the step.

The surface tension is preferably from 15 to 36 [mN/m], because within this range, unevenness at the drying can be prevented. The surface tension is more preferably from 17 to 32 [mN/m], still more preferably from 19 to 26 [mN/m]. Within this range, the coatable upper limit rate is advantageously not decreased. The surface tension can be controlled, for example, by adding a leveling agent.

In the production method of the present invention, the coating solution is preferably coated on the surface of the continuously travelling web at a rate of 25 [m/min] or more.

[Filtration]

The coating solution for use in the coating is preferably filtered before coating. The filter for the filtration preferably has a pore size as small as possible within the range of not removing the components in the coating solution. The filter used for the filtration preferably has an absolute filtration precision of 0.1 to 10 μm, more preferably from 0.1 to 5 μm. The thickness of the filter is preferably from 0.1 to 10 mm, more preferably from 0.2 to 2 mm. In this case, the filtration pressure is preferably 1.5 MPa or less, more preferably 1.0 MPa or less, still more preferably 0.2 MPa or less.

The filter member for the filtration is not particularly limited as long as it does not affect the coating solution. Specific examples thereof include those described above as the filtration member for the wet dispersion product of inorganic compound.

For accelerating the defoaming and maintaining the dispersion of the dispersion product, the filtered coating solution is also preferably subjected to ultrasonic dispersion immediately before coating.

<Performance of Antireflection Film>

(Optical Properties)

The antireflection film of the present invention is characterized in that the light-diffusing layer has an inner haze value of 30 to 60% and a surface haze value of 1% or less. The haze value can be measured according to JIS-K-7105 by using a haze meter (for example, Model 1001DP manufactured by Nippon Denshoku Industries Co., Ltd. or HR-100 manufactured by Murakami Color Research Laboratory).

In the measurement of haze value (total haze value ht, surface haze value hs, inner haze value hi), a film where layers up to the light-diffusing layer are coated is used and the total haze value ht is measured by using a haze meter (Model 1001DP manufactured by Nippon Denshoku Industries Co., Ltd.). Furthermore, when a solution having the same refractive index as the light-diffusing layer, which is obtained by removing only light-transmitting fine particles from the coating solution for a light-diffusing layer, is overcoated to smoothly cover the film having coated thereon the light-diffusing layer until surface irregularities are filled up, the haze value of the resulting film is hi and the haze value obtained by subtracting hi from ht is hs.

In the antireflection film of the present invention, the average of mirror reflectances with an incident angle of 5° in the wavelength region of 450 to 650 nm (that is, average reflectance) is 2.5% or less, preferably 1.5% or less, more preferably 1.4% or less.

The mirror reflectance with an incident angle of 5° is a ratio of the intensity of light reflected at an angle of −5° with respect to the normal of a sample to the intensity of light entering from an angle of +50 with respect to the normal and this is an index for the reflection of surrounding scenes due to mirror reflection. In the case of application as an antireflection film having an antiglare function, the intensity of light reflected at an angle of −5° with respect to the normal is weak for the scattered light ascribable to the surface irregularities provided to impart antiglare property. Accordingly, the mirror reflectance can be said to reflect both antiglare property and antireflection property.

If the average mirror reflectance of the antireflection film with an incident angle of 5° in the wavelength region of 450 to 650 nm exceeds 2.5%, the reflection of surrounding scenes is bothersome and when applied to the surface film of a display device, the visibility disadvantageously decreases.

The antireflection film of the present invention is also characterized in that the reflected light has more neutral color tint.

The color tint of reflected light can be determined from a reflection spectral in the range from 380 to 680 nm of reflected light and the distance ΔE from the center point on the L*a*b* chromaticity diagram is preferably 15 or less, more preferably 10 or less, and most preferably 5 or less. Also, the change in the color tint after a weather resistance test is also preferably small and ΔE is preferably 15 or less, more preferably 10 or less, and most preferably 5 or less. In particular, it is preferred that the change in color tint after a weather resistance test is in this range.

Within this range, both low reflectance and reduction in color tint of reflected light can be achieved and therefore, for example, when applied to the outermost surface of a liquid crystal display device, even if external light having high brightness, such as fluorescent lamp in a room, is slightly reflected, the color tint can be neutral and good quality of the display image can advantageously maintained.

The antireflection film of the present invention is characterized in that changes in these optical properties and the mechanical properties of the film after a weather resistance test are in the range of substantially causing no problem, particularly, these properties are prevented from changes after a light fastness test.

The weather resistance test as used in the present invention means a weather resistance test according to JIS K5600-7-7:1999 and this is a weather resistance test performed by a sunshine weather meter (S-80, manufactured by Suga Test Instruments Co., Ltd.) at a humidity of 50% for a treatment time of 200 hours.

Such an antireflection film having reflected light with neutral color tint and at the same time, having a low reflectance can be obtained by optimizing the balance between the refractive index of the low refractive index layer and the refractive index of the light-transmitting resin in the light-diffusing layer.

(Electrical Conductivity)

In the case of use, for example, as a protective film outside the first polarizing plate (outermost polarizing plate) provided in the liquid crystal device, the antireflection film of the present invention preferably has the following electrical conductivity irrespective of the above-described liquid crystal mode which is described in detail later.

The vertical release charge measured at an ordinary temperature and an ordinary humidity for the transparent support is preferably from −200 to +200 pc (picocoulomb)/cm², more preferably from −100 to +100 pc/cm², still more preferably from −50 to +50 pc/cm², and most preferably 0 pc/cm². The unit pc (picocoulomb) is 10⁻¹² coulomb.

Furthermore, the vertical release charge measured at an ordinary temperature and 10% RH is preferably from −100 to +100 pc/cm², more preferably from −50 to +50 pc/cm², and most preferably 0 pc/cm².

The method for measuring the vertical release charge is described below.

A measurement sample is previously left standing for 2 hours or more in an environment of measurement temperature and humidity. The measuring apparatus comprises a table on which the measurement sample is placed, and a head for holding the other party film. The head can repeat the pressing from above to the measurement sample and releasing therefrom. This head is connected with an electrometer for measuring the charge amount. An antireflection film to be measured is placed on the table and TAC or PET is fixed to the head. After removing electricity from the measuring part, the head is repeatedly pressed to and released from the measurement sample. The charge value is read at the first release and at the fifth release and the obtained values are averaged. By varying the sample, this operation is repeated on three samples. All values are averaged and the obtained value is used as the vertical release charge.

Depending on the other part film or the kind of measurement sample, positive charging or negative charging may occur but the matter of importance is the size of absolute value.

In general, the absolute value of charge is larger in an environment of lower humidity. The antireflection film of the present invention is small also in this absolute value and therefore, is preferred as the protective film of a polarizing plate.

The antireflection film of the present invention has an absolute value of vertical release charge in the above-described range at an ordinary temperature and an ordinary humidity and at an ordinary temperature and 10% RH and therefore, exhibits excellent dust-protecting property.

The vertical release charge value is controlled to fall within the above-described range by adjusting the proportion among various elements on the surface of the antireflection film.

In the case of a polarizing plate in the viewing side of a display device in a liquid crystal mode such as TN and OCB, the surface resistivity of the protective film is preferably 1×10¹¹Ω/□ or more. By having a small absolute value of vertical release charge, the image display quality can be prevented from decrease while maintaining the dust-protecting property. The surface resistivity is measured by a circular electrode method described in JIS. More specifically, a current value is read 1 minute after the application of voltage and the surface resistivity (SR) is determined.

<Protective Film of Polarizing Film>

The protective film of a polarizing film of the present invention uses the above-described antireflection film as the surface protective film of a polarizing film and therefore, the transparent support surface opposite the side having the light-diffusing layer, that is, the surface to be laminated with a polarizing film is preferably hydrophilized to improve the adhesion to the polarizing film comprising a polyvinyl alcohol as the main component.

The protective film of a polarizing film in the present invention may be produced by two methods, that is (1) a method of coating respective layers (e.g., light-diffusing layer, low refractive index layer, hard coat layer) on one surface of a transparent support which is previously hydrophilized and (2) a method of coating respective layers (e.g., light-diffusing layer, low refractive index layer, hard coat layer) on one surface of a transparent support and then hydrophilizing the surface to be laminated with a polarizing film. In the method (1), the surface on which the light-diffusing layer is coated is also hydrophilized and this makes it difficult to ensure adhesion between the support and the light-diffusing layer. Therefore, the method (2) is preferred.

[Hydrophilization]

The surface hydrophilization of the transparent support can be performed by a known method. Examples thereof include a method of modifying the film surface by corona discharging, glow discharging, ultraviolet irradiation, flame treatment, ozone treatment, acid treatment, alkali treatment or the like. These are described in detail in JIII Journal of Technical Disclosure, supra, No. 2001-1745, pp. 30-32.

[Saponification]

Among these, an alkali saponification treatment is preferred and this is very effective as a surface treatment for the cellulose acylate film.

(1) Dipping Method

This is a method of dipping an antireflection film in an alkali solution under appropriate conditions and saponifying all portions having reactivity with an alkali on the film entire surface. This method requires no specific equipment and therefore, is preferred in view of cost. Examples of the alkali saponification solution includes a potassium hydroxide solution and a sodium hydroxide solution. The concentration of hydroxide ion is preferably from 0.1 to 3.0 mol/L. Furthermore, when the alkali treating solution contains a solvent having good wettability to film (e.g., isopropyl alcohol, n-butanol, methanol, ethanol), a surfactant or a wetting agent (e.g., diols, glycerin), the saponification solution is enhanced in wettability to the transparent support, aging stability and the like. The liquid temperature of the alkali solution is preferably from 25 to 70° C., more preferably from 30 to 60° C.

After the dipping in an alkali solution, the film is preferably washed thoroughly with water or dipped in a dilute acid to neutralize the alkali component so as to prevent the alkali component from remaining in the film.

By the saponification treatment, the transparent support main surface opposite the main surface having the light-diffusing layer is hydrophilized. The protective film of a polarizing film is usually used by contacting the hydrophilized surface of the transparent support with the polarizing film.

The hydrophilized surface is effective in improving the adhesion to a polarizing film comprising a polyvinyl alcohol as the main component.

In the saponification treatment, the contact angle to water of the transparent support surface opposite the side having the light-diffusing layer is preferably lower in view of adhesion to a polarizing film, but in the dipping method, the main surface having the light-diffusing layer is also damaged with alkali and therefore, it is important to select requisite minimum reaction conditions. When the contact angle of the support in the opposite side is used as the index for the damage of the antireflection layer by alkali, the contact angle is preferably from 20 to 50°, more preferably from 30 to 50°. Within this range, the antireflection film can be free from actual damage and maintain the adhesion to a polarizing plate and this is preferred.

(2) Alkali Solution Coating Method

In order to avoid damage on the antireflection film in the dipping method, an alkali solution coating method of coating an alkali solution only on the main surface opposite the main surface having the antireflection film and heating, water-washing and drying it is preferably used. Examples of the alkali solution and treatment include those described in JP-A-2002-82226 and International Publication 02/46809.

The polarizing plate of the present invention preferably uses the antireflection film of the present invention for at least one protective film (protective film for polarizing plate) of a polarizing film. The protective film of a polarizing film preferably has, as described above, a contact angle to water of 20 to 50° on the transparent support surface opposite the side having the light-diffusing layer, that is, the surface to be laminated with the polarizing film.

By using the antireflection film of the present invention as the protective film of a polarizing film, a polarizing plate excellent in physical strength and weather resistance and having an antireflection function can be produced, and large cost reduction and thinning of a display device can be advantageously achieved.

<Polarizing Plate>

The polarizing plate comprises a polarizing film and two sheets of transparent protective film disposed in both sides of the polarizing film. As described above, the antireflection film can be used for one protective film. Another protective film may a normal cellulose acylate film. A polarizing plate where the antireflection film of the present invention used as the protective film in one side of the polarizing film and an optically anisotropic layer comprising a liquid crystalline compound are stacked in this order is also preferred. It is preferred to provide the optically anisotropic layer comprising a liquid crystalline compound on a transparent support to form an optically compensatory film (hereinafter sometimes referred to as an optically compensatory sheet) and use the resulting transparent support in the polarizing film side. The lamination between the antireflection film and the polarizing film or between the polarizing film and the optically anisotropic layer support can be performed by using a well-known pressure-sensitive adhesive or adhesive (for example, polyvinyl alcohol-base adhesive) or the above-described saponification treatment or the like may be performed before the lamination.

The polarizing film in general includes an iodine-type polarizing film, a dye-type polarizing film using a dichroic dye, and a polyene-type polarizing film. The iodine-type polarizing film and dye-type polarizing film are generally produced by using a polyvinyl alcohol-base film.

In the production of a polarizing plate, the moisture permeability of protective film is important. The polarizing film and the protective film (including antireflection film, hereinafter the same) are usually laminated by an aqueous adhesive and the adhesive solvent is diffused in the protective film and thereby dried. In general, as the moisture permeability of protective film is higher, the drying proceeds more rapidly and the productivity is more increased. However, if the moisture permeability is too high, water intrudes into the polarizing film depending on the environment where the liquid crystal display device is used (at high humidity), as a result, the polarizing ability decreases.

The moisture permeability of the polarizing plate is determined by the thickness of protective film (and polymerizable liquid crystal compound), free volume, hydrophilicity/hydrophobicity, and the like.

In the case of use as the protective film of a polarizing plate, the moisture permeability is preferably from 100 to 1,000 g/m²·24 hrs, more preferably from 300 to 700 g/m²·24 hrs.

The thickness of protective film can be adjusted, in the production of film, by controlling the lip flow rate and line speed or by stretching or compression. The moisture permeability varies depending on the main material used and therefore, is preferably rendered to fall in the preferred range by adjusting the thickness.

The free volume of protective film can be adjusted, in the production of film, by controlling the drying temperature and time. Also in this case, since the moisture permeability varies depending on the main material used, the moisture permeability is preferably rendered to fall in the preferred range by adjusting the free volume.

The hydrophilicity/hydrophobicity of protective film can be adjusted by additives. The moisture permeability can be elevated by adding a hydrophilic additive into the free volume and conversely, the moisture permeability can be decreased by adding a hydrophobic additive.

By independently adjusting these factors to control the moisture permeability, the polarizing plate can be produced at a low cost with high productivity.

[Optically Anisotropic Layer Comprising Liquid Crystal Compound]

The polarizing plate preferably contains an anisotropic layer comprising a liquid crystal compound in the transparent support side opposite the antireflection film of the polarizing film. The optically anisotropic layer is preferably designed to compensate for the liquid crystal compound in the liquid crystal cell at the black display time of a liquid display device. The alignment state of liquid crystal compound in the liquid crystal cell at the black display time differs depending on the mode of the liquid crystal display device. The alignment state of liquid crystal compound in the liquid crystal cell is described in IDW' 00, FMC7-2, pp. 411-414.

[Liquid Crystalline Compound]

The liquid crystal compound for use in the optically anisotropic layer may be a rod-like liquid crystal or a discotic liquid crystal and such a liquid crystal includes a polymer liquid crystal, a low molecular liquid crystal, and a low molecular liquid crystal turned to show no liquid crystallinity resulting from crosslinking. The liquid crystalline compound for use in the present invention is most preferably a discotic liquid crystal.

Preferred examples of the rod-like liquid crystal include those described in JP-A-2000-304932.

Examples of the discotic liquid crystal for use in the present invention include benzene derivatives described in a study report of C. Destrade et al., Mol. Cryst., Vol. 71, page 111 (1981); truxene derivatives described in Mol. Cryst., Vol. 122, page 141 (1985), and Physics. Lett., A, Vol. 78, page 82 (1990); cyclohexane derivatives described in a study report of B. Kohne et al., Angew. Chem., Vol. 96, page 70 (1984); macrocycles of azacrown type and phenylacetylene type described in a study report of J. M. Lehn et al., J. Chem. Commun., page 1794 (1985), and a study report of J. Zhang et al., J. Am. Chem. Soc., Vol. 116, page 2655 (1994). The discotic liquid crystal generally has a structure that such a compound is present as a mother nucleus in the molecular center and radially substituted as linear chains by a linear alkyl group, an alkoxyl group, a substituted benzoyloxy group or the like and this exhibits liquid crystallinity. However, the discotic liquid crystal is not limited to those described above as long as the molecule itself has a negative uniaxiality and can impart a definite alignment. Furthermore, the term “formed from a discotic compound” as referred to in the present invention herein means that the final product need not be the above-described compound and the discotic liquid crystal includes, for example, a low molecular discotic liquid crystal having a group capable of reacting under the action of heat, light or the like and turned to have a high molecular weight and lose the liquid crystallinity as a result of polymerization or crosslinking caused by a reaction under the action of heat, light or the like. Preferred examples of the discotic liquid crystal include those described in JP-a-8-50206.

In the present invention, the optically anisotropic layer is preferably a layer comprising a compound having a discotic structure unit, where the plane of the discotic structure unit is tilted with respect to the transparent support plane and the angle made by the discotic structure nit plane and the transparent support plane is changing in the depth direction of the optically anisotropic layer.

The angle (inclined angle) of the discotic structure unit plane generally increases or decreases as the distance from the bottom of the optically anisotropic layer increases in the depth direction of the optically anisotropic layer. The inclined angle preferably increases with the increase of distance. Examples of the change of inclined angle include continuous increase, continuous decrease, intermittent increase, intermittent decrease, change containing continuous increase and decrease, and intermittent change containing increase and decrease. The intermittent change contains a region where the inclined angle does not change in the middle of the thickness direction. Even if a region where the inclined angle does not change is contained, the inclined angle as a whole preferably increases or decreases. The inclined angle as a whole more preferably increases, and it is particularly preferred to increase continuously.

The optically anisotropic layer can be generally obtained by dissolving the discotic compound and other compounds in a solvent, coating the solution on an orientation film, and then subjecting the coating to drying, heating to a discotic nematic phase-forming temperature, and cooling while maintaining the aligned state (discotic nematic phase). Also, the optically anisotropic layer can be obtained by dissolving the discotic compound and other compounds (e.g., polymerizable monomer, photopolymerization initiator) in a solvent, coating the solution on an orientation film, and then subjecting the coating to drying, heating to a discotic nematic phase-forming temperature, polymerization (for example, by radiation of UV light) and cooling. The transition temperature between the discotic nematic liquid crystal phase and the solid phase of the discotic liquid crystalline compound for use in the present invention is preferably from 70 to 300° C., more preferably from 70 to 170° C.

The inclined angle of the discotic unit in the support side can be generally controlled by selecting the discotic compound or materials of the orientation film or by selecting method for the rubbing treatment. On the other hand, the inclined angle of the discotic unit in the surface side (air side) can be controlled by selecting the discotic compound or compounds (e.g., plasticizer, surfactant, polymerizable monomer, polymer) used together with the discotic compound. Furthermore, the degree of change of the inclined angle can be also controlled by the above-described selections.

As for the plasticizer, surfactant and polymerizable monomer, any compound can be used as long as it has compatibility with the discotic compound, can change the inclined angle or dose not inhibit the alignment. Among these compounds, a polymerizable monomer (for example, a compound having a vinyl group, a vinyloxy group, an acryloyl group or a methacryloyl group) is preferred. This compound is generally used in an amount of 1 to 50 weight % (preferably from 5 to 30 weight %) based on the discotic compound.

Preferred examples of the polymerizable monomer include a polyfunctional acrylate. The number of functional groups is preferably 3 or more, more preferably 4 or more, and most preferably 6. Preferred examples of the hexafunctional monomer include dipentaerythritol hexaacrylate. Also, polyfunctional monomers differing in the number of functional groups may be mixed and used.

As for the polymer, any polymer can be employed as long as it has compatibility with the discotic compound and can change the inclined angle of the liquid crystalline discotic compound. Examples of the polymer include cellulose esters. Preferred examples of the cellulose ester include cellulose acetate, cellulose acetate propionate, hydroxypropyl cellulose, and cellulose acetate butyrate. For not inhibiting the alignment of the discotic compound, the polymer is generally used in an amount of 0.1 to 10 weight % (preferably from 0.1 to 8 weight %, more preferably from 0.1 to 5 weight %) based on the discotic compound. In the present invention, the optically anisotropic layer is preferably a film comprising a cellulose acetate film, an orientation film provided thereon and a discotic liquid crystal formed on the orientation film, where the orientation film comprises a crosslinked polymer and the film is subjected to a rubbing treatment.

[Orientation Film]

The orientation film is usually necessary because it has a function of regulating the alignment direction of liquid crystal molecules, but when the aligned state after the alignment of liquid crystalline compounds is fixed, the orientation film is fulfilling its role and therefore, this is not necessarily essential as the constituent element of the present invention. For example, only the optically anisotropic layer fixed in the aligned state on the orientation film may be transferred on a polarizer to produce the polarizing plate of the present invention.

The orientation film can be provided by a method such as rubbing of an organic compound (preferably polymer), oblique vapor-deposition of an inorganic compound, formation of a layer having microgrooves, or accumulation of an organic compound (e.g., ∈-tricosanoic acid, dioctadecyl methylammonium chloride, methyl stearate) according to a Langmuir-Blodgett method (LB membrane). Furthermore, an orientation film of expressing the alignment function upon application of electric or magnetic field or irradiation of light is also known.

The orientation film is preferably formed by the rubbing of a polymer. The polymer used for the orientation film has in principle a molecular structure having a function of aligning liquid crystal molecules.

In the present invention, in addition to the function of aligning liquid crystal molecules, a side chain having a crosslinking functional group (e.g., double bond) is preferably bonded to the main chain or a crosslinking functional group having a function of aligning liquid crystal molecules is preferably introduced into the side chain.

The polymer used for the orientation film may be a polymer which is crosslinkable by itself, or a polymer which is crosslinked with use of a crosslinking agent. Also, a combination of multiple polymers may be used.

Examples of the polymer include methacrylate-base copolymers, styrene-base copolymers, polyolefins, polyvinyl alcohols, modified polyvinyl alcohols, poly(N-methylolacrylamides), polyesters, polyimides, vinyl acetate copolymers, carboxymethyl cellulose and polycarbonates described, for example, in JP-A-8-338913 (paragraph [0022]). A silane coupling agent can be used as the polymer. A water soluble polymer (e.g., poly(N-methylolacrylamide), carboxymethyl cellulose, gelatin, polyvinyl alcohol, modified polyvinyl alcohol) is preferred, and gelatin, a polyvinyl alcohol and a modified polyvinyl alcohol are more preferred, and a polyvinyl alcohol and a modified polyvinyl alcohol are most preferred. It is particularly preferred to use two or more polyvinyl alcohols or modified polyvinyl alcohols differing in the polymerization degree in combination.

The saponification degree of the polyvinyl alcohol is preferably from 70 to 100%, more preferably from 80 to 100%. The polymerization degree of the polyvinyl alcohol is preferably from 100 to 5,000.

The side chain having a function of aligning liquid crystal molecules generally has a hydrophobic group as the functional group. The specific kind of the functional group can be determined according to the kind of liquid crystal molecule and the desired alignment state.

For example, the modifying group of the modified polyvinyl alcohol can be introduced by modification through copolymerization, chain transfer or block polymerization. Examples of the modifying group include a hydrophilic group (e.g., carboxylic acid group, sulfonic acid group, phosphonic acid group, amino group, ammonium group, amide group, thiol group), a hydrocarbon group having from 10 to 100 carbon atoms, a fluorine atom-substituted hydrocarbon group, a thioether group, a polymerizable group (e.g., unsaturated polymerizable group, epoxy group, aziridinyl group), and an alkoxysilyl group (e.g., trialkoxy, dialkoxy, monoalkoxy). Specific examples of the modified polyvinyl alcohol compound include those described in JP-A-2000-155216 (paragraphs [0022] to [0145]) and JP-A-2002-62426 (paragraphs [0018] to [0022]).

When the side chain having a crosslinking functional group is bonded to the main chain of the orientation film polymer or a crosslinking functional group is introduced to the side chain having a function of aligning liquid crystal molecules, the orientation film polymer and the polyfunctional monomer contained in the optically anisotropic layer can be copolymerized, as a result, strong bonding by a covalent bond can be obtained not only between a polyfunctional monomer and a polyfunctional monomer but also between an orientation film polymer and an orientation film polymer and between a polyfunctional monomer and an orientation film polymer. Accordingly, the strength of the optically compensatory sheet can be remarkably enhanced by introducing a crosslinking group into the orientation film polymer and this is preferred.

The crosslinking functional group of the orientation film polymer preferably contains a polymerizable group similarly to the polyfunctional monomer. Specific examples thereof include those described in JP-A-2000-155216 (paragraphs [0080] to [0100]).

The orientation film polymer may also be crosslinked by using a crosslinking agent separately from the crosslinking functional group.

Examples of the crosslinking agent include aldehydes, N-methylol compounds, dioxane derivatives, compounds which are caused to act when the carboxylic group is activated, active vinyl compounds, active halogen compounds, isooxazoles and dialdehyde starch. These crosslinking agents may be used in combination of two or more thereof. Specific examples the crosslinking agent include the compounds described in JP-A-2002-62426 (paragraphs [0023] to [0024]). Among these, aldehydes having high reaction activity are preferred and glutaraldehyde is more preferred.

The amount of the crosslinking agent added is preferably from 0.1 to 20 weight %, more preferably from 0.5 to 15 weight %, based on the polymer. The amount of the non-reacted crosslinking agent remaining in the orientation film is preferably 1.0 weight % or less, more preferably 0.5 weight % or less. Within these ranges, the liquid crystal display device using the orientation film can have a sufficiently high durability free from reticulation even when used for a long period of time or left standing under high-temperature high-humidity conditions and this is preferred.

The orientation film can be fundamentally formed by applying a coating solution containing materials for forming the orientation film, that is, the above-described polymer and crosslinking agent, on the transparent support, drying it under heat (causing crosslinking) and rubbing the film formed. As described above, the crosslinking reaction may be performed at an arbitrary time after applying the coating solution on the transparent support. In the case where a water-soluble polymer such as polyvinyl alcohol is used as the material for forming the orientation film, the coating solution is preferably prepared by using a mixed solvent of water and an organic solvent having defoaming activity (e.g., methanol). The ratio by weight of water:methanol is preferably from 0:100 to 99:1, more preferably from 0:100 to 91:9. By using such a solvent in this range, the generation of bubbles can be prevented and the defects on the orientation film and in turn on the surface of the optically anisotropic layer can be greatly decreased and therefore, this is preferred.

The orientation film is preferably coated by spin coating, dip coating, curtain coating, die coating, extrusion coating, rod coating or roll coating. In particular, a die coating method, a rod coating method is preferred. The thickness after drying is preferably from 0.1 to 10 μm. The drying under heat can be performed at 20 to 110° C. For satisfactorily forming the crosslinking, the temperature at the drying under heat is preferably from 60 to 100° C., more preferably from 80 to 100° C. The drying time may be from 1 minute to 36 hours but is preferably from 1 minute to 30 minutes. The pH is also preferably adjusted to an optimal value for the crosslinking agent used. In the case of using glutaraldehyde, the pH is preferably from 4.5 to 5.5, more preferably 5

The orientation film may be provided on the transparent support or on an undercoat layer.

In the case of providing the orientation film directly on the transparent support, the above-described surface hydrophilization treatment is preferably performed.

The undercoat layer may be an undercoat layer described, for example, in JP-A-7-333433 or may be formed by a single layer method of coating only one layer of resin such as gelatin containing both a hydrophobic group and a hydrophilic group or a so-called multilayer method of providing a layer having good adhesion to the polymer film as a first layer (hereinafter simply referred to as a first undercoat layer) and coating thereon a layer of hydrophilic resin such as gelatin having good adhesion to the orientation film as a second layer (hereinafter simply referred to as a second undercoat layer) (see, for example, JP-A-11-248940).

The orientation film can be obtained, as described above, by crosslinking the polymer layer and then rubbing the surface.

The rubbing treatment can be performed by a treating method widely employed in the liquid crystal alignment step of LCD. More specifically, the surface of the orientation film is rubbed with paper, gauze, felt, rubber, nylon, polyester fiber in a fixed direction, whereby the alignment can be obtained. Generally, the rubbing is performed several times by using a cloth in which fibers uniform in the length and thickness are averagely implanted.

The orientation film is then caused to function to align liquid crystal molecules of the optically anisotropic layer provided on the orientation film. Thereafter, if desired, the orientation film polymer is reacted with the polyfunctional monomer contained in the optically anisotropic layer or the orientation film polymer is crosslinked by using a crosslinking agent.

The thickness of the orientation film is preferably from 0.1 to 10 μm.

<Transparent Support on which Optically Anisotropic Layer Comprising Liquid Crystal Compound is Provided>

The transparent support is not particularly limited as long as it is a plastic film having high transmittance, but is preferably formed of cellulose acetate which is a construction material of the protective film for the polarizing plate.

The transparent support on which the optically anisotropic layer is provided has an optically important role by itself. Therefore, the retardation value Re of the transparent support for use in the present invention is from 0 to 200 nm and the Rth retardation value is preferably adjusted to 40 to 400 nm.

In the case where the liquid crystal display device uses two optically anisotropic cellulose acetate films, the Rth retardation value of each film is preferably from 50 to 250 nm.

In the case where the liquid crystal display device uses one optically anisotropic cellulose acetate film, the Rth retardation value of the film is preferably from 100 to 400 nm.

The birefringent index [Δn: nx−ny] of the cellulose acetate film is preferably from 0.00 to 0.002. Also, the birefringent index of the cellulose acetate film in the thickness direction {(nx+ny)/2−nz} is preferably from 0.001 to 0.04.

The retardation value (Re) is calculated according to the following formula:
Retardation value (Re)=(nx−ny)×d
wherein nx is a refractive index in the slow axis direction in the film plane (maximum refractive index in plane) and ny is a refractive index in the direction perpendicular to the slow axis in the plane of the retardation plate.
Rth={(nx+ny)/2−nz}×d (II)
wherein nx is a refractive index in the slow axis direction (direction of giving maximum refractive index) in the film plane, ny is a refractive index in the traveling axis direction (direction of giving minimum refractive index) in the film plane, nz is a refractive index in the thickness direction of the film, and d is a thickness of the film in the unit of nm.

The cellulose acylate film for use in the optically compensatory sheet of the present invention preferably has a hygroscopic expansion coefficient of 3×10⁻⁵/% RH or less, more preferably 15×10⁻⁵/% RH, still more preferably 10×10⁻⁵/% RH. The hygroscopic expansion coefficient is preferably smaller but is usually 1.0×10⁻⁵/% RH or more.

The hygroscopic expansion coefficient represents the variation in the length of a sample when the relative humidity is changed at a constant temperature.

By adjusting this hygroscopic expansion coefficient, the optically compensatory sheet can be prevented from frame-like increase of transmittance (light leakage due to strain) while maintaining the optically compensatory function.

The method for measuring the hygroscopic expansion coefficient is described below. A sample in a width of 5 mm and a length of 20 mm is cut out from a polymer film produced and in the sate of one end being fixed, suspended in an atmosphere of 25° C. and 20% RH (R0). A weight of 0.5 g is hung at another end and after the sample is left standing for 10 minutes, the length (L0) is measured. Thereafter, while keeping the temperature at 25° C., the humidity is changed to 80% RH (R1) and the length (L1) is measured. The hygroscopic expansion coefficient is calculated according to the following formula:
Hygroscopic expansion coefficient [% RH]={L1−L0)/L0}/(R1−R0)

In order to reduce the dimensional change due to moisture absorption of the film, a compound having a hydrophobic group, a fine particle or the like is preferably added. The compound having a hydrophobic group is preferably an appropriate material selected from plasticizers and deterioration inhibitors having a hydrophobic group such as aliphatic group or aromatic group within the molecule. The amount of such a compound added is preferably from 0.01 to 10 weight % based on the solution (dope) prepared. Also, the dimensional change may be reduced by decreasing the free volume in the polymer film. More specifically, as the residual solvent amount at the film formation by a solvent casting method is smaller, the free volume is more decreased. The drying is preferably performed under the conditions of giving a residual solvent amount of 0.01 to 1.00 weight % based on the cellulose acylate film.

These additives added to the polymer film or additives which can be added according to various purposes (for example, ultraviolet inhibitor, releasing agent, antistatic agent, deterioration inhibitor (e.g., antioxidant, peroxide decomposing agent, radical inhibitor, metal inactivating agent, acid scavenger, amine) and infrared absorbent) may be a solid or an oily product. In the case of the film is constituted by multiple layers, the kind and amount added of additive may be different between respective layers. Preferred examples of these additives include the materials described in detail in JIII Journal of Technical Disclosure, supra, No. 2001-1745, pp. 16-22. The amount of the additive used is not particularly limited as long as its function can be expressed, but the additive is preferably used appropriately in the range from 0.001 to 25 weight % based on the entire composition of the polymer film.

<Liquid Crystal Display Device>

The liquid crystal display device of the present invention is described below. Any conventionally known liquid crystal display device can be used as the liquid crystal display device of the present invention. Examples thereof include those described in Tatsuo Uchida (supervisor), Hansha-gata Color LCD Sogo Gijutsu (General Technique of Reflection-Type Color LCD), CMC (1999), Flat Panel Display no Shin Tenbo (New Prospect of Flat Panel Display), Research Division of Toray Research Center (1996), and Ekisho Kanren Shijo no Genjo to Shorai Tenbo (Jokan), (Gekan) (Status Qua and Future Prospect of Liquid Crystal-Related Market) (first volume), (last volume), Fuji Chimera Soken (2003).

The liquid crystal device in which the antireflection film and/or polarizing plate of the present invention is attached is preferably TN mode, VA mode, IPS mode, OCB mode or semitransmitting ECB mode.

The liquid display device in which the antireflection film and/or polarizing plate of the present invention is attached has good contrast and wide view angle and can be advantageously prevented from change in color hue and reflection of external light.

(TN Mode)

Constituent members in one embodiment of the TN-mode liquid crystal display device of the present invention are sequentially described below.

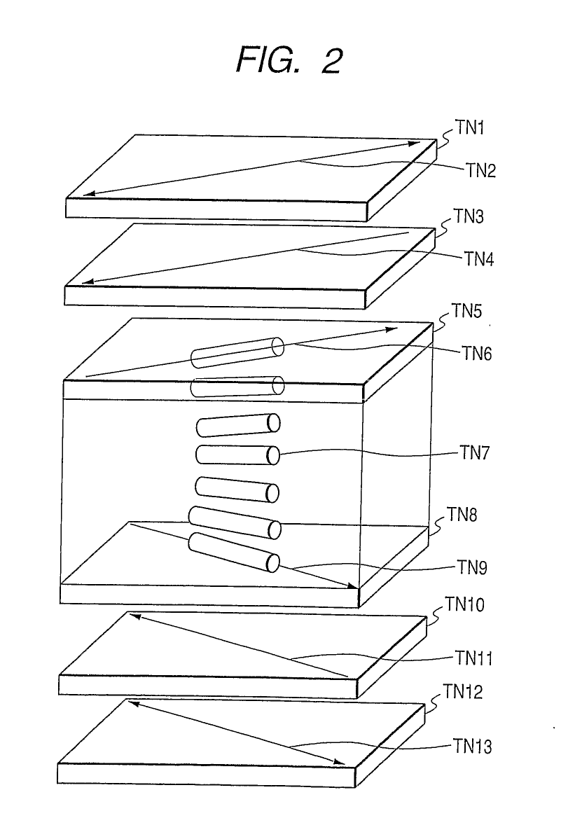

FIG. 2 is a schematic view showing one embodiment of the liquid crystal display device of the present invention.

The liquid crystal display device shown in FIG. 2 comprises a liquid crystal cell (TN5 to TN9) and upper and lower polarizing plates TN1 and TN12 disposed to sandwich the liquid crystal cell (TN5 to TN9). The polarizing plate comprises a polarizing film and a pair of transparent protective films sandwiching the polarizing film, but in FIG. 2, this is shown as an integrated polarizing plate and its detailed structure is omitted. The liquid crystal cell comprises a liquid crystal layer formed by an upper electrode substrate TN5, a lower electrode substrate TN8 and a liquid crystal layer TN7 interposed between these electrode substrates. In each of the upper electrode substrate TN5 and the lower electrode substrate TN8, an orientation film (not shown) is formed on the plane (hereinafter sometimes referred to as “inner plane”) coming into contact with the liquid crystal layer TN7 and the orientation film is subjected to a rubbing treatment or the like to control the alignment of liquid crystal molecules of the liquid crystal layer TN7 in the state where no or low voltage is applied. Also, in each of the upper electrode substrate TN5 and the lower electrode substrate TN8, a transparent electrode (not shown) capable of applying a voltage to the liquid crystal layer TN7 comprising liquid crystal molecules is formed on the inner plane.

For the liquid crystal layer TN7, a liquid crystal having positive dielectric anisotropy, refractive index anisotropy, Δn=0.0854 (589 nm, 20° C.) and Δ∈=about +8.5 (for example, MLC-9100 produced by Merck) can be used. The alignment of the liquid crystal layer is controlled by the orientation film and rubbing. In this example, the director showing the alignment direction of liquid crystal molecules, that is, so-called tilt angle, is formed at about 3° by rubbing. The rubbing is applied such that the rubbing directions on the upper and lower substrates are orthogonal to each other, and the size of the tilt angle can be controlled by the strength and frequency of rubbing. The orientation film is formed by coating a polyimide film and then baking it. The twist angle of the liquid crystal layer is determined by the crossing angle between rubbing directions on the upper and lower substrates and by the chiral material added to the liquid crystal material. In this example, a chiral material having a pitch of about 60 μm is added to give a twist angle of 90°. Incidentally, the twist angle is set to the vicinity of 90° (from 85 to 95°) in the case of a liquid crystal display device for notebook computer, personal computer monitor or television, and set to 0 to 70° in the case of use as a reflection-type display device of cellular phone or the like. The thickness d of the liquid crystal layer is 5 μm. Here, the brightness at the white display time varies depending on the product Δnd of the thickness d and the refractive index anisotropy Δn and therefore, the thickness is set to 0.2 to 0.5 μm so as to obtain maximum brightness.

The liquid crystal material LC is not particularly limited as long as it is a nematic liquid crystal. With a larger dielectric anisotropy Δ∈, the driving voltage can be decreased, and with a smaller refractive index anisotropy Δn, the thickness (gap of the liquid crystal layer) can be increased, the liquid crystal enclosing time can be shortened, and the fluctuation in the gap can be decreased.

The upper and lower polarizing plates are stacked such that the absorption axis TN2 of the upper polarizing plate TN1 runs at nearly right angles with the absorption axis TN13 of the lower polarizing plate TN12, the absorption axis TN2 of the upper polarizing plate TN1 of the liquid crystal cell runs in parallel to the rubbing direction (alignment controlling direction) of the upper electrode substrate TN5, and the absorption axis TN13 of the lower polarizing plate TN12 runs in parallel to the rubbing direction (alignment controlling direction) of the lower substrate TN8. In the inner side of each orientation film of the upper electrode substrate TN5 and the lower electrode substrate TN8, a transparent electrode (not shown) is formed, but in the non-driving state where a driving voltage is not applied to the electrode, the liquid crystal molecules of the liquid crystal layer TN7 are aligned nearly in parallel to the substrate plane, as a result, the polarization state of light transmitted through the liquid crystal panel is propagated along the twisted structure of liquid crystal molecules and ejected with the polarization plane being rotated at 90°. That is, the liquid crystal display in the non-driving state realizes a white display. On the other hand, in the driving state, liquid crystal molecules are aligned nearly perpendicularly to the substrate plane and therefore, the light passed through the liquid crystal panel passes without changing the polarization state. In other words, an ideal black display can be obtained in the driving state of the liquid crystal display device.

The TN-mode liquid crystal display device of the present invention is not limited to the constitution shown in FIG. 2 but may comprise other members. For example, a color filter may be disposed between the liquid crystal cell and the polarizing film. As described later, it is preferred to separately dispose an optically compensatory film (in FIG. 2, an upper optically anisotropic layer TN3 and a lower optically anisotropic layer TN10; hereinafter sometimes referred to as an optically compensatory sheet) between the liquid crystal cell and the polarizing plate.

In use as a transmission-type display device, a backlight using a cold or hot cathode fluorescent tube or using a light-emitting diode, a field emission element or an electroluminescent element as the light source may be disposed on the back plane. The liquid crystal display device of the present invention may also be a reflection type and in this case, it is sufficient to dispose only one polarizing plate in the observation side. A reflection film is disposed on the back plane of the liquid crystal cell or on the inner plane of the substrate in the lower side of the liquid crystal cell. Of course, a front light using the above-described light source can be provided in the observation side of the liquid crystal cell.

(VA Mode)

Constituent members in one embodiment of the VA-mode liquid crystal display device of the present invention are sequentially described below.

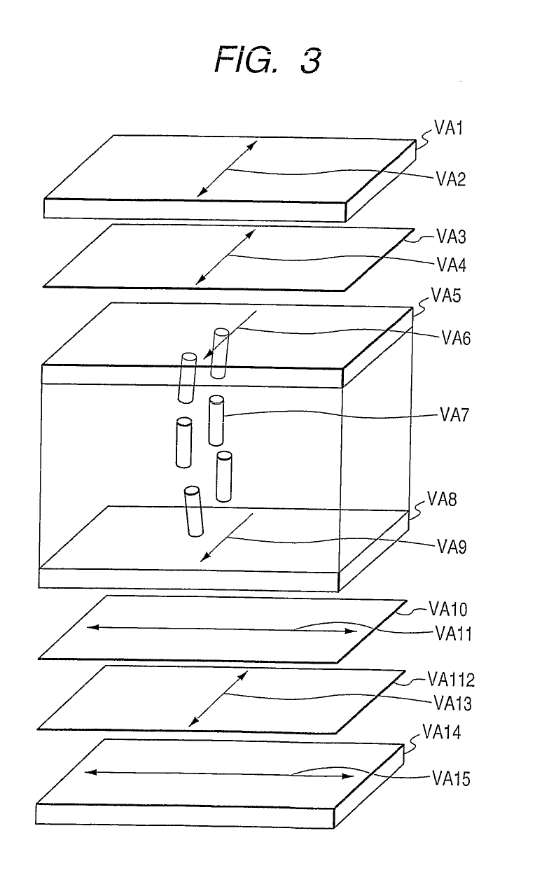

FIG. 3 is a schematic view showing one embodiment of the liquid crystal display device of the present invention.

The liquid crystal display device shown in FIG. 3 comprises a liquid crystal cell (VA5 to VA9) and upper and lower polarizing plates VA1 and VA14 disposed to sandwich the liquid crystal cell. The polarizing plate comprises a polarizing film and a pair of transparent protective films sandwiching the polarizing film, but in FIG. 3, this is shown as an integrated polarizing plate and its detailed structure is omitted. In the VA mode, between upper and lower electrode substrates, a liquid crystal having negative dielectric anisotropy, Δn=0.0813 and Δ∈=about −4.6 (for example, MLC-6608 produce by Merck) is interposed and aligned by rubbing to a director (showing the alignment direction of liquid crystal molecules), that is, so-called tilt angle with respect to the substrate plane, of about 89°. The thickness d of the liquid crystal layer VA7 is 3.5 μm. Here, the brightness at the white display time varies depending on the product Δnd of the thickness d and the refractive index anisotropy Δn and therefore, the thickness is set to 0.2 to 0.5 μm, preferably from 0.25 to 0.35 μm, so as to obtain maximum brightness.

The upper and lower polarizing plates are stacked such that the absorption axis VA2 of the upper polarizing plate VA1 runs at nearly right angles with the absorption axis VA15 of the lower polarizing plate VA14. In the inner side of each orientation film of the upper electrode substrate VA5 and the lower electrode substrate VA8, a transparent electrode (not shown) is formed, but in the non-driving state where a driving voltage is not applied to the electrode, the liquid crystal molecules of the liquid crystal layer are aligned, like liquid crystal layer VA7, nearly perpendicularly to the substrate plane, as a result, the polarization state of light transmitted through the liquid crystal panel is scarcely changed. That is, an ideal black display can be realized in the non-driving state of the liquid crystal display device. On the other hand, in the driving state, liquid crystal molecules are inclined nearly in parallel to the electrode substrate plane and the light passed through the liquid crystal panel is changed in the polarization state by the inclined liquid crystal molecules. In other words, a white display is obtained in the driving state of the liquid crystal display device.

In this example, since an electric field is applied between upper and lower electrode substrates, a liquid crystal material having negative dielectric anisotropy such that liquid crystal molecules respond perpendicularly to the electric field direction is used. In the case where an electrode is disposed on one electrode substrate and the electric field is applied in the transversal direction parallel to the substrate plane, a liquid crystal material having positive dielectric anisotropy is used. In VA-mode liquid crystal display devices, a chiral material generally used in TN-mode liquid crystal display devices is not added on many occasions because this deteriorates the dynamic response properties, but this material is sometimes added to decrease the alignment failure.

The characteristic features of the VA mode are high response and high contrast, but the contrast deteriorates in the oblique direction despite high contrast at the front. The liquid crystal molecules at the black display time are aligned perpendicularly to the substrate plane and when observed from the front, a high contrast is obtained because of almost no birefringence in the liquid crystal molecule and in turn, low transmittance. However, when observed from the oblique direction, birefringence is caused in the liquid crystal molecule. Furthermore, although the crossing angle between absorption axes of upper and lower polarizing plates is orthogonal of 90° at the front, this angle exceeds 90° when viewed from the oblique direction. Because of these two factors, leaked light is generated in the oblique direction and the contrast decreases. In order to solve this problem, optically compensatory sheets (in FIG. 3, an upper optically anisotropic layer VA3, a lower optically anisotropic layer 1 VA10 and a lower optically anisotropic layer 2 VA12) are preferably disposed. Also, although the liquid crystal molecules are inclined at the white display time, the birefringence of liquid crystal molecule when observed from the oblique direction greatly differs between the inclination direction and the opposite direction and a difference is caused in the brightness or color tone. For solving this problem, the liquid crystal display device is constituted to have a structure called multi-domain of dividing one pixel into multiple regions.

(OCB Mode)

Constituent members in one embodiment of the OCB-mode liquid crystal display device of the present invention are sequentially described below.

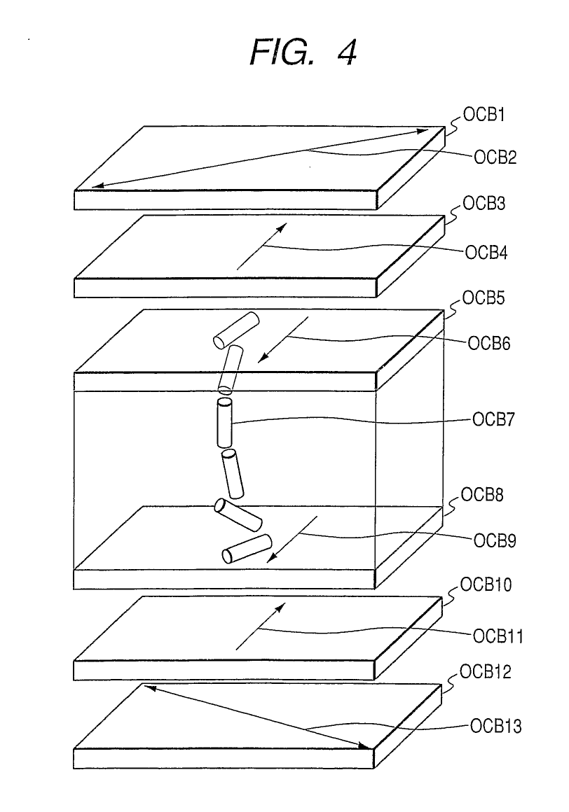

FIG. 4 is a schematic view showing one embodiment of the liquid crystal display device of the present invention.

The liquid crystal display device shown in FIG. 4 comprises a bend-aligned liquid crystal cell (OCB5 to OCB9), upper and lower polarizing plates OCB1 and OCB12 disposed to sandwich the liquid crystal cell, a pair of optically anisotropic layers (OCB3 and OCB10) disposed in both sides of the liquid crystal cell, and a backlight (not shown). The polarizing plate comprises a polarizing film and a pair of transparent protective films sandwiching the polarizing film, but in FIG. 4, this is shown as an integrated polarizing plate and its detailed structure is omitted.

The rubbing direction (alignment controlling direction) OCB6 of the upper electrode substrate OCB5 of the liquid crystal cell (OCB5 to OCB9) and the rubbing direction (alignment controlling direction) OCB11 of the lower electrode substrate OCB8 are the same (parallel). The rubbing directions (alignment controlling directions) OCB4 and OCB11 for aligning the optically anisotropic layers OCB3 and OCB11 are in the parallel relationship with the rubbing directions (alignment controlling directions) OCB6 and OCB9 of the liquid cell facing respective anisotropic layers. The absorption axis OCB2 or OCB13 of the polarizing plate OCB1 or OCB12 makes an angle of substantially 45° on the same plane with the alignment direction OCB4 or OCB11 of the optically anisotropic layer. Two polarizing plates (OCB1 and OCB12) are disposed such that in-plane absorption axes (OCB2 and OCB13) are orthogonal to each other (cross-nicole).

In the bend-aligned liquid crystal cell, between the upper electrode substrate OCB5 and the lower electrode substrate OCB8, a liquid crystal layer OCB7 having positive dielectric anisotropy, Δn=0.0813 and Δ∈=about 4.6 is interposed and aligned by rubbing (alignment controlling direction) to a director (showing the alignment direction of liquid crystal molecules), that is, so-called tilt angle, of about 8°. The rubbing directions (alignment controlling directions) OCB6 and OCB9 are nearly in parallel and running in the same direction, whereby the alignment of liquid crystal molecules in the liquid crystal layer OCB7 becomes a spray alignment in the cell cross-sectional direction. Here, when a chiral agent is added to the liquid crystal layer to impart a twist component, the orientation is stabilized. At this time, the twist angle is 180° in the electric filed non-applied state. Also, the twist angle may be set to 90° or near 270° by causing the rubbing directions to run at right angles.

The thickness d of the liquid crystal layer is 7 μm. Here, the brightness at the white display time varies depending on the product Δnd of the thickness d and the refractive index anisotropy Δn and therefore, the thickness is set to 0.6 to 0.9 μm so as to obtain maximum brightness.

The upper electrode substrate OCB5 and the lower electrode substrate OCB8 of the liquid crystal cell each has an orientation film (not shown) and an electrode layer (not shown). The orientation film has a function of aligning the liquid crystal molecules of the liquid crystal layer OCB7 and the electrode layer has a function of applying a voltage to the liquid crystal layer OCB7.

When the applied voltage of the bend-aligned liquid crystal cell is low, the liquid crystal molecule in the upper electrode substrate OCB5 side of the liquid crystal cell and the liquid crystal molecule in the lower electrode substrate OCB8 side are aligned substantially in reverse directions (vertically symmetrically). The liquid crystal molecules in the vicinity of the electrode substrates (OCB5 and OCB8) are aligned almost in the horizontal direction and the rod-like liquid crystal molecules in the center part of the liquid crystal cell are aligned almost in the vertical direction. When the applied voltage is high, the liquid crystal molecules in the vicinity of substrates are maintaining the almost horizontal alignment. The rod-like liquid crystal molecules in the center part of the liquid crystal cell are maintaining the almost vertical alignment. The liquid crystal molecule of which alignment is changed by the elevation of voltage is the liquid crystal molecules positioned in the middle between the substrate and the center part of the liquid crystal cell and these liquid crystal molecules are aligned more vertically than in the OFF state. However, it is the same as in the OFF state that the liquid crystal molecule in the upper electrode substrate OCB5 side of the liquid crystal cell and the liquid crystal molecule in the lower electrode substrate OCB8 side are aligned substantially in reverse directions (vertically symmetrically).

The concept of the optical compensation in the OCB (bend-aligned) mode liquid crystal display device is that the bend-aligned liquid crystal cell (OCB5 to OCB9) is optically compensated by the cooperation of the optically anisotropic layers (OCB3 and OCB10) formed from discotic liquid crystal molecules and the transparent support having optical anisotropy. When the directions (OCB4 and OCB11) for aligning discotic liquid crystal molecules of the optically anisotropic layers (OCB3 and OCB10) are set to fall in the non-parallel relationship with the rubbing directions of the liquid crystal cell, namely, the alignment controlling directions (OCB6 and OCB9), the liquid crystal molecules in the bend-aligned liquid crystal cell and the discotic liquid crystal molecules of the optically anisotropic layers (OCB3 and OCB10) respond to effect optical compensation. And, the optical anisotropy of the transparent support is designed to respond to the substantially vertically aligned liquid crystal molecules in the center part of the bend-aligned liquid crystal cell.

(Semitransmitting ECB Mode)

Constituent members in one embodiment of the semitransmitting ECB-mode liquid crystal display device of the present invention are sequentially described below.

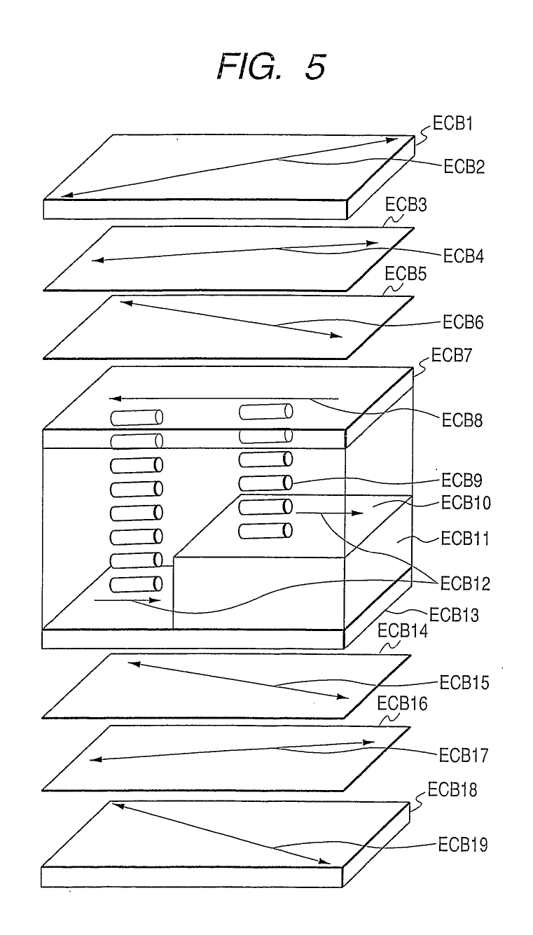

FIG. 5 is a schematic view showing one embodiment of the liquid crystal display device of the present invention.

The liquid crystal display device shown in FIG. 5 comprises a semitransmitting parallel-aligned liquid crystal cell (ECB7 to ECB13), upper and lower polarizing plates ECB1 and ECB18 disposed to sandwich the liquid crystal cell (ECB7 to ECB13), optically anisotropic layers (ECB3, ECB5, ECB14 and ECB16) disposed in both sides of the liquid crystal cell, and a backlight (not shown). The polarizing plate comprises a polarizing film and a pair of transparent protective films sandwiching the polarizing film, but in FIG. 5, this is shown as an integrated polarizing plate and its detailed structure is omitted.

Unlike CRT (cathode ray tube), the liquid crystal display device does not emit light by itself and therefore, this display device has been heretofore used as a transmission-type display device of undergoing illumination by providing a backlight comprising a cold cathode fluorescent tube or the like on the back plane of the panel. However, with recent progress of a compact and thin liquid crystal display device, its use is spreading to mobiles used outdoors or carried at all times. At this time, particularly when used outdoors, there arises a problem that the backlight does not effectively functions due to strong effect of external light and the display quality greatly decreases. To solve this problem, a reflection mode where a metallic reflection film having a concave-convex structure is provided on the inner plane of the liquid crystal cell has been proposed. Furthermore, in order to establish both the transmission mode and the reflection mode, semitransmitting ECB where a reflection part and a transmission part are provided in one pixel of the display device has been proposed.

FIG. 5 shows a schematic view of a liquid crystal cell of one pixel. The rubbing direction (alignment controlling direction) ECB8 of the upper electrode substrate ECB7 of the liquid crystal cell (ECB7 to ECB13) and the rubbing direction (alignment controlling direction) ECB12 of the lower electrode substrate ECB13 are set to run in non-parallel, and the liquid crystal layer has a parallel alignment with no twist structure.

In both the transmission part and the reflection part, the upper electrode substrate ECB7 and the lower electrode substrate ECB13 each has an orientation film (not shown) and an electrode layer (not shown). The orientation film has a function of aligning the liquid crystal molecules in the liquid crystal layer ECB9 and the electrode layer has a function of applying a voltage to the liquid crystal layer ECB9. The electrode layer usually comprises a transparent indium tin oxide (ITO), but in the reflection part (not shown), an opaque interlayer insulating film ECB11 is disposed on the transparent electrode and a reflection electrode comprising metal aluminum or the like is formed thereon and takes electrical conduction to the lower transparent electrode layer through a contact through hole.

In the parallel mode, between the upper and lower electrode substrates, a liquid crystal having positive dielectric anisotropy, refractive index anisotropy, Δn=0.0854 (589 nm, 20° C.) and Δ∈=about +8.5 (for example, MLC-9100 produced by Merck) can be used. The thickness d of the liquid crystal layer in the transmission part is 3.5 μm. Here, the brightness at the white display time varies depending on the product Δnd of the thickness d and the refractive index anisotropy Δn and therefore, the thickness is set to 0.2 to 0.4 μm so as to obtain maximum brightness. In the reflection part, the apparent thickness becomes two times due to the reflection electrode and therefore, the thickness can be ideally a half of the transmission part, that is, 1.75 μm. However, factors such as process limitation of the interlayer insulating film are present and the above-described relationship need not be always established.

The concept of the optical compensation in the semitransmitting ECB liquid crystal display device can be described by using the polarization state generated by the liquid crystal cell and optically anisotropic layers (ECB3, ECB5, ECB14 and ECB16).

In the reflection part of FIG. 5, the liquid crystal molecules of the liquid crystal layer ECB9 are aligned in parallel to the electrode substrates ECB7 and ECB13 in the voltage non-applied state. The product of the thickness d of this liquid crystal layer and the refractive index anisotropy Δn is set to ¼ of the wavelength of light, for example, with visible light λ=550 nm, the retardation is set to the vicinity of 138 nm. This is a value called λ/4 plate and has a property of converting linear polarization into circular polarization. Also, the retardation values of the optically anisotropic layers ECB3 and ECB5 are similarly set to ¼ of the wavelength of light.

In the state where a voltage is not applied to the liquid crystal cell, since the retardation values of the optically anisotropic layers ECB3 and ECB5 correspond to λ/4 plate, the linear polarization passed through the polarizing plate becomes circular polarization. Since the retardation of the liquid crystal cell is similarly λ/4 plate and at the same time, when the rubbing direction (alignment controlling direction) ECB8 of the liquid crystal cell and the slow axis direction ECB6 of the optically anisotropic layer ECB5 are adjusted to reverse the direction of the circular polarization, the circular polarization passed through the liquid crystal cell returns to linear polarization. The polarization is further returned by the reflection plate, the same polarization conversion is performed, and the linear polarization passes through the upper polarizing plate ECB1 without changing the polarization state, as a result, a white display substantially in the bright state is displayed.

On the other hand, in the voltage applied state, the liquid crystal molecules in the liquid crystal layer ECB9 are aligned perpendicularly to the substrate plane and the retardation of the liquid crystal cell becomes nearly 0. The light passed through the polarizing plate is converted into circular polarization on passing the optically anisotropic layers, but due to the reflection at the reflection film, the direction of circular polarization is reversed. When again passed through optically anisotropic layers, linear polarization with the polarization plane being rotated at 90° is yielded and cannot pass through the polarizing plate. Therefore, in the voltage applied state, a black display in the dark state is displayed.

In setting the retardation value of the anisotropic layer to λ/4, this value must be set at all wavelengths in the visible light region so as to obtain high display quality. For this purpose, it is preferred that two optically anisotropic layers ECB3 and ECB5 are used and designed to roughly give a retardation value of λ/4 in the visible light wavelength region by setting the crossing angle of slow axis directions ECB4 and ECB6 and the retardation value of each optically anisotropic layer and further setting the crossing angle with the absorption axis ECB2 of the upper polarizing plate ECB1. In this constitution, as a preferred example, the retardation value of the optically anisotropic layer ECB3 is set to give λ/2 plate, the retardation value of the optically anisotropic layer ECB5 is set to give λ/4 plate, the crossing angle of slow axes ECB4 and EXB6 is set to 60°, the crossing angle of the absorption axis ECB2 of the upper polarizing plate ECB1 and the slow axis ECB4 of the optically anisotropic layer is set to 15°, and the crossing angle of the absorption axis ECB2 of the upper polarizing plate ECB1 and the rubbing direction ECB8 of the liquid crystal cell is set to 45°.

The transmission part may designed such that the optically anisotropic layers ECB14 and ECB16 having the same retardation value as those in the reflection part are ideally disposed and the angles made with the optical axis are symmetrically disposed. Of course, each value may be adjusted according to the thickness of the liquid crystal layer in the transmission part.

(IPS Mode)

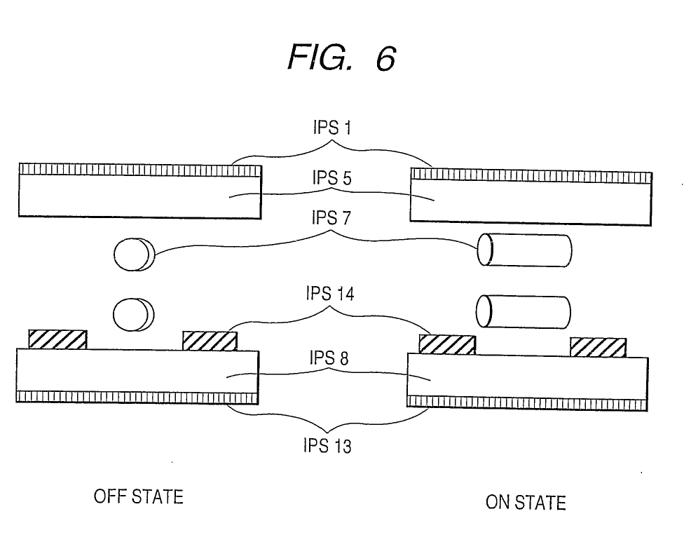

Constituent members in one embodiment of the IPS-mode liquid crystal display device of the present invention are sequentially described below. FIG. 6 is a schematic side cross-sectional view showing the IPS-mode liquid crystal cell. The liquid crystal cell usually has multiple pixels by using an electrode in the matrix state, but one portion of one pixel is shown here.

A linear electrode 14 is formed in the inner side of a pair of substrates IPS 5 and IPS 8 and an alignment controlling film (not shown) is formed thereon. When an electric field is not applied, rod like liquid crystal molecules IPS 7 interposed between the supports IPS 5 and IPS 8 are aligned to make a small angle with respect to the longitudinal direction of the linear electrode IPS 14. Here, the liquid crystal is assumed to have positive dielectric anisotropy. When an electric field is applied, the liquid crystal molecules IPS 7 are turned to the electric field direction. By disposing the polarizing plates IPS 1 and IPS 13 at a predetermined angle, the light transmittance can be changed. The polarizing plate comprises a polarizing film and a pair of transparent protective films sandwiching the polarizing film, but in FIG. 6, this is shown as an integrated polarizing plate and its detailed structure is omitted. Incidentally, the electric field direction is preferably substantially parallel to the surface of the substrate IPS 8 and the angle therebetween is 20° or less. Hereinafter, in the present invention, those at an angle of 20° or less are generically called a parallel electric field. Also, the same effect is obtained either when the electrode IPS 14 is formed in parts on the upper and lower substrates or when formed only one substrate.

For the liquid crystal material LC, a nematic liquid crystal having a positive dielectric anisotropy Δ∈ is used. The thickness (gap) of the liquid crystal layer is set to from more than 2.8 μm to less than 4.5 μm, because when the retardation Δn·d is from more than 0.25 μm to less than 0.32 μm, transmission properties almost free of wavelength dependency can be obtained in the visible light range. By combining this with an orientation film and a polarizing plate which are described later, a maximum transmittance can be obtained when the liquid crystal molecules are turned at 45° from the rubbing direction to the electric field direction. Incidentally, the thickness (gap) of the liquid crystal layer is controlled by polymer beads. Of course, the same gap can be obtained by using glass beads or fibers or by using a resin-made columnar spacer. Also, the liquid crystal material LC is not particularly limited as long as it is a nematic liquid crystal. With a larger dielectric anisotropy Δ∈ value, the driving voltage can be decreased, and with a smaller refractive index anisotropy Δn, the thickness (gap) of the liquid crystal layer can be increased, the liquid crystal enclosing time can be shortened, and the fluctuation in the gap can be decreased.

### EXAMPLES

Examples of the present invention are described below in comparison with Comparative Examples, but the present invention is not limited thereto.

### Example 1

<Production of Antireflection Film (HK-01)>

(Production of Light-Diffusing Film (HFK-01))

50 Parts by weight of an ultraviolet-curable resin (KAYARAD PET-30, produced by Nippon Kayaku Co., Ltd., refractive index: 1.51) as the light-transmitting resin constituting the light-diffusing layer, 2 parts by weight of a curing initiator (Irgacure 184, produced by Ciba•Specialty•Chemicals Co., LTD.), 5 parts by weight of an acryl-styrene bead (particle size: 3.5 μm, refractive index: 1.55) as the first light-transmitting fine particle, 5.2 parts by weight of a crosslinked styrene bead (SXS-350, produced by The Soken Chemical & Engineering Co., Ltd., particle size: 3.5 μm, refractive index: 1.61) as the second light-transmitting fine particle, 10 parts by weight of a silane coupling agent KBM-5103 (produced by Shin-Etsu Chemical Co., Ltd.) and 0.03 parts by weight of Fluorine-Base Polymer (f1) shown below were mixed with 50 parts by weight of toluene to prepare a coating solution. This coating solution was coated on a cellulose acylate film (TD80UF, produced by Fuji Photo Film Co., Ltd.) to a dry thickness of 6.0 μm and after drying the solvent, irradiated with ultraviolet light at an illuminance of 400 mW/cm² and an irradiation dose of 300 mJ/cm² by using an air-cooling metal halide lamp of 160 W/cm (manufactured by Eye Graphics Co., Ltd.) to cure the coating layer, thereby forming Light-Diffusing Film (HKF-01).
Fluorine-Base Polymer (f1):

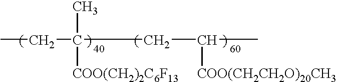

Mw: 1.5×10⁴ (molar compositional ratio)

The haze value (clouding value) of HKF-01 was measured according to JIS-K-7105 by using a haze meter Model 1001DP (manufactured by Nippon Denshoku Industries Co., Ltd.) and found to be 42%.

(Production of Antireflection Film (HK-01))

The following Coating Solution (LL-1) for Low Refractive Index Layer was coated on the light-diffusing layer by using a gravure coater and after drying at 80° C., irradiated with ultraviolet light at an illuminance of 550 mW/cm² and an irradiation dose of 600 mJ/cm² by using an air-cooling metal halide lamp of 160 W/cm (manufactured by Eye Graphics Co., Ltd.) to form a low refractive index layer (refractive index: 1.43, film thickness: 86 nm). In this way, Antireflection Film (HKF-01) was produced.

(Preparation of Coating Solution (LL-1) for Low Refractive Index Layer)

Fluorine-Base Copolymer (FP-1) having a structure shown below was dissolved in methyl isobutyl ketone to have a concentration of 30 weight %. Thereto, a terminal methacrylate group-containing silicone resin X-22-164C (produced by Shin-Etsu Chemical Co., Ltd.) in an amount of 3 weight % based on the solid content and a photo-radical generator Irgacure 907 (produced by Ciba•Specialty•Chemicals Co., LTD.) in an amount of 5 weight % based on the solid content were added to prepare Coating Solution LL-1 for Low Refractive Index Layer.
Fluorine-Base Copolymer (FP-1):

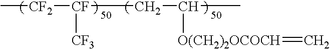

Mw: 5×10⁴ (molar compositional ratio)

(Evaluation of Antireflection Film (HK-01))

The obtained film was evaluated on the following items. As for the haze value, the light-diffusing film was measured. The results are shown in Table 1.

(1) Average Reflectance

After fixing an adapter ARV-474 to a spectrophotometer V-550 (JASCO Corporation), the mirror reflectance at an exit angle of −5° with an incident angle of 5° was measured in the wavelength region of 380 to 780 nm and the average reflectance at 450 to 650 nm was calculated. The antireflection property was evaluated by the value obtained.

(2) Haze value

The haze value of the light-diffusing film was measured by using a haze meter Model 1001DP (manufactured by Nippon Denshoku Industries Co., Ltd.).

(3) Surface Energy

As an index for soiling resistance (finger print adhesion) on the surface, the surface energy was measured by the method described above after the optical material was humidity-conditioned for 2 hours at a temperature of 25° C. and a humidity of 60% RH.

(4) Measurement of Dynamic Friction Coefficient

The surface slipperiness was evaluated by using the dynamic friction coefficient as an index. The sample was humidity-conditioned for 2 hours at a temperature of 25° C. and a relative humidity of 60% and then measured by a dynamic friction measuring machine HEIDON-14 with a 5 mmφ stainless steel ball under a load of 100 g at a velocity of 60 cm/min, and the obtained value was used as the dynamic friction coefficient.

(5) Evaluation of Adhesion

The antireflection film was humidity-conditioned for 2 hours at a temperature of 25° C. and a relative humidity of 60%. On the surface of each antireflection film in the side having the light-diffusing layer, 11 vertical cutting lines and 11 transverse cutting lines were cut with a cutter knife to form a grid-like pattern having 100 squares in total and an adhesion test using a polyester pressure-sensitive adhesive tape (No. 31B) produced by Nitto Denko Corporation was repeated on the same place. The presence or absence of stripping was observed with an eye and rated on the following 4-stage scale.

⊚: In 100 squares, stripping was not observed at all.

◯: In 100 squares, the number of squares where stripping was observed was 2 or less.

Δ: In 100 squares, the number of squares where stripping was observed was from 3 to 10.

X: In 100 squares, the number of squares where stripping was observed was exceeding 10.

(6) Evaluation of Resistance against Steel Wool Rubbing

A #0000 steel wool under a load of 500 g/cm² was reciprocatingly rubbed 60 times on the antireflection film before and after the above-described exposure and the flawed state was observed and rated on the following 3-stage scale.

A: Not flawed at all.

B: Slightly flawed by flaw was hardly perceivable.

C: Markedly flawed.

(7) Surface Resistivity

For all samples, the surface resistivity was measured by a circular electrode method and confirmed to be 1×10¹² Ω/□or more.

(8) Prevention of Dust From Sticking (Dust-Protecting Property)

The film to be measured was laminated on a glass plate and after removing electricity, reciprocatingly rubbed 10 times with TRACY produced by Toray Industries, Inc. Thereafter, fine polystyrene foam powder as pseudo dusts was spread on the entire film and the film was erected. The falling of pseudo dusts was observed and rated on the following 4-stage scale.

⊚: Falling of almost all pseudo dusts.

◯: Falling of 80% or more of pseudo dusts.

Δ: Falling of 50% or more of pseudo dusts.

X: Remaining of 50% or more of pseudo dusts on the film surface.

(9) Evaluation of Weather Resistance

A weather resistance test on respective levels with an exposure time of 200 hours was performed by using a sunshine weather meter (S-80, manufactured by Suga Test Instruments Co., Ltd.).

(Measurement of Reflectance, Reflected Light Spectrum)

For the polarizing plate before and after the weather resistance test, the reflection spectrum with incident light at an inclined angle of 5° was measured in the same manner as in the measurement of mirror reflectance, and the reflectance in the wavelength region of 380 to 780 nm and the color tint of reflected light on CIE chromaticity diagram were calculated. From the values obtained, the changes in average reflectance and in color tint between before and after the weather resistance were determined on the following 4-stage scale.

(Color Tint Change ΔE of Reflected Light)

TABLE 1

| | |
|---|---|
| Antireflection film | HK-01 |
| Light-diffusing layer | HKF-01 |
| Average reflectance | 2.3% |
| Inner haze value | 42% |
| Surface haze value | 0.7% |
| Surface energy | 25 mN/m |
| Dynamic friction coefficient | 0.12 |
| Adhesion | ⊚ |
| Rubbing resistance | A |
| Dust-protecting property | ◯ |
| Weather resistance | ◯ |

<Production of Protective Film (HF-01) of Polarizing Plate>

A polarizing film was produced by adsorbing iodine to a stretched polyvinyl alcohol film. On one surface of the polarizing film, HK-01, which was saponified, was laminated by using a polyvinyl alcohol-base adhesive such that the transparent support film (cellulose acylate) face of HK-01 came to the polarizing film side.

<Production of Optically Compensatory Sheet (WV-01)>

(Production of Support)

The following components were charged into a mixing tank and stirred under heat to prepare a cellulose acylate solution.

Composition of Cellulose Acylate Solution

| | |
|---|---|
| Cellulose triacetate having | 100 parts by weight |
| acetylation degree of 60.7% | |
| (substitution degree at 6- | |
| position: 0.90) | |
| Triphenyl phosphate | 7.8 parts by weight |
| Biphenyldiphenyl phosphate | 3.9 parts by weight |
| UV Agent UV-1 having a structure | 1.0 part by weight |
| shown below | |
| UV Agent UV-2 having a structure | 1.0 part by weight |
| shown below | |
| Methylene chloride | 300 parts by weight |
| Methanol | 54 parts by weight |
| 1-Butanol | 11 parts by weight |

| | |
|---|---|
| UV Agent: | |
| 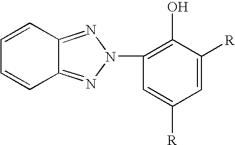 | UV-1: R is —C₄H₉(t) UV-2: R is —C₅H₁₁(t) |

(Retardation Adjusting Agent Solution)

The following components were charged into a separate mixing tank and stirred under heat to prepare a retardation adjusting agent solution.

Composition of Retardation Adjusting Agent Solution

| | |
|---|---|
| Retardation adjusting agent shown | 160 parts by weight |
| below | |
| Methylene chloride | 80 parts by weight |
| Methanol | 190 parts by weight |

Retardation Adjusting Agent:

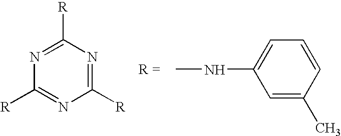

52 Parts by weight of the retardation adjusting agent solution was added to 477 parts by weight of a cellulose acylate solution and thoroughly stirred to prepare a dope. The amount of the retardation adjusting agent per 100 parts by weight of cellulose acylate was 3 parts by weight.

The obtained dope was cast by using a band casting machine. After the film surface temperature on the band reached 40° C., the film was dried for 1 minute, stripped off and stretched by using a tenter under the condition of 130° C. to produce Cellulose Acylate Film CA-1 (thickness: 80 μm) having a residual solvent amount of 0.3 weight %.

The retardation of the produced Cellulose Acylate Film (CA-01) was measured, as a result, the retardation Rth in the thickness direction was 175 nm and the in-plane retardation Re was 40 nm.

(Alkali Saponification Treatment)

One surface of the film sample was subjected to the following alkali saponification treatment.

After elevating the film surface temperature to 40° C. by passing an induction heating roll at a temperature of 60° C., Alkali Solution (S-1) having the following composition was coated on the film by a rod coater to a coated amount of 12 ml/m² and then, the film was allowed to stay for 8 seconds under a steam-type far infrared heater produced by Noritake Co., Ltd., which was heated at 110° C. Thereafter, 3 ml/m² of pure water was coated by using similarly a rod coater. At this time, the film temperature was 40° C. Subsequently, water washing by a fountain coater and water draining by an air knife were repeated three times and then, the film was dried by allowing it to stay for 5 seconds in a drying zone at 70° C.

Composition of Alkali Solution (S-1)

| | | |
|---|---|---|
| Potassium hydroxide | 5.6 | weight % |
| Water | 25.0 | weight % |
| Isopropanol | 58.4 | weight % |
| Surfactant (K-1: | 1.0 | weight % |
| C₁₄H₂₉O(CH₂CH₂O)₂₀H) | | |
| Propylene glycol | 10.0 | weight % |
| Defoaming agent: Surfynol DF110D | 0.010 | weight % |
| (produced by Nissin Chemical | | |
| Industry Co., Ltd.) | | |

(Contact Angle with Water)

The contact angle with water as measured by using a contact angle meter (Model CA-X Contact Angle Meter, manufactured by Kyowa Interface Science Co., Ltd.) under conditions of (20° C./65% RH) was 35°.

(Formation of Orientation Film)

On each film after this surface treatment for hydrophilization, a coating solution for orientation film having the following composition was coated by a rod coater to a coated amount of 28 ml/m² and then dried with hot air at 60° C. for 60 seconds and further with hot air at 90° C. for 150 seconds.

The pH on the coated surface after drying was measured, as a result, the pH value was 4.1. Also, at the center and left and right both ends in the coating cross direction, the pH value was from 4.00 to 4.20.

Each film surface-treated for hydrophilization was then subjected to a rubbing treatment in the longitudinal direction.

Composition of Coating Solution for Orientation Film

| | |
|---|---|
| Modified polyvinyl alcohol shown | 20 parts by weight |
| below | |
| Carboxylic Acid Compound (A-1) | 0.07 parts by weight |
| Glutaraldehyde | 0.5 parts by weight |
| Water | 360 parts by weight |
| Methanol | 120 parts by weight |

Modified Polyvinyl Alcohol:

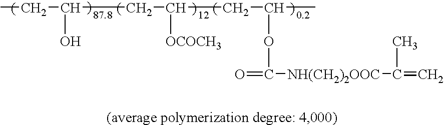

Carboxylic Acid Compound (A-1):

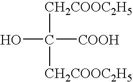

(Formation of Optically Anisotropic Layer)

Discotic Liquid Crystal Coating Solution (DA-1) having the following composition was coated by a #4 wire bar coater, heated for 3 minutes in a thermostatic chamber at 125° C. to align the discotic liquid crystal, irradiated with UV at 500 mJ/cm² by using a high-pressure mercury lamp, and then allowed to cool to room temperature, thereby forming Optically Compensatory Sheet (WV-01). The thickness of the optically anisotropic layer in the film was 1.7 μm.

Composition of Discotic Liquid Crystal Coating Solution
(DA-1)

| | |
|---|---|
| Discotic Liquid Crystal DLC-A | 9.1 parts by weight |
| shown below | |
| Ethylene oxide-modified | 0.9 parts by weight |
| trimethylolpropane acrylate | |
| (V#360, produced by Osaka | |
| Organic Chemical Industry Ltd.) | |
| Fluorine Compound (F) shown | 1.4 parts by weight |
| below | |
| Cellulose acetate butyrate | 0.2 parts by weight |
| (CAB551-0.2, produced by Eastman | |
| Chemical) | |
| Cellulose acetate butyrate | 0.05 parts by weight |
| (CAB531-1, produced by Eastman | |
| Chemical) | |
| Irgacure 907 | 3.0 parts by weight |
| Kayacure DETX (produced by | 0.1 part by weight |
| Nippon Kayaku Co., Ltd.) | |
| Methyl ethyl ketone | 30.0 parts by weight |

DLC-A:

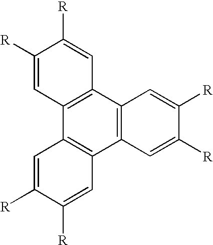

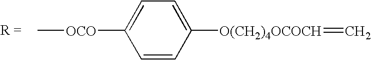

Fluorine Compound (F):

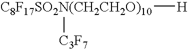

<Polarizing Plate with Optically Compensatory Sheet>
(Production of Viewing-Side Polarizing Plate SHB-01)

Optically Compensatory Sheet (WV-01) having an optically anisotropic layer comprising a liquid crystalline compound was saponified and then laminated to the opposite side of the polarizing plate protective film (HF-01) by using a polyvinyl alcohol-base adhesive such that the transparent support film of WV-01 came to the polarizing film side. In this way, Viewing-Side Polarizing Plate (SHB-01) was produced.

(Production of Backlight-Side Polarizing Plate BHB-01)

A polarizing film was produced by adsorbing iodine to a stretched polyvinyl alcohol film. A commercially available triacetyl cellulose film Fujitac TD80UF (produced by Fuji Photo Film Co., Ltd.) was saponified and then laminated to one side of the polarizing film by using a polyvinyl alcohol-base adhesive. Furthermore, Optically Compensatory Sheet (WV-01) having an optically anisotropic layer comprising a liquid crystalline compound was saponified and then laminated to the opposite side by using a polyvinyl alcohol-base adhesive such that the transparent support film of WV-01 came to the polarizing film side. In this way, Backlight-Side Polarizing Plate (BHB-01) was produced.

<Liquid Crystal Display Device>

(Production of Bend-Aligned Liquid Crystal Cell>

A polyimide film was provided as an orientation film on a glass support with an ITO electrode and the orientation film was subjected to a rubbing treatment. Two sheets of the thus-obtained glass supports were disposed to face each other while laying the rubbing directions to run in parallel and setting the cell gap to 6 μm. In the cell gap, a liquid crystalline compound having Δn of 0.1396 (ZLI1132, produced by Merck) was injected to produce a bend-aligned liquid crystal cell.

(Production of Liquid Crystal Display Device)

The viewing side of this bend-aligned cell was laminated with Polarizing Plate (SHB-01) through a pressure-sensitive adhesive such that the optically compensatory sheet came to the liquid crystal cell side, and the backlight side was laminated with Backlight-Side Polarizing Plate (BHB-01) through a pressure-sensitive adhesive such that the optically anisotropic layer side came to the liquid crystal cell side, whereby the cell was interposed between polarizing plates. The transmission axis of the viewing-side polarizing plate and the transmission axis of the backlight-side polarizing plate were arranged to be in 0 mode.

### Comparative Example 1-1

A liquid crystal display device was produced in the same manner as in Example 1 except that in the production of liquid crystal display device in Example 1, the polarizing plates sandwiching the bend-aligned cell both were Polarizing Plate (BHB-01) (that is, a liquid crystal display device not having the antireflection film of the present invention in the viewing-side polarizing plate). When BHB-01 is used as the viewing-side polarizing plate, this is called SHB-R1.

### Comparative Example 1-2 to Comparative Example 1-4

Light-Diffusing Films (HKF-R1) to (HKF-R3) of Comparative Examples 1-1 to 1-4 were produced by changing the blending ratio between the light-transmitting resin and the light-transmitting particle in the light-diffusing film (HKF-01) of the antireflection film of Example 1 to give the haze value shown in Table 2. Liquid crystal display devices of OCB mode were produced in the same manner as in Example 1 except for using each of these light-diffusing films in place of Light-Diffusing Film (HKF-01) of Example 1.

TABLE 2

| | Viewing- | | | | |
|---|---|---|---|---|---|
| | Side | | | | |
| | Polarizing | Antireflection Film | | | |
| | Plate | Light- | | | |
| | Polarizing | Diffusing | Inner | Surface | |
| | Plate for | Layer for | Haze | Haze | Average |
| | Comparison | Comparison | Value | Value | Reflectance |
| Comparative | SHB-R2 | HKF-R1 | 10% | 1% | 2.5% |
| Example 1-2 | | | | | |
| Comparative | SHB-R3 | HKF-R2 | 25% | 0.8% | 2.4% |
| Example 1-3 | | | | | |
| Comparative | SHB-R4 | HKF-R3 | 65% | 1.2% | 2.3% |
| Example 1-4 | | | | | |

<Evaluation of Performance of Display Device>

As for the image drawing performance of liquid crystal display devices produced, the following properties were evaluated. The results obtained are shown in Table 3.

(Evaluation of Unevenness of Image Drawn)

The image drawing unevenness at the black display (L1) time was observed with an eye by using a measuring apparatus (EZ-Contrast 160D, manufactured by ELDIM).

◯: Not generated at all (a level that unevenness was evaluated by 10 persons and not recognized even by one person).

Δ: Weakly generated (a level that unevenness was evaluated by 10 persons and recognized by 1 to 5 persons).

X: Strongly generated (a level that unevenness was evaluated by 10 persons and recognized by 6 or more persons).

(Evaluation of Reflection of External Light)

The reflection of external light using a fluorescent lamp was evaluated with an eye and rated on the following 4-stage scale.

⊚: Reflection was changed but not bothersome at all.

◯: Reflection was changed but scarcely bothersome.

Δ: Reflection change was bothersome but allowable.

X: Reflection change was bothersome.

(Contrast and View Angle)

A white display voltage of 2V and a black display voltage of 6 V were applied to the liquid crystal cell of liquid crystal display device and by using a measuring apparatus (EZ-Contrast 160D, manufactured by ELDIM), the contrast ratio and the view angle in transverse direction (direction orthogonal to the rubbing direction of cell) (the angle range width of giving a contrast ratio of 10 or more and the range width free from gradation reversal) were examined.

⊚: Not bothersome at all.

◯: Changed but scarcely bothersome.

Δ: Change was bothersome but allowable.

X: Change was bothersome.

(Color Tint Change)

The degree of change in color tone was observed with an eye within the view angle range from front to 600 by using the same apparatus as in the evaluation method of (Contrast and View Angle) and rated according to the following criteria:
⊚: Not bothersome at all.
◯: Changed but scarcely bothersome.
Δ: Change was bothersome but allowable.

X: Change was bothersome.

TABLE 3

| | | Viewing- | Unevenness | Reflection | | | |
|---|---|---|---|---|---|---|---|
| | Liquid | Side | of | of | | | Color |
| | Crystal | Polarizing | Image | External | Contrast | View | Tint |
| | Mode | Plate | Drawn | Light | (up/down) | Angle | Change |
| Example 1 | OCB | SHB-O1 | ◯ | ◯ | ⊚ | ⊚ | ◯ |
| Comparative | | SHB-R1 | ◯ | X | ◯ | ⊚ | Δ |
| Example 1-1 | | | | | | | |
| Comparative | | SHB-R2 | ◯ | X | ◯ | ⊚ | Δ |
| Example 1-2 | | | | | | | |
| Comparative | | SHB-R3 | ◯ | Δ | ◯ | ⊚ | Δ |
| Example 1-3 | | | | | | | |
| Comparative | | SHB-R4 | Δ | ◯ | X | ⊚ | ◯ |
| Example 1-4 | | | | | | | |

In the display device of Example 1, the image drawn was a clear image free from unevenness of entire surface and reflection of external light, the contrast was more increased in the up/down sides, the color tint change was decreased and the visibility was enhanced.

In Comparative Example 1-1 where the antireflection film of the present invention was not provided, the external light was intensively reflected and the color tint was changed. In Comparative Examples 1-2 and 1-3 where the inner haze value was small, reflection of external light or glaring of screen was increased.

In Comparative Example 1-4 where the inner haze value was large, the screen became whitish and the sharpness of black display in the image drawn was decreased.

As verified above, only the present invention could achieve clearness of image and good visibility free from change in contrast and in color tint of image even when the viewing direction was changed.

### Example 2 and Comparative Example 2

<Production of Antireflection Film (HK-02)>

{Formation of Electrically Conductive Layer}

Shintron 4456-S7 (trade name, a hard-coating agent having dispersed therein ATO (solid content: 45%), produced by Shinto Paint Co., Ltd.) was coated on Fujitac TD80UL (produced by Fuji Photo Film Co., Ltd.), dried and then cured by irradiating ultraviolet light to form an electrically conductive layer having a thickness of 1 μm. This film had electrical conductivity with a surface resistivity on the order of 10⁸Ω/□.

Incidentally, the surface resistivity was determined by allowing the sample to stand for 1 hour under the conditions of (25° C./65% RH) and then measuring it under the same conditions by means of a resistivity meter MCP-HT260 manufactured by Mitsubishi Chemical Corporation.

On this electrically conductive layer, a light-diffusing layer was provided as follows to produce Film (HKF-02).

(Production of Light-Diffusing Film (HKF-02))

The light-transmitting resin constituting the light-diffusing layer was prepared by mixing 100 parts of a zirconium oxide dispersion-containing hard-coat coating solution (modified product of inorganic fine particle and solvent composition of Desolite Z-7404, produced by JSR Corporation, refractive index: 1.64), 6 parts by weight of a curing initiator (Irgacure 184, produced by Ciba•Specialty•Chemicals Co., LTD.), 6 parts by weight of a silane coupling agent KBM-5103 (produced by Shin-Etsu Chemical Co., Ltd.) and 0.04 parts by weight of Fluorine-Base Polymer (f1) with stirring by an air disper and dissolving the mixture in a methyl ethyl ketone/methyl isobutyl ketone (3/7 by weight). When this solution was coated and cured with ultraviolet ray, the refractive index of the obtained coating film was 1.51.

In the solution prepared above, 4 parts by weight of a crosslinked styrene bead (SXS-500, produced by The Soken Chemical & Engineering Co., Ltd., particle size: 3 μm, refractive index: 1.61) and 5.3 parts by weight of a crosslinked styrene (SXS-500, produced by The Soken Chemical & Engineering Co., Ltd., particle size: 5 μm, refractive index: 1.61) as the light-transmitting fine particle were mixed. The resulting solution was adjusted to a solid content of 30% with methyl ethyl ketone/methyl isobutyl ketone (3/7 by weight), then coated on the cellulose acylate film where the electrically conductive layer was provided, to have a dry thickness of 4.0 μm and after drying the solvent, irradiated with ultraviolet light at an illuminance of 400 mW/cm² and an irradiation dose of 300 mJ/cm² by using an air-cooling metal halide lamp of 160 W/cm (manufactured by Eye Graphics Co., Ltd.) to cure the coating layer, thereby producing Light-Diffusing Film (HKF-02). The haze value of (HKF-02) was 35% and the surface haze value was 0.7%.

(Production of Antireflection Film (HK-02))

Coating Solution (LL-1) for Low Refractive Index Layer was coated to a thickness of 85 nm in the same manner as in the production of the antireflection film of Example 1 to produce Antireflection Film (HK-02).

The optical properties of the obtained film were the same as those of Antireflection Film (HK-01).

(Evaluation of Antireflection Film (HK-02))

The properties of the obtained were evaluated in the same manner as in Example 1 and the results are shown in Table 4.

TABLE 4

| | | |
|---|---|---|
| Antireflection film | HK-02 | HK-03 |
| Light-diffusing layer | HKF-02 | HKF-3 |
| Average reflectance, % | 2.5% | 2.3% |
| Inner haze value | 35% | 45% |
| Surface haze value | 0.7% | 0.5% |
| Surface energy | 25 mN/m | 25 mN/m |
| Dynamic friction coefficient | 0.12 | 0.12 |
| Adhesion | ⊚ | ⊚ |
| Rubbing resistance | A | A |
| Dust-protecting property | ◯ | ◯ |
| Weather resistance | ◯ | ◯ |

The optical properties of the obtained film (HK-02) showed good results as same as those of Antireflection film (HK-01).

<Production of Protective Film (HF-02) of Polarizing Plate>

A polarizing film was produced by adsorbing iodine to a stretched polyvinyl alcohol film. On one surface of the polarizing film, an antireflection film (HK-02), which was saponified, was laminated by using a polyvinyl alcohol-base adhesive such that the transparent support film (cellulose acylate) face of the antireflection film (HK-02) came to the polarizing film side.

<Production of Optically Compensatory Sheet>

(Production of Support)

The following components were charged into a mixing tank and stirred under heat to prepare a cellulose acylate solution.

(Composition of Cellulose Acylate Solution)

| | | |
|---|---|---|
| Cellulose triacetate having | 100 | parts by weight |
| acetylation degree of 59.9% | | |
| (substitution degree at 6- | | |
| position: 0.90) | | |
| Triphenyl phosphate | 6.8 | parts by weight |
| Biphenyldiphenyl phosphate | 0.08 | parts by weight |
| UV Agent: UV-1 | 1.0 | part by weight |
| UV Agent: UV-2 | 1.0 | part by weight |
| Methyl group-modified silica | 0.15 | parts by weight |
| (“AEROSIL (registered | | |
| trademark) 972” (primary | | |
| particle size: 16 nm, produced | | |
| by Nippon Aerosil K.K.)) | | |
| Methyl acetate | 290 | parts by weight |
| Methanol | 25 | parts by weight |
| Acetone | 25 | parts by weight |
| Ethanol | 25 | parts by weight |
| 1-Butanol | 25 | parts by weight |

(Preparation of Retardation Adjusting Agent Solution)

16 Parts by weight of the retardation adjusting agent shown below, 74.4 parts by weight of methyl acetate, 6.4 parts by weight of methanol, 6.4 parts by weight of acetone, 6.4 parts by weight of ethanol and 6.4 parts by weight of i-butanol were charged and stirred under heat to prepare a retardation adjusting agent solution.
Retardation Adjusting Agent:

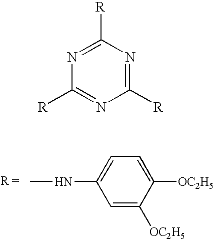

36 Parts by weight of the retardation adjusting agent solution was mixed with 475 parts by weight of a cellulose acylate solution, thoroughly stirred and then left standing at room temperature (25° C.) for 3 hours. The obtained non-uniform gel-like solution was cooled at −70° C. for 6 hours and then heated-stirred at 50° C. to obtain a completely dissolved dope.

The obtained dope was filtered at 50° C. through a filter paper (#63, produced by Toyo Roshi Kaisha, Ltd.) having an absolute filtration precision of 0.01 mm and further through a filter paper (FH025, produced by Pall Ltd.) having an absolute filtration precision of 0.0025 mm and then defoamed to prepare a dope. This dope was cast by using a rotary drum casting machine. The casting was performed under the same conditions as in the band casting of Example 1. After the film surface temperature on the drum reached 40° C., the film was dried for 1 minute and then a film having a residual solvent amount of 50 weight % was stripped off and air-dried at 140° C. to obtain a film having a residual solvent amount of 40 weight %. This film was biaxially stretched in the casting direction (machine direction) and in the cross direction to produce Cellulose Acylate Film (CA-02) in the form of a wound roll having a thickness of 105 μm, a length of 1,000 m and a width of 1.34 m.

The retardation value (Re) of the produced Cellulose Acylate Film (CA-02) at a wavelength of 590 nm was 100 nm and the retardation value (Rth) was 50 nm.

(Saponification Treatment)

After elevating the film surface temperature to 40° C. by passing an induction heating roll at a temperature of 60° C., Alkali Solution (S-2) having the following composition was coated on Cellulose Acylate Film (CA-02) by a rod coater to a coated amount of 12 ml/m² and then, the film was allowed to stay for 15 seconds under a steam-type far infrared heater produced by Noritake Co., Ltd., which was heated at 110° C. Thereafter, 3 ml/m² of pure water was coated by using similarly a rod coater. At this time, the film temperature was 40° C. Subsequently, water washing by a fountain coater and water draining by an air knife were repeated three times and then, the film was dried by allowing it to stay for 5 seconds in a drying zone at 70° C.

Composition of Alkali Solution (S-2)

| | | |
|---|---|---|
| Potassium hydroxide | 8.55 | weight % |
| Water | 23.235 | weight % |
| Isopropanol | 54.20 | weight % |
| Surfactant (K-1: | 1.0 | weight % |
| C₁₄H₂₉O(CH₂CH₂O)₂₀H) | | |
| Propylene glycol | 13.0 | weight % |
| Defoaming agent: Surfynol DF110D | 0.015 | weight % |
| (produced by Nissin Chemical | | |
| Industry Co., Ltd.) | | |

The contact angle with water on the surface of the obtained film was 37° and the surface energy was 63 mN/m.

(Formation of Orientation Film)

On this surface-treated film, a coating solution for orientation film having the following composition was coated by a rod coater to a coated amount of 28 ml/m² and then dried with hot air at 60° C. for 60 seconds and further with hot air at 90° C. for 150 seconds.

The pH on the coated surface after drying was measured, as a result, the pH value was 3.95. Also, at the center and left and right both ends in the coating cross direction, the pH value was from 3.90 to 4.05.

Composition of Coating Solution for Orientation Film

| | |
|---|---|
| Modified polyvinyl alcohol shown | 20 parts by weight |
| below | |
| Citric acid | 0.05 parts by weight |
| Glutaraldehyde | 0.5 parts by weight |
| Water | 360 parts by weight |
| Methanol | 120 parts by weight |

Modified Polyvinyl Alcohol:

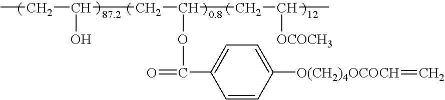

(Rubbing Treatment of Orientation Film)

The orientation film surface was subjected to a rubbing treatment in the longitudinal direction of the film to run in parallel to the conveying direction by using a rubbing roll laminated with a commercially available rubbing cloth under the environmental conditions of (25° C./45% RH).

(Formation of Optically Anisotropic Layer)

41.01 Parts by weight of Discotic Liquid Crystalline Compound (DB) having a structure shown below, 4.06 parts by weight of an ethylene oxide-modified trimethylolpropane triacrylate (V#360, produced by Osaka Organic Chemical Industry Ltd.), 0.90 parts by weight of a cellulose acetate butyrate (CAB551-0.2, produced by Eastman Chemical), 0.23 parts by weight of a cellulose acetate butyrate (CAB531-1, produced by Eastman Chemical), 1.35 parts by weight of a photopolymerization initiator (Irgacure 907, produced by Ciba•Specialty•Chemicals Co., LTD.), 0.45 parts by weight of a sensitizer (Kayacure DETX, produced by Nippon Kayaku Co., Ltd.) and 102 parts by weight of Fluorine-Containing Surfactant (F-2) having a structure shown below were dissolved in 102 parts by weight of methyl ethyl ketone to prepare a coating solution. This coating solution was coated on the orientation film by a #3.4 wire bar. Thereafter, the film was heated for 2 minutes in a constant temperature zone at 130° C. to align the discotic liquid crystalline compound, then UV-irradiated for 1 minute by using a high-pressure mercury lamp of 120 W/cm in an atmosphere of 60° C. to polymerize the discotic liquid crystalline compound, and allowed to cool to room temperature, thereby forming an optically anisotropic layer having a film thickness of 2.0 μm. In this way, Optically Compensatory Sheet (WV-02) was produced.
Discotic Liquid Crystalline Compound (DB): 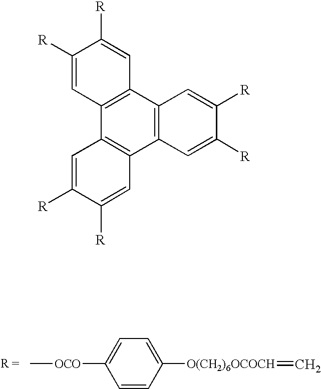
Fluorine-Containing Surfactant (F-2): 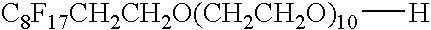
<Polarizing Plate with Optically Compensatory Sheet>
(Production of Viewing-Side Polarizing Plate (SHB-02))

Optically Compensatory Sheet (WV-02) having an optically anisotropic layer comprising a liquid crystalline compound was saponified and then laminated to the opposite side of the polarizing plate protective film (HF-02) by using a polyvinyl alcohol-base adhesive such that the transparent support film of WV-02 came to the polarizing film side. In this way, Viewing-Side Polarizing Plate (SHB-02) was produced.

<Liquid Crystal Display Device>

In place of the viewing-side protective film provided in the IPS-mode 20-inch liquid crystal display device Model W20-lc3000 (manufactured by Hitachi Ltd.), one sheet of Polarizing Plate (SHB-02) of the present invention was laminated in the viewing side through an acryl-base pressure-sensitive adhesive such that the optically anisotropic layer came to the liquid crystal cell side.

### Comparative Example 2

A liquid crystal display device was produced in the same manner as in Example 2 except for using Polarizing Plate (BHB-02) mentioned below in place of Polarizing Plate (SHB-02).

(Production of Polarizing Plate (BHB-02))

A polarizing film was produced by adsorbing iodine to a stretched polyvinyl alcohol film. A commercially available triacetyl cellulose film (Fujitac TD80UF, produced by Fuji Photo Film Co., Ltd.) was saponified and then laminated to one side of the polarizing film by using a polyvinyl alcohol-base adhesive. Furthermore, Optically Compensatory Sheet (WV-02) having an optically anisotropic layer comprising a liquid crystalline compound was saponified and then laminated to the opposite side by using a polyvinyl alcohol-base adhesive such that the transparent support film of WV-02 came to the polarizing film side. In this way, Backlight-Side Polarizing Plate (BHB-02) was produced.

<Evaluation of Performance of Liquid Crystal Display Device>

The display devices of Example 2 and Comparative Example 2 were evaluated on the quality of the drawn image in the same manner as in Example 1. The results are shown in Table 5.

### Example 3 and Comparative Example 3

(Preparation of Electrically conductive Ultrafine Particle Dispersion (EL-2))

20 Parts by weight of ITO (tin-containing indium oxide, specific surface area: 40 m²/g, powder resistivity: 0.1 Ω·cm), 6 parts by weight of a dispersant having a structure shown below and 74 parts by weight of cyclohexanone were dispersed in a Dyno mill by using zirconia bead having a particle size of 0.2 mm. Thereafter, the beads were separated by filtration through a 200-mesh nylon cloth. In the obtained dispersion, the average size of dispersed particles was 30 nm and the content of particles of 100 nm or more was 0%.
Dispersant:

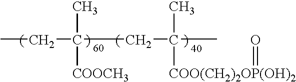

Mw: 1.5×10⁴ (compositional ratio by weight)

(Preparation of Coating Solution for Electrically Conductive Layer)

82 Parts by weight of ethyl cellosolve, 22 parts by weight of tetraethoxysilane, 20 parts by weight of methyltriethoxysilane and 58 parts by weight of γ-methacryloyloxypropylmethyldimethoxysilane were added and while keeping the liquid temperature at 5 to 10° C., 37 parts by weight of 0.01 N hydrochloric acid was added dropwise with stirring over 3 hours. After the completion of dropwise addition, stirring was performed for 0.5 hours to obtain a partially hydrolyzed product of silyl compound. Thereto, 224 parts by weight of the electrically conductive ultrafine particle dispersion prepared above was added and stirred by a high-speed disper at 5,000 rpm for 1 hour. To this dispersion, Irgacure 907 (trade name) in an amount of 5 weight % based on the solid content, 2.6 parts by weight of an aluminum acetylacetonate and 0.5 parts by weight of ammonium perchlorate were added and after thorough stirring, the resulting dispersion was filtered through a propylene-made filter having a pore size of 30 μm to prepare a coating solution for electrically conductive layer.

(Formation of Electrically Conductive Layer)

On the above-described cellulose acylate film (TD80UF), the coating solution for electrically conductive layer prepared above was coated by a gravure coater and dried at 100° C. Thereafter, while purging with nitrogen to give an atmosphere having an oxygen concentration of 1.0 vol % or less, the film was irradiated with ultraviolet light at an illuminance of 400 mW/cm² and an irradiation dose of 300 mJ/cm² by using an air-cooling metal halide lamp of 160 W/cm (manufactured by Eye Graphics Co., Ltd.) and heated at 120° C. for 10 minutes to cure the coating layer, thereby forming an electrically conductive layer having a thickness of 2 pin. This film had electrical conductivity with a surface resistivity on the order of 10⁸Ω/□.

(Production of Light-Diffusing Film (HKF-03))

The light-transmitting resin constituting the light-diffusing layer was prepared by mixing 100 parts of a zirconium oxide dispersion-containing hard-coat coating solution (Desolite Z-7404, produced by JSR Corporation, refractive index: 1.64), 43 parts by weight of a light-transmitting resin (DPHA, produced by Nippon Kayaku Co., Ltd.) and 5 parts by weight of a curing initiator (Irgacure 184, produced by Ciba•Specialty•Chemicals Co., LTD.) with stirring by an air disper and dissolving the mixture in a methyl ethyl ketone/methyl isobutyl ketone (20/80 by weight). When this solution was coated and cured with ultraviolet ray, the refractive index of the obtained coating film was 1.62.

In the solution prepared above, 5.2 parts by weight of a silica bead (KEP-150, produced by Nippon Shokubai Co., Ltd., particle size: 1.5 μm, refractive index: 1.46) and 2.0 parts by weight of a polymethyl methacrylate-base bead (MX300, produced by The Soken Chemical & Engineering Co., Ltd., particle size: 3.0 μm, refractive index: 1.49) as the light-transmitting fine particle were mixed. The resulting solution was adjusted to a solid content of 53% with methyl ethyl ketone/methyl isobutyl ketone (20/80 by weight).

The obtained solution was coated on the film with an electrically conductive layer prepared above, to have a dry thickness of 4.0 μm and after drying the solvent, irradiated with ultraviolet light at an illuminance of 400 mW/cm² and an irradiation dose of 300 mJ/cm² by using an air-cooling metal halide lamp of 160 W/cm (manufactured by Eye Graphics Co., Ltd.) to cure the coating layer, thereby producing (HKF-03). The haze value of (HKF-03) was 45%.

(Production of Antireflection Film (HK-03))

The same low refractive index layer as in Example 1 was coated on (HFK-03) in the same manner as in Example 1 to produce Antireflection Film (HK-03).

The properties of the obtained film were evaluated in the same manner as in Example 1 (shown in Table 4). The optical Properties of the obtained film (HK-03) were good results as same as those of Antireflection Film (HK-01). The results were good similarly to those of Example 1.

<Production of Protective Film (HF-03) of Polarizing Plate>

A polarizing film was produced by adsorbing iodine to a stretched polyvinyl alcohol film. On one surface of the polarizing film, Antireflection Film (HK-03), which was saponified, was laminated by using a polyvinyl alcohol-base adhesive such that the transparent support film (cellulose acylate) face of Antireflection Film (HK-03) came to the polarizing film side.

<Production of Optically Compensatory Sheet>

(Production of Support)

The following components were charged into a mixing tank and stirred under heat to prepare a cellulose acylate solution.

(Composition of Cellulose Acylate Solution)

| | | |
|---|---|---|
| Cellulose triacetate having | 100 | parts by weight |
| acetylation degree of 59.9% | | |
| (substitution degree at 6- | | |
| position: 0.90) | | |
| Triphenyl phosphate | 6.8 | parts by weight |
| Biphenyldiphenyl phosphate | 0.08 | parts by weight |
| UV Agent: UV-1 | 1.0 | part by weight |
| UV Agent: UV-2 | 1.0 | part by weight |

| | |
|---|---|
| Methyl group-modified silica | 0.15 parts by weight |
| (“AEROSIL (registered | |
| trademark) 972” (primary | |
| particle size: 16 nm, produced | |
| by Nippon Aerosil K.K.)) | |
| Methyl acetate | 290 parts by weight |
| Methanol | 25 parts by weight |
| Acetone | 25 parts by weight |
| Ethanol | 25 parts by weight |
| 1-Butanol | 25 parts by weight |

(Preparation of Retardation Adjusting Agent Solution)

17 Parts by weight of the retardation adjusting agent shown below, 74.4 parts by weight of methyl acetate, 6.4 parts by weight of methanol, 6.4 parts by weight of acetone, 6.4 parts by weight of ethanol and 6.4 parts by weight of i-butanol were charged and stirred under heat to prepare a retardation adjusting agent solution.
Retardation Adjusting Agent:

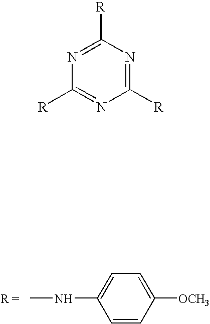

36 Parts by weight of the retardation adjusting agent solution was mixed with 464 parts by weight of a cellulose acylate solution, thoroughly stirred and then left standing at room temperature (25° C.) for 3 hours. The obtained non-uniform gel-like solution was cooled at −70° C. for 6 hours and then heated-stirred at 50° C. to obtain a completely dissolved dope.

The obtained dope was subjected to filtration through filter and defoaming in the same manner as in Example 1 to prepare a dope.

A film was formed by a band casting method in the same manner as in Example 1 and Cellulose Acylate Film (CA-03) having a residual solvent amount of 0.25 weight % was obtained in the form of a wound roll having a thickness of 100 μm, a length of 1,000 m and a width of 1.34 m.

The retardation value (Re) of the produced Cellulose Acylate Film (CA-03) at a wavelength of 590 nm was 50 nm and the retardation value (Rth) was 92 nm.

(Production of Optically Compensatory Sheet (WV-03))

On the support (CA-03) prepared above, an optically anisotropic layer was provided in the same manner as in Example 2 to produce Optically Compensatory Sheet (WV-03).

<Polarizing Plate with Optically Compensatory Sheet>

(Production of Viewing-Side Polarizing Plate SHB-03)

Optically Compensatory Sheet (WV-03) having an optically anisotropic layer comprising a liquid crystalline compound was saponified and then laminated to the opposite side of the polarizing plate protective film (HF-03) by using a polyvinyl alcohol-base adhesive such that the transparent support film of (WV-03) came to the polarizing film side. In this way, Viewing-Side Polarizing Plate (SHB-03) was produced.

<Liquid Crystal Display Device>

In place of the viewing-side polarizing plate provided in the VA-mode 22-inch liquid crystal display device Model TH22-LH10 (manufactured by Matsushita Electric Industrial Co., Ltd.), one sheet of Polarizing Plate (SHB-03) of the present invention was laminated in the observer side through an acryl-base pressure-sensitive adhesive such that the optically anisotropic layer came to the liquid crystal cell side.

### Comparative Example 3

A liquid crystal display device was produced in the same manner as in Example 3 except for using Polarizing Plate (BHB-02) in place of Polarizing Plate (SHB-03).

<Evaluation of Performance of Liquid Crystal Display Device>

The display devices of Example 3 and Comparative Example 3 were evaluated on the quality of the drawn image in the same manner as in Example 1. The results are shown in Table 5.

### Example 4 and Comparative Example 4

<Production of Optically Compensatory Sheet (WV-04)>

(Production of Support)

100 Parts by weight of cellulose triacetate powder having acetylation degree of 59.9% (substitution degree at 6-position: 0.90), 6.8 parts by weight of triphenyl phosphate, 4.9 parts by weight of biphenyldiphenyl phosphate and 0.5 parts by weight of silica (particle size: 20 nm) were charged into a solution obtained by previously mixing 290 parts by weight of methyl acetate, 25 parts by weight of acetone, 25 parts by weight of methanol, 25 parts by weight of ethanol and 25 parts by weight of n-butanol, and stirred under heat to dissolve respective components.

On the other hand, 12 parts by weight of 2-hydroxy-4-benzyloxybenzophenone and 4 parts by weight of 2,4-benzyloxybenzophenone were charged into a solution obtained by previously mixing 70 parts by weight of methyl acetate, 6 parts by weight of acetone, 6 parts by weight of methanol, 6 parts by weight of ethanol and 6 parts by weight of n-butanol, and dissolved under heat to prepare a retardation adjusting agent solution.

22 Parts by weight of the retardation adjusting agent solution was gradually added to 474 parts by weight of the cellulose triacetate solution prepared above. Thereafter, the film formation was performed in the same manner as in Example 1 to produce Cellulose Triacylate Film (CA-04) (film thickness: 80 μm, length: 1,300 m, width: 1,340 mm).

The retardation value (Re) of the obtained Cellulose Acylate Film (CA-04) at a wavelength of 590 nm was 10 nm and the retardation value (Rth) was 78 nm.

{Production of Optically Compensatory Sheet (wv-04))

On the support (CA-04) prepared above, an optically anisotropic layer was provided in the same manner as in Example 1 to produce Optically Compensatory Sheet (WV-04).

<Polarizing Plate with Optically Compensatory Sheet>

(Production of Viewing-Side Polarizing Plate (SHB-04))

Optically Compensatory Sheet (WV-04) having an optically anisotropic layer comprising a liquid crystalline compound was saponified and then laminated to the opposite side of the polarizing plate protective film (HF-01) by using a polyvinyl alcohol-base adhesive such that the transparent support film of (WV-03) came to the polarizing film side. In this way, Viewing-Side Polarizing Plate (SHB-04) was produced.

<Liquid Crystal Display Device>

In place of the viewing-side polarizing plate provided in the TN-mode 20-inch liquid crystal display device Model TH-20TA3 (manufactured by Matsushita Electric Industrial Co., Ltd.), one sheet of Polarizing Plate (SHB-04) of the present invention was laminated in the observer side through an acryl-base pressure-sensitive adhesive such that the optically anisotropic layer came to the liquid crystal cell side. Also, in the backlight side, Backlight-Side Polarizing Plate (BHB-02) was laminated such that the optically anisotropic layer side came to the liquid crystal cell side. The transmission axis of the observer-side polarizing plate and the transmission axis of the backlight-side polarizing plate were arranged to be in 0 mode.

### Comparative Example 4

A liquid crystal display device was produced in the same manner as in Example 4 except for using Polarizing Plate (BHB-02) in place of Polarizing Plate (SHB-04).

<Evaluation of Performance of Liquid Crystal Display Device>

The display devices of Example 4 and Comparative Example 4 were evaluated on the quality of the drawn image in the same manner as in Example 1. The results are shown in Table 5.

TABLE 5

| | | | | | | | Color |
|---|---|---|---|---|---|---|---|
| | Liquid | | Reflection of | Contrast | | | Tint |
| | Crystal | Image | External | Main Evaluation | | View | Change |
| | Mode | Unevenness | Light | Item | Results | Angle | Property |
| Example 2 | IPS | ◯ | ◯ | leaked light at | ◯ | ⊚ | ⊚ |
| Comparative | | ◯ | X | black display | Δ | ⊚ | ⊚ |
| Example 2 | | | | | | | |
| Example 3 | VA | ◯ | ◯ | oblique | ◯ | ⊚ | ⊚ |
| Comparative | | ◯ | X | direction | Δ | ⊚ | ◯ |
| Example 3 | | | | | | | |
| Example 4 | TN | ◯ | ◯ | up/down | ◯ | ◯ | ◯ |
| Comparative | | ◯ | X | | Δ | X | X |
| Example 4 | | | | | | | |

In the IPS-mode display device of Example 2, as compared with Comparative Example 2 not using the polarizing plate protective film of the present invention, not only the device was freed from reflection of external light but also the visibility was improved to cause no practical problem in contrast due to leaked light at the black display time.

In the VA-mode display device of Example 3, as compared with Comparative Example 3 not using the polarizing plate protective film of the present invention, not only the device was freed from reflection of external light but also the visibility was enhanced to cause no practical problem in contrast from the oblique direction and at the same time, the problem of color tint change was eliminated.

In the TN-mode display device of Example 4, as compared with Comparative Example 4 not using the polarizing plate protective film of the present invention, not only the device was freed from reflection of external light but also the up/down contrast, view angle and color tint change were remarkably enhanced and good visibility was obtained.

### Example 5

The following coating solution for low refractive index layer was coated on Light-Diffusing Film (HKF-01) of Example 1 to produce an antireflection film.

(Preparation of Coating Solution (LL-2) for Low Refractive Index Layer)

130 Parts of a heat-crosslinking fluorine-containing polymer (JN-7228, produced by JSR, refractive index: 1.42, solid concentration: 6%), 13 parts by weight of a silica sol (a product differing in particle size from MEK-ST produced by Nissan Chemical Industries, Ltd., average particle size: 45 nm, solid concentration: 30%) as the inorganic filler, and 6 parts by weight of (Sol Solution a) below as the interfacial binder were mixed with 50 parts by weight of methyl ethyl ketone and 6 parts by weight of cyclohexanone and then filtered through a polypropylene-made filter having a pore size of 1 μm to prepare the coating solution.

(Sol Solution a)

In a reactor equipped with a stirrer and a reflux condenser, 120 parts of methyl ethyl ketone, 100 parts of 3-acryloyloxypropyltrimethoxysilane (KBM-5103, produced by Shin-Etsu Chemical Co., Ltd.) and 3 parts of diisopropyl aluminum acetate (KEROPE, produced by Hope Pharmaceutical CO., LTD.) were added and mixed and thereafter, 30 parts of ion exchanged water was added. The resulting mixture was reacted at 60° C. for 4 hours and then, the reaction solution was cooled to room temperature to obtain Sol Solution a. The weight average molecular weight was 1,600 and in the components except for oligomer components, the components having a molecular weight of 1,000 to 20,000 were occupying 100%. Also, from the gas chromatography, the raw material acryloyloxypropyltrimethoxysilane was not remaining at all.

(Production of Antireflection Film (HK-05))

On Light-Diffusing Film (HKF-01), the thus-prepared (LL-5) was coated to a dry thickness of 100 nm and after drying the solvent at 120° C. for 2 minutes, irradiated with ultraviolet light at 240 mJ to prepare Antireflection Film (HK-05).

{Evaluation of Antireflection Film (HK-05)}

The haze value of the antireflection film prepared was 42%. Also, the properties of the antireflection film were measured in the same manner as those of the antireflection film produced above and the results are shown in Table 6 below. As seen, the obtained Optical Properties of the obtained film (HK-05) showed good results as same as those of Antireflection Film (HK-01).

TABLE 6

| | |
|---|---|
| Antireflection film | HK-05 |
| Average reflectance, % | 2.1 |
| Inner haze value, % | 42 |
| Surface haze value, % | 0.7 |
| Surface energy, mN/m | 20 |
| Dynamic friction coefficient | 0.11 |
| Adhesion | ◯ |
| Rubbing resistance | A |
| Dust-protecting property | ◯ |
| Weather resistance | ◯ |

### Examples 5-1 to 5-4

Liquid Crystal Display Devices shown in Table 7 were produced in the same manner as those of Examples 1 to 5, respectively, except that in each polarizing plate with optically compensatory sheet used in Examples 1 to 4, the antireflection film portion of the outside protective film was replaced by Antireflection Film (HK-05).

TABLE 7

| | | | | | Image |
|---|---|---|---|---|---|
| | Constitution of First | | | | Drawing |
| | Polarizing Plate | | | | Per- |
| | Polarizing | Anti- | Optically | Liquid | formance |
| | Plate | reflection | Compensatory | Crystal | of Display |
| Example | No. | Film | Sheet | Mode | Device |
| 5-1 | SHB-05-1 | HK-04 | WV-01 | OCB | equal to |
| | | | | | Example 1 |
| 5-2 | SHB-05-2 | ″ | WV-02 | IPS | equal to |
| | | | | | Example 2 |
| 5-3 | SHB-05-3 | ″ | WV-03 | VA | equal to |
| | | | | | Example 3 |
| 5-4 | SHB-05-4 | ″ | WV-04 | TN | equal to |
| | | | | | Example 4 |

{Evaluation of Display Device}

The image drawing performance of each display device was evaluated in the same manner as in Example of the same liquid crystal mode. As seen in Table 7, the display devices exhibited excellent visibility equal to that in respective corresponding Examples.

### Example 6

<Production of Antireflection Films (HK-61) to (HK-65)>

In the production of Antireflection Film (HK-01) of Example 1, Coating Solution (LL-61) for Low Refractive Index Layer was used in place of (LL-1) and coated at a rate of 25 mm/min by using a die coater (slot die) described later. The coating obtained was dried at 90° C. for 30 seconds and then, while purging with nitrogen to give an atmosphere having an oxygen concentration of 0.1 vol % or less, irradiated with ultraviolet light at an illuminance of 600 mW/cm² and an irradiation dose of 400 mJ/cm² by using an air-cooling metal halide lamp of 240 W/cm (manufactured by Eye Graphics Co., Ltd.) to form a low refractive index layer (refractive index: 1.45, film thickness: 83 nm). In this way, Antireflection Film (HI-61) was produced.

Furthermore, Antireflection Films (HK-62) to (HK-65) were produced by using (LL-62) to (LL-65), respectively, in place of Coating Solution (LL-1) for Low Refractive Index Layer.

[Constitution of Die Coater]

A die coater having a constitution shown in FIGS. 8, 9(A), 10 and 11 was used. In the slot die 13 used, the upstream lip land length l_{UP} was 0.5 mm, the downstream lip land length l_{LO} was 50 μm, the length in the web traveling direction of the opening of the slot 16 (width of the end part 16a) was 150 μm, and the length of the slot 16 was 50 mm. The gap between the upstream lip land 18a and the web W was set to be 50 μm longer than the gap between the downstream lip land 18b and the web W (hereinafter referred to as an “overbite length of 50 μm”), the gap G_{L} between the downstream lip land 18b and the web W was set to 50 μm, and the gaps between the side plate of the depression chamber and the web and between the back plate and the web both were set to 200 μm.

(Preparation of Coating Solution (LL-61) for Low Refractive Index Layer)

152.4 Parts by weight of a solution prepared by dissolving Fluorine-Base Copolymer FP-1 in methyl ethyl ketone to have a concentration of 23.7 weight %, 1.1 parts by weight of a terminal methacrylate group-containing silicone resin X-22-164C (produced by Shin-Etsu Chemical Co., Ltd.), 1.8 parts by weight of a photo-radical generator Irgacure 907 (produced by Ciba Specialty Chemicals), 815.9 parts by weight of methyl ethyl ketone and 28.8 parts by weight of cyclohexanone were added and stirred. The resulting solution was filtered through a PTFE (polytetrafluoroethylene)-made filter having a pore size of 0.45 μm to prepare Coating Solution (LL-61) for Low Refractive Index Layer. The viscosity of this coating solution was 0.61 [mPa·sec], the surface tension was 24 [mN/m], and the amount of the coating solution coated on the transparent support was 2.8 [ml/m²].

(Preparation of Coating Solution (LL-62) for Low Refractive Index Layer)

426.6 Parts by weight of a solution prepared by dissolving Fluorine-Base Copolymer FP-1 in methyl ethyl ketone to have a concentration of 23.7 weight %, 3.0 parts by weight of a terminal methacrylate group-containing silicone resin X-22-164C (produced by Shin-Etsu Chemical Co., Ltd.), 5.1 parts by weight of a photo-radical generator Irgacure 907 (produced by Ciba Specialty Chemicals), 538.6 parts by weight of methyl ethyl ketone and 26.7 parts by weight of cyclohexanone were added and stirred. The resulting solution was filtered through a PTFE-made filter having a pore size of 0.45 μm to prepare Coating Solution (LL-62) for Low Refractive Index Layer. The viscosity of this coating solution was 1.0 [mPa·sec], the surface tension was 24 [mN/m], and the amount of the coating solution coated on the transparent support was 1.5 [ml/m²].

(Preparation of Coating Solution (LL-63) for Low Refractive Index Layer)

213.3 Parts by weight of a solution prepared by dissolving Fluorine-Base Copolymer FP-1 in methyl ethyl ketone to have a concentration of 23.7 weight %, 1.5 parts by weight of a terminal methacrylate group-containing silicone resin X-22-164C (produced by Shin-Etsu Chemical Co., Ltd.), 2.5 parts by weight of a photo-radical generator Irgacure 907 (produced by Ciba Specialty Chemicals), 754.3 parts by weight of methyl ethyl ketone and 28.4 parts by weight of cyclohexanone were added and stirred. The resulting solution was filtered through a PTFE-made filter having a pore size of 0.45 μm to prepare Coating Solution (LL-63) for Low Refractive Index Layer. The viscosity of this coating solution was 0.76 [mPa·sec], the surface tension was 24 [mN/m], and the amount of the coating solution coated on the transparent support was 2.0 [ml/m²].

(Preparation of Coating Solution (LL-64) for Low Refractive Index Layer)

85.3 Parts by weight of a solution prepared by dissolving Fluorine-Base Copolymer FP-1 in methyl ethyl ketone to have a concentration of 23.7 weight %, 0.6 parts by weight of a terminal methacrylate group-containing silicone resin X-22-164C (produced by Shin-Etsu Chemical Co., Ltd.), 1.0 part by weight of a photo-radical generator Irgacure 907 (produced by Ciba Specialty Chemicals), 883.7 parts by weight of methyl ethyl ketone and 29.3 parts by weight of cyclohexanone were added and stirred. The resulting solution was filtered through a PTFE-made filter having a pore size of 0.45 μm to prepare Coating Solution (LL-64) for Low Refractive Index Layer. The viscosity of this coating solution was 0.49 [mPa·sec], the surface tension was 24 [mN/m], and the amount of the coating solution coated on the transparent support was 5.0 [ml/m²].

(Preparation of Coating Solution (LL-65) for Low Refractive Index Layer)

71.1 Parts by weight of a solution prepared by dissolving Fluorine-Base Copolymer FP-1 in methyl ethyl ketone to have a concentration of 23.7 weight %, 0.5 parts by weight of a terminal methacrylate group-containing silicone resin X-22-164C (produced by Shin-Etsu Chemical Co., Ltd.), 0.8 parts by weight of a photo-radical generator Irgacure 907 (produced by Ciba Specialty Chemicals), 898.1 parts by weight of methyl ethyl ketone and 29.5 parts by weight of cyclohexanone were added and stirred. The resulting solution was filtered through a PTFE-made filter having a pore size of 0.45 μm to prepare Coating Solution (LL-65) for Low Refractive Index Layer. The viscosity of this coating solution was 0.46 [mPa·sec], the surface tension was 24 [mN/m], and the amount of the coating solution coated on the transparent support was 6.0 μl/m²).

[Evaluation of Antireflection Films (HK-61) to (HK-65)]

The surface state of each antireflection film obtained was evaluated. Also, the average reflectance was measured in the same manner as in Example 1.

(Surface State)

The back surface in 1 m² of the film after coating all layers was black-painted with a felt pen and then, the uniformity of shading on the coated surface was evaluated with an eye.

◯: Shading unevenness was not noticeable.

X: Shading unevenness was noticeable.

The results are shown in Table 8. In HK-61, HK-63 and HK-64 where the amount of the coating solution coated on the transparent support was 2 ml/m² or more, the coating solution could be coated (in Table 8, the rating was ◯), but in HK-62 where the coated amount was 1.5 ml/m², the coating solution could not be uniformly coated throughout the surface and a film usable as the antireflection film could not be prepared (in Table 8, the rating was X). Furthermore, in HK-65 where the amount of the coating solution coated on the transparent support was 6 ml/m², the coating solution could be coated but due to its large amount, the drying was insufficient and vertical streak-like unevenness ascribable to wind was generated over the entire surface (in Table 8, the rating was X).

Display devices were produced in the same manner as in Example 1 by using Antireflection Films (HK-61), (HK-63) and (HK-64), as a result, these devices had less color unevenness and higher display grade than those of the display device of Example 1 which was produced by using a gravure coater.

TABLE 8

| | Coating | | | Coating | | |
|---|---|---|---|---|---|---|
| | Solution for | | | Solution | Surface State | |
| | Low | | Coated | Could or | of | |
| Antireflection | Refractive | Viscosity | Amount | Could Not Be | Antireflection | Average |
| Film | Index | (mPa/sec) | (ml/m²) | Coated | Film | Reflectance |
| HK-61 | LL-61 | 0.61 | 2.8 | ◯ | ◯ | 2.3% |
| HK-62 | LL-62 | 1.00 | 1.5 | X | X | * |
| HK-63 | LL-63 | 0.76 | 2.0 | ◯ | ◯ | 2.3% |
| HK-64 | LL-64 | 0.49 | 5.0 | ◯ | ◯ | 2.3% |
| HK-65 | LL-65 | 0.46 | 6.0 | ◯ | X | * |

*: Immeasurable due to large fluctuation depending on the measuring position.

### Example 7

Antireflection Films (HK-71) to (HK-75) were produced in the same manner as Antireflection Film (HK-61) except for changing the downstream lip land length l_{LO} to 10 μm, 30 μm, 70 μm, 100 μm or 120 μm. Antireflection Films (HK-71) to (HK-75) obtained were evaluated in the same manner as Antireflection Film (HK-61). The results are shown in Table 9. An antireflection film free from surface state failure was obtained when the downstream lip land length was from 30 to 100 μm. In Antireflection Film (HK-71), streak-like unevenness was generated in the base longitudinal direction, and in Antireflection Film (HK-75), when the coating solution was coated at the same rate as in Antireflection Film (HK-61), the coating solution 14 did not form a bead shape 14a shown in FIG. 9 and could not be coated. By decreasing the coating rate to a half (12.5 m/min), the coating solution could be coated, but streak-like unevenness was generated in the base longitudinal direction. Display devices were produced in the same manner as in Example 1 by using Antireflection Films (HK-72), (HK-73) and (HK-74), as a result, a display device having a very high display grade, that is, remarkably reduced in the reflection of surrounding scenes and in the color tint of reflected light and ensured with uniformity in the display plane, was obtained. On the other hand, when display devices were produced in the same manner as in Example 1 by using Antireflection Films (HK-71) and (HK-75), color tint unevenness was viewed on the display device and high display grade was not obtained.

TABLE 9

| | Downstream | Overbite | Surface | |
|---|---|---|---|---|
| | Lip Land | Length | State of | |
| Antireflection | Length l_{LO} | LO | Antireflection | Average |
| Film | (μm) | (μm) | Film | Reflectance |
| (HK-71) | 10 | 50 | X | * |
| (HK-72) | 30 | 50 | ◯ | 2.3% |
| (HK-73) | 70 | 50 | ◯ | 2.3% |
| (HK-74) | 100 | 50 | ◯ | 2.3% |
| (HK-75) | 120 | 50 | X | * |

*: Immeasurable due to large fluctuation depending on the measuring position.

### Example 8

Antireflection Films (HK-81) to (HK-85) were produced in the same manner as Antireflection Film (HK-61) except for changing the overbite length LO of the die coater to 0 μm, 30 μm, 70 μm, 120 μm or 150 μm. Antireflection Films (HK-81) to (HK-85) obtained were evaluated in the same manner as Antireflection Film (HK-61). The results are shown in Table 10. An antireflection film free from surface state failure was obtained when the overbite length was from 30 to 120 μm. In Antireflection Film (HK-81), the coating could be performed but when the surface state was inspected, stepwise unevenness was observed in the base cross direction, and in Antireflection Film (HK-85), when the coating solution was coated at the same rate as in Antireflection Film (HK-61), the coating solution 14 did not form a bead shape 14a shown in FIG. 9 and could not be coated. By decreasing the coating rate to a half (12.5 m/min), the coating solution could be coated, but streak-like unevenness was generated in the base longitudinal direction. Display devices were produced in the same manner as in Example 1 by using Antireflection Films (HK-82), (HK-83) and (HK-84), as a result, a display device having a very high display grade, that is, remarkably reduced in the reflection of surrounding scenes and in the color tint of reflected light and ensured with uniformity in the display plane, was obtained. On the other hand, when display devices were produced in the same manner as in Example 1 by using Antireflection Films (HK-81) and (HK-85), color tint unevenness was viewed on the display device and high display grade was not obtained.

TABLE 10

| | Downstream | Overbite | Surface | |
|---|---|---|---|---|
| | Lip Land | Length | State of | |
| Antireflection | Length l_{LO} | LO | Antireflection | Average |
| Film | (μm) | (μm) | Film | Reflectance |
| (HK-81) | 50 | 0 | X | * |
| (HK-82) | 50 | 30 | ◯ | 2.3% |
| (HK-83) | 50 | 70 | ◯ | 2.3% |
| (HK-84) | 50 | 120 | ◯ | 2.3% |
| (HK-85) | 50 | 150 | X | * |

*: Immeasurable due to large fluctuation depending on the measuring position.

### Example 9

Antireflection films having the same compositions as Antireflection Films (HK-01) to (HK-03) and (HK-05) were produced by changing the coating method of the light-diffusing layer to the die coating method of Example 6. The obtained antireflection films were evaluated in the same manner as in Example 1, as a result, the inner haze value of the light-diffusing layer was from 35 to 45% and the surface haze value was from 0.5 to 1.0%. The average reflectance of the antireflection films obtained was from 2.3 to 2.5%. These antireflection films had a high display grade with less color unevenness.

### INDUSTRIAL APPLICABILITY

By the antireflection film and polarizing plate described in detail in the specification, an antireflection film and a polarizing plate, where the view angle (particularly, view angle in the lower direction) is enlarged without increasing the thickness of panel, the reduction in contrast, gradation or black-and-white reversal, color hue change and the like are scarcely generated even when the view angle is changed, and the scratch resistance is enhanced, can be provided.

Also, by the antireflection film and polarizing plate described in detail in the specification, a liquid crystal display device having a good contrast and a wide view angle can be provided, where gradation reversal in the lower direction of panel, color hue change and reflection of external light are prevented in a high level.

1. An antireflection film comprising a transparent support, which has a light-diffusing layer and a low refractive index layer on the transparent support,
wherein the light-diffusing layer has an inner haze value of 30 to 60% and a surface haze value of 1% or less, and the antireflection film has an average reflectance of 2.5% or less at a wavelength of 450 to 650 nm.

2. The antireflection film according to claim 1,
wherein a color tint change ΔE of a reflected light before and after a weather resistance test according to JIS K5600-7-7:1999 is 15 or less on a L*a*b* chromaticity diagram.

3. The antireflection film according to claim 1 or 2,
wherein the low refractive index layer has a surface energy of 26 mN/m or less and a dynamic friction coefficient of 0.25 or less.

4. The antireflection film according to claim 1 or 2,
wherein the light-diffusing layer comprises a light-transmitting resin and at least two or more kinds of light-transmitting particles, a difference between a refractive index of the light-transmitting resin and a refractive index of the light-transmitting fine particle is from 0.02 to 0.20, and the two or more kinds of light-transmitting fine particles have different refractive indexes.

5. The antireflection film according to claim 1 or 2,
wherein the low refractive index layer contains a fluorine-containing compound and has a refractive index of 1.31 to 1.48.

6. The antireflection film according to claim 1 or 2,
wherein the low refractive index layer is a cured film comprising a copolymer, which contains a repeating unit derived from a fluorine-containing vinyl monomer and a repeating unit having a radical polymerizable group on a side chain.

7. The antireflection film according to claim 1 or 2,
which further comprises an electrically conductive layer.

8. A method for producing the antireflection film according to claim 1 or 2 by using a coating apparatus to coat at least either coating solution for a light-diffusing layer or for a low refractive index layer, the method comprising coating the coating solution from a slot of a leading lip of a slot die in a state that a land of the leading lip is brought close to a surface of a continuously traveling web supported by a backup roll,
wherein the apparatus comprises the slot die in which the leading lip of the slot die on a web traveling direction side has a land length of 30 to 100 μm in the web traveling direction and the leading lip of the slot die on an opposite side of the web traveling direction and the web are disposed to give a gap larger by 30 to 120 μm than a gap between the leading lip on the web traveling direction and the web when the slot die is set to a coating position.

9. The method according to claim 8, wherein a viscosity of the coating solution is 2.0 mPa·sec or less at the coating and an amount of the coating solution coated on a surface of the web is from 2.0 to 5.0 ml/m².

10. The method according to claim 8,
wherein the coating solution is coated on a surface of the continuously traveling web at a rate of 25 m/min or more.

11. A polarizing plate comprising the antireflection film according to claim 1 or 2 for at least one protective film of a polarizing film.

12. A polarizing plate comprising an antireflection film produced by the method according to claim 8 for at least one protective film of a polarizing film.

13. A polarizing plate comprising: the antireflection film according to claim 1 or 2 for one protective film of a polarizing film; and an optically compensatory film having an optical anisotropy for another protective film of the polarizing film.

14. A polarizing plate comprising: an antireflection film produced by the method according to claim 8 for one protective film of a polarizing film; and an optically compensatory film having an optical anisotropy for another protective film of the polarizing film.

15. A liquid crystal display device comprising,
a pair of substrates disposed opposite to each other, at least one substrate having an electrode,
a liquid crystal layer disposed between the pair of substrates, and
a polarizing plate disposed on an outermost surface in a viewing side outside the liquid crystal layer, wherein the polarizing plate is the polarizing plate according to claim 11.

16. The liquid crystal display device according to claim 15, which is one of an in-plane switching liquid crystal display device, an optically compensatory bend liquid crystal display device, and a vertically aligned liquid crystal display device.

17. The liquid crystal display device according to claim 15, wherein a size of a display image is 20 inches or more.
